(19) United States
(12) Patent Application Publication
(10) Pub. No.: US 2019/0235376 A1
(43) Pub. Date: Aug. 1, 2019

(54) THERMALLY-DEVELOPABLE PHOTOSENSITIVE MATERIAL AND PREPARATION METHOD THEREOF

(71) Applicant: FUJIFILM CORPORATION, Tokyo (JP)

(72) Inventors: Yoshihisa HASHI, Kanagawa (JP); Munenori SHIMOYAMA, Kanagawa (JP); Yoshihiro JIMBO, Kanagawa (JP)

(21) Appl. No.: 16/382,195

(22) Filed: Apr. 12, 2019

Related U.S. Application Data
(63) Continuation of application No. PCT/JP2017/037414, filed on Oct. 16, 2017.

(30) Foreign Application Priority Data
Oct. 20, 2016 (JP) 2016-206373

(51) Int. Cl. G03C 1/12; G03C 1/74; G03C 1/09

(52) U.S. Cl. CPC G03C 1/12; G03C 1/09; G03C 1/74

(57) ABSTRACT

Provided is a thermally-developable photosensitive material having a support, an image forming layer, which contains at least a photosensitive silver halide, a non-photosensitive organic silver salt, a reducing agent, and a binder, on one surface of the support, and a non-photosensitive back layer on the other surface of the support, in which either the image forming layer or the image forming layer and the non-photosensitive back layer contain an infrared absorbing dye which absorbs at least infrared having a wavelength equal to or longer than 700 nm. Also provided is a manufacturing method of the thermally-developable photosensitive material.

### CROSS-REFERENCE TO RELATED APPLICATIONS

This application is a Continuation of International Application No. PCT/JP2017/037414 filed on Oct. 16, 2017, which claims priority to Japanese Patent Application No. 2016-206373 filed on Oct. 20, 2016. The entire contents of these applications are incorporated herein by reference.

### BACKGROUND OF THE INVENTION

### 1. Field of the Invention

The present disclosure relates to a thermally-developable photosensitive material and a preparation method thereof.

### 2. Description of the Related Art

In recent years, in the medical fields, from the viewpoint of environment preservation and space saving, the reduction of waste of a treatment liquid has been strongly required. Accordingly, there has been a need for techniques relating to photosensitive thermally-developable photographic materials for medical diagnoses and photographic techniques that can be efficiently exposed by using a laser imagesetter or a laser imager and can form a black image having excellent resolution and sharpness. In a case where these thermally-developable photosensitive materials are used, it possible to provide a simpler thermal development treatment system good for the environment without using a solution-based treatment chemical.

As a thermally-developable photosensitive material, for example, a black-and-white thermally-developable photosensitive material is suggested which contains at least photosensitive silver halide, a non-photosensitive organic silver salt, a color developing agent, and a coupler on at least one surface of a support and has at least two image forming layers containing the photosensitive silver halide, in which a first image forming layer contains at least a reducing agent for silver ions, a second image forming layer contains the color developing agent, and a sensitivity difference between the first image forming layer and the second image forming layer is equal to or greater than 0.2 as represented by LogE₀ which is the logarithm of an exposure amount E₀ required to obtain an image density of 1.0 (for example, see JP2008-058820A). It is said that this black-and-white thermally-developable photosensitive material has high sensitivity, high density, and excellent image tone over a low density area to a high density area.

As another example, a thermally-developable photosensitive material is suggested which has at least photosensitive silver halide, a non-photosensitive organic silver salt, and a reducing agent for thermal development on at least one surface of a support and contains an infrared dye and a magenta dye described below, in which (1) the thermally-developable photosensitive material has a maximum light absorption at a wavelength equal to or longer than 750 nm and equal to or shorter than 850 nm, (2) a ratio of an absorbance at 785 nm to an absorbance at 810 nm is equal to or higher than 0.8 and equal to or lower than 1.2, and (3) an absorbance at 650 nm is equal to or higher than 5% of an absorbance at the maximum light absorption (for example, see JP2009-086588A). It is said that this thermally-developable photosensitive material has versatility which enables the material to be commonly used in various different thermal development apparatuses.

### SUMMARY OF THE INVENTION

In the related art, in a case where the wavelength of an infrared laser used for exposure is changed, the types of dyes used in the respective thermally-developable photosensitive materials need to be changed as well. Changing the types of materials according to wavelength requires talents and time for product development and becomes a factor significantly increasing costs.

For example, the black-and-white thermally-developable photosensitive material described in JP2008-058820A does not absorb light in a case where an infrared laser having a wavelength equal to or longer than 700 nm is used. Therefore, in order for the thermally-developable photosensitive material to become usable for lasers having a plurality of different wavelengths and to maintain sensitivity while improving the sharpness as image quality, the material needs to be further improved.

Furthermore, although the absorption band of the thermally-developable photosensitive material described in JP2009-086588A is broadened by using an infrared dye and a magenta dye in combination, in order for the material to become usable for lasers having a plurality of different wavelengths, the material needs to be further improved. In addition, in order for the thermally-developable photosensitive material described in JP2009-086588A to have a structure satisfying both the improvement of sharpness as image quality and the maintenance of sensitivity, the material needs to be further improved.

An object of embodiments of the present invention is to provide a thermally-developable photosensitive material, which makes it possible to obtain an image having improved sharpness as image quality while maintaining sensitivity even in a case where exposure is performed using infrared rays having different wavelengths, and a preparation method of the material.

Means for achieving the above object include the following aspects.

<1> A thermally-developable photosensitive material comprising: a support; an image forming layer, which contains at least a photosensitive silver halide, a non-photosensitive organic silver salt, a reducing agent, and a binder, on one surface of the support; and a non-photosensitive back layer on the other surface of the support, in which either the image forming layer or the image forming layer and the non-photosensitive back layer contain an infrared absorbing dye which absorbs at least infrared having a wavelength equal to or longer than 700 nm.

<2> The thermally-developable photosensitive material described in <1>, in which the infrared absorbing dye is a cyanine-based dye represented by Formula (I).

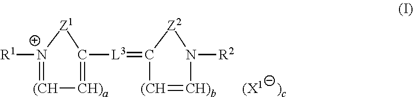

In the formula, Z¹ and Z² each independently represent a non-metal atomic group necessary for forming a 5- or 6-membered nitrogen-containing heterocyclic ring which may be fused; R¹ and R² each independently represent an aliphatic group or an aromatic group; L³ represents a methine chain including 3, 5, or 7 methine groups; a, b, and c each independently represent 0 or 1; and X¹ represents an atomic group which may become an anion.

<3> The thermally-developable photosensitive material described in <2>, in which the nitrogen-containing heterocyclic ring is a ring selected from the group consisting of a benzoxazole ring, a benzothiazole ring, a benzimidazole ring, an indolenine ring, and a benzindolenine ring.

<4> The thermally-developable photosensitive material described in any one of <1> to <3>, in which the non-photosensitive back layer contains, as the infrared absorbing dye, an oxonol dye represented by Formula (II).

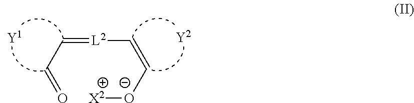

In the formula, Y¹ and Y² each independently represent a non-metal atomic group necessary for forming an aliphatic ring or a heterocyclic ring; L² represents a methine chain including an odd number of methine groups; and X² represents a hydrogen atom or an atomic group which may become a cation.

<5> The thermally-developable photosensitive material described in any one of <1> to <4>, in which the image forming layer further contains an infrared sensitizing dye represented by Formula (III).

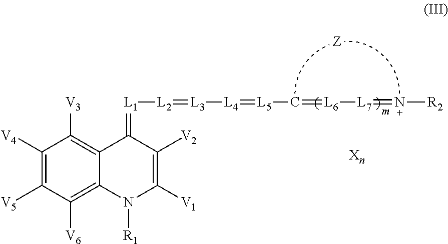

In the formula, V₁, V₂, V₃, V₄, V₅, and V₆ each independently represent a substituent satisfying Y=σp1+σp2+σp3+σp4+σp5+σp6<−0.27 provided that a Hammett constant σp of each of V₁, V₂, V₃, V₄, V₅, and V₆ is σpi (i=1 to 6); R₁ and R₂ each independently represent an alkyl group; L₁, L₂, L₃, L₄, L₅, L₆, and L₇ each independently represent a methine group; m represents 0 or 1; Z represents an atomic group necessary for forming a 5- or 6-membered nitrogen-containing heterocyclic ring; Xₙ represents a charge balancing counterion; and n represents a number equal to or greater than 0 that is necessary for charge neutralization.

<6> The thermally-developable photosensitive material described in any one of <1> to <5>, in which the image forming layer further contains an intensely color-sensitizing compound represented by Formula (IV).

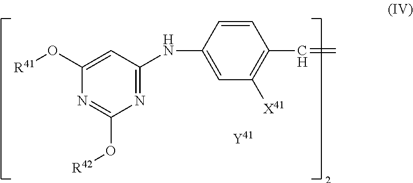

In the formula, R⁴¹ and R⁴² each independently represent a hydrogen atom or a monovalent substituent; X⁴¹ represents an acid anion group; and Y⁴¹ represents a monovalent metal ion.

<7> The thermally-developable photosensitive material described in any one of <1> to <6>, in which the image forming layer further contains an intensely color-sensitizing compound represented by Formula (V).

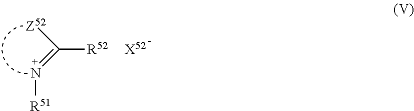

In the formula, Z⁵² represents a non-metal atomic group necessary for forming a 5- or 6-membered nitrogen-containing heterocyclic ring; R⁵¹ represents a hydrogen atom, an alkyl group, or an alkenyl group; R⁵² represents a hydrogen atom or an alkyl group having 1 to 4 carbon atoms; and X⁵²⁻ represents an acid anion.

<8> The thermally-developable photosensitive material described in any one of <1> to <7>, in which a content of a silver element in the image forming layer is equal to or greater than 0.3 g/m² and equal to or smaller than 1.5 g/m².

<9> The thermally-developable photosensitive material described in any one of <1> to <8>, in which the image forming layer and the non-photosensitive back layer contain an infrared absorbing dye which absorbs at least infrared having a wavelength equal to or longer than 700 nm.

<10> A preparation method of the thermally-developable photosensitive material described in any one of <1> to <9>, comprising: a step of forming the image forming layer by aqueous coating.

<11> The preparation method of the thermally-developable photosensitive material described in <10>, further comprising: a step of preparing a coating solution for forming an image forming layer by adding at least one kind of compound, which is selected from the group consisting of an infrared sensitizing dye represented by Formula (III), an intensely color-sensitizing compound represented by Formula (IV), and an intensely color-sensitizing compound represented by Formula (V), to a composition containing a photosensitive silver halide under a temperature condition of equal to or higher than 50° C., in which the step of forming the image forming layer by aqueous coating is a step of forming the image forming layer by performing aqueous coating by using the coating solution for forming an image forming layer.

According to the embodiments of the present invention, it is possible to provide a thermally-developable photosensitive material, which makes it possible to obtain an image having improved sharpness as image quality while maintaining sensitivity even in a case where exposure is performed using infrared rays having different wavelengths, and a preparation method of the material.

### DESCRIPTION OF THE PREFERRED EMBODIMENTS

Hereinafter, the present disclosure will be specifically described.

In the present specification, a description of “xx to yy” represents a range of numerical values including xx and yy.

In the present specification, “(meth)acryl” is a term used as a concept including both the acryl and methacryl, and “(meth)acryloyl” is a term used as a concept including both the acryloyl and methacryloyl.

In the present specification, the term “step” includes not only an independent step, but also a step which cannot be clearly distinguished from other steps as long as the intended goal of the step is accomplished.

Furthermore, unless otherwise specified, hydrocarbon groups such as an alkyl group, an aryl group, an alkylene group, and an arylene group in the present disclosure may have a branch or a ring structure.

In the present disclosure, “% by mass” has the same definition as “% by weight”, and “part by mass” has the same definition as “part by weight”.

In the present disclosure, a combination of two or more preferable aspects is a more preferable aspect.

In addition, unless otherwise specified, a weight-average molecular weight (Mw) and a number-average molecular weight (Mn) in the present disclosure are the molecular weight which is detected by a differential refractometer by using a gel permeation chromatography (GPC) analysis apparatus using columns of TSKgel GMH×L, TSKgel G4000H×L, and TSKgel G2000H×L (trade names, manufactured by Tosoh Corporation) and tetrahydrofuran (THF) as a solvent and expressed using polystyrene as a standard substance.

Hereinafter, the thermally-developable photosensitive material according to the present disclosure will be specifically described.

(Thermally-Developable Photosensitive Material)

The thermally-developable photosensitive material according to the present disclosure has a support, an image forming layer, which contains at least a photosensitive silver halide, a non-photosensitive organic silver salt, a reducing agent, and a binder, on one surface of the support, and a non-photosensitive back layer on the other surface of the support, in which either the image forming layer or the image forming layer and the non-photosensitive back layer contain an infrared absorbing dye which absorbs at least infrared having a wavelength of equal to or longer than 700 nm.

In the thermally-developable photosensitive material according to the present disclosure, from the viewpoint of the sensitivity and the sharpness as image quality of the image to be obtained, it is preferable that each of the image forming layer and the non-photosensitive back layer contains the infrared absorbing dye which absorbs at least infrared having a wavelength equal to or longer than 700 nm.

As described above, in the related art, in a case where the wavelength of an infrared laser used for exposure is changed, the types of dyes used in the respective thermally-developable photosensitive materials need to be changed as well. Changing the types of materials according to wavelength requires talents and time for product development and becomes a factor significantly increasing costs.

Considering the above circumstances, the thermally-developable photosensitive material according to the present disclosure has adopted the aspect described above. Accordingly, even though exposure is performed by infrared rays having different wavelengths, the sharpness as image quality of the image to be obtained becomes excellent, and the sensitivity is maintained.

The detailed mechanism thereof is unclear. However, presumably, because the thermally-developable photosensitive material has the non-photosensitive back layer, and the image forming layer contains at least an infrared absorbing dye absorbing at least infrared having a wavelength equal to or longer than 700 nm, the scattering (irradiation) of the infrared having various wavelengths may be prevented at the time of exposure; a phenomenon (halation) in which the infrared is reflected from a side of the support opposite to the image forming layer and hence the picture (image) is blurred may be inhibited; and even though exposure is performed using infrared rays of different wavelengths, the sharpness as image quality of the image to be obtained may become excellent, and the reduction of sensitivity may be inhibited.

<Image Forming Layer>

The thermally-developable photosensitive material according to the present disclosure has the image forming layer, which contains at least a photosensitive silver halide, a non-photosensitive organic silver salt, a reducing agent, and a binder, on one surface of the support.

Furthermore, the image forming layer contains an infrared absorbing dye which absorbs at least infrared having a wavelength equal to or longer than 700 nm.

<<Infrared Absorbing Dye>

The image forming layer in the thermally-developable photosensitive material according to the present disclosure contains an infrared absorbing dye which absorbs at least infrared having a wavelength equal to or longer than 700 nm.

The infrared absorbing dye is not particularly limited and may be a dye which absorbs at least infrared having a wavelength equal to or longer than 700 nm.

By adjusting the pH of a solution containing the infrared absorbing dye of the present disclosure, the absorption wavelength of the infrared absorbing dye can be controlled. Presumably, this is because the aggregated state of the infrared absorbing dye is changed due to the pH change of the solution, although details thereof are unclear. For example, for the image forming layer in the thermally-developable photosensitive material according to the present disclosure, at the time of preparing a coating solution used for forming the image forming layer, by adjusting the pH of the finally obtained solution, an infrared absorbing dye, which exhibits a desired absorption wavelength characteristic with respect to the wavelength of the exposure laser for forming an image, can be incorporated into the thermally-developable photosensitive material.

Specifically, examples of the infrared absorbing dye include dyes such as an azo dye, a metal complex salt azo dye, a pyrazolone azo dye, a naphthoquinone dye, an anthraquinone dye, a phthalocyanine dye, a carbonium dye, a quinoneimine dye, a methine dye, a cyanine dye, a squarylium colorant, a pyrylium salt, and a metal thiolate complex.

The method for checking whether the infrared absorbing dye absorbs at least infrared having a wavelength equal to or longer than 700 nm is not particularly limited, and known methods may be used for checking the light absorption (absorption of an infrared region having a wavelength equal to or longer than 700 nm) of the dye.

Furthermore, from the viewpoint of the sensitivity and the sharpness as image quality of the image to be obtained, the image forming layer preferably contains at least one kind of infrared absorbing dye selected from the group consisting of a cyanine dye represented by Formula (I) and an oxonol dye represented by Formula (II), and more preferably contains at least the cyanine dye represented by Formula (I).

—Cyanine Dye Represented by Formula (I)—

From the viewpoint of the sensitivity and the sharpness as image quality of the image to be obtained, it is preferable that the image forming layer in the thermally-developable photosensitive material according to the present disclosure contains at least a cyanine dye represented by Formula (I).

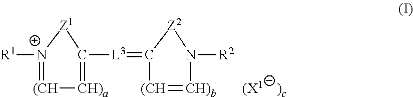

In the formula, Z¹ and Z² each independently represent a non-metal atomic group necessary for forming a 5- or 6-membered nitrogen-containing heterocyclic ring which may be fused; R¹ and R² each independently represent an aliphatic group or an aromatic group; L³ represents a methine chain including 3, 5, or 7 methine groups; a, b, and c each independently represent 0 or 1; and X¹ represents an atomic group which can become an anion.

The nitrogen-containing heterocyclic ring may be fused with another heterocyclic ring, aromatic ring, or aliphatic ring.

Examples of the nitrogen-containing heterocyclic ring and a fused ring thereof include an oxazole ring, an isoxazole ring, a benzoxazole ring, a naphthoxazole ring, an oxazolocarbazole ring, an oxazolodibenzofuran ring, a thiazole ring, a benzothiazole ring, a naphthothiazole ring, an indolenine ring, a benzindolenine ring, an imidazole ring, a benzimidazole ring, a naphthoimidazole ring, a quinoline ring, a pyridine ring, a pyrrolopyridine ring, a propyrrole ring, an indolizine ring, an imidazoquinoxaline ring, and a quinoxaline ring. As the nitrogen-containing heterocyclic ring, a 5-membered ring is more preferable than a 6-membered ring. The 5-membered nitrogen-containing heterocyclic ring is even more preferably fused with a benzene ring or a naphthalene ring. Among these, from the viewpoint of the sensitivity and the sharpness as image quality of the image to be obtained, a ring selected from the group consisting of a benzoxazole ring, a benzothiazole ring, a benzimidazole ring, an indolenine ring, and a benzindolenine ring is particularly preferable.

The nitrogen-containing heterocyclic ring and the fused ring thereof may have a substituent. The substituent include a halogen atom, a cyano group, a nitro group, a hydroxyl group, a carboxyl group, an amino group, a formyl group, a carbamoyl group, a ureide group, a urethane group, a mercapto group, a sulfo group, a sulfamoyl group, an aliphatic group, an aromatic group, a heterocyclic group, —O—R, —CO—R, —CO—O—R, —O—CO—R, —NH—R, —N(R)₂, —NH—CO—R, —CO—NH—R, —CO—N(R)₂, —NH—CO—NH—R, —NH—CO—N(R)₂, —NH—CO—O—R, —S—R, —SO₂—R, —SO₂—O—R, —NH—SO₂—R, —SO₂—NH—R, and —SO₂—N(R)₂. R each independently represents an aliphatic group, an aromatic group, or a heterocyclic group. The carboxyl group and the sulfo group may be in a state where the hydrogen atom is dissociated or may be in the form of a salt. These substituents may be further substituted.

In the present specification, an aliphatic group means an alkyl group, a substituted alkyl group, an alkenyl group, a substituted alkenyl group, an alkynyl group, or a substituted alkynyl group. The alkyl group may be cyclic. A chain-like alkyl group may have a branch. The number of carbon atoms in the alkyl group is preferably 1 to 20, more preferably 1 to 12, and particularly preferably 1 to 8. Examples of the alkyl group include a methyl group, an ethyl group, a propyl group, an isopropyl group, a n-butyl group, a s-butyl group, an isobutyl group, a t-butyl group, a cyclopropyl group, a cyclohexyl group, and a 2-ethylhexyl group.

The alkyl portion of the substituted alkyl group is the same as the aforementioned alkyl group. Examples of substituents of the substituted alkyl group include the aforementioned substituents. These substituents may be further substituted.

Examples of the substituted alkyl group include a 2-hydroxyethyl group, a 2-carboxyethyl group, a 2-methoxyethyl group, a 2-diethylaminoethyl group, a 3-sulfopropyl group, a 4-sulfobutyl group, a benzyl group, and a phenethyl group.

The alkenyl group may be cyclic. A chain-like alkenyl group may have a branch. The number of carbon atoms in the alkenyl group is preferably 2 to 20, more preferably 2 to 12, and particularly preferably 2 to 8. The alkenyl group includes a vinyl group, an allyl group, a 1-propenyl group, a 2-butenyl group, a 2-pentenyl group, and a 2-hexenyl group. The alkenyl portion of the substituted alkenyl group is the same as the aforementioned alkenyl group. The substituent of the substituted alkenyl group is the same as the substituent of the alkyl group.

The alkynyl group may be cyclic. A chain-like alkynyl group may have a branch. The number of carbon atoms in the alkynyl group is preferably 2 to 20, more preferably 2 to 12, and particularly preferably 2 to 8. Examples of the alkynyl group include an ethynyl group and a 2-propynyl group.

The alkynyl portion in the substituted alkynyl group is the same as the aforementioned alkynyl group. The substituent of the substituted alkynyl group is the same as the substituent of the alkyl group.

In the present specification, an aromatic group means an aryl group or a substituted aryl group. The number of carbon atoms in the aryl group is preferably 6 to 25, more preferably 6 to 15, and particularly preferably 6 to 10. Examples of the aryl group include a phenyl group and a naphthyl group.

The aryl portion of the substituted aryl group is the same as the aforementioned aryl group. Examples of the substituent of the substituted aryl group include the substituents described above.

Examples of the substituted aryl group include a 4-carboxyphenyl group, a 4-acetamidophenyl group, a 3-methanesulfonamidophenyl group, a 4-methoxyphenyl group, a 3-carboxyphenyl group, a 3,5-dicarboxyphenyl group, a 4-methanesulfonamidophenyl group, and a 4-butanesulfonamidophenyl group.

In the present specification, a heterocyclic group means an unsubstituted heterocyclic group or a substituted heterocyclic group. The heterocyclic ring of the heterocyclic group is preferably a 5-membered or 6-membered ring. The heterocyclic ring may be fused with an aliphatic ring, an aromatic ring, or another heterocyclic ring. Examples of the heterocyclic ring (including the fused ring) include a pyridine ring, a piperidine ring, a furan ring, a furfuran ring, a thiophene ring, a pyrrole ring, a quinoline ring, a morpholine ring, an indole ring, an imidazole ring, an oxazole ring, a pyrazole ring, a carbazole ring, a phenothiazine ring, a phenoxazine ring, an indoline ring, a thiazole ring, a pyrazine ring, a thiadiazine ring, a benzoquinoline ring, and a thiadiazole ring. The substituent of the substituted heterocyclic group is the same as the substituent of the substituted aryl group.

R¹ and R² in Formula (I) each independently represent an aliphatic group or an aromatic group. The definitions and examples of the aliphatic group and the aromatic group are as described above.

L³ in Formula (I) is more preferably a methine chain including 5 or 7 methine groups.

The methine group may have a substituent. The methine group having a substituent is preferably a central methine group (in meso-position). Examples of the substituent include the substituents described above. These substituents may be further substituted.

Furthermore, it is preferable that two substituents in at least two methine groups in the methine chain are bonded to each other so as to form a 5-membered or 6-membered ring.

a and b in Formula (I) are preferably 0.

In a case where the cyanine dye has an anionic substituent such as a sulfo group or a carboxyl group and forms an intramolecular salt, c in Formula (I) is 0.

X¹ in Formula (I) is an atomic group which can become an anion. The anion may be a monovalent anion or an anion having a valency equal to or higher than 2. Examples of the anion (X¹⁻) include a halide ion (Cl⁻, Br⁻, or I⁻), a p-toluenesulfonic acid ion, an ethyl sulfate ion, PF₆⁻, BF₄⁻, and ClO₄⁻.

It is preferable that the cyanine dye represented by Formula (I) has any of a carboxyl group or a sulfo group as a substituent.

Specifically, as the cyanine dye represented by Formula (I), for example, the cyanine dyes described in JP2010-072575A are suitable.

—Oxonol Dye Represented by Formula (II)—

From the viewpoint of the sensitivity and the sharpness as image quality of the image to be obtained, it is preferable that the image forming layer in the thermally-developable photosensitive material according to the present disclosure contains at least an oxonol dye represented by Formula (II).

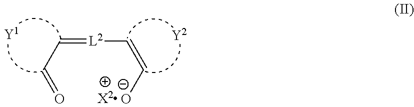

In the formula, Y¹ and Y² each independently represent a non-metal atomic group necessary for forming an aliphatic ring or a heterocyclic ring; L² represents a methine chain including an odd number of methine groups; and X² represents a hydrogen atom or an atomic group which can become a cation.

In Formula (II), as the ring that Y¹ and Y² form, a heterocyclic ring is more preferable than an aliphatic ring.

Examples of the aliphatic ring include an indandione ring.

Examples of the heterocyclic ring include a 5-pyrazolone ring, an isoxazolone ring, a Barbituric acid ring, a pyridone ring, a rhodanine ring, a pyrazolidinedione ring, a pyrazolopyridone ring, and a Meldrum's acid ring. Among these, a 5-pyrazolone ring and a Barbituric acid ring are preferable. The aliphatic ring and the heterocyclic ring may have a substituent. Examples of the substituent include the substituents described above.

L² in Formula (II) is preferably a methine chain including 3, 5, or 7 methine groups, and particularly preferably a methine chain including 5 methine groups. The methine group may have a substituent. The methine group having a substituent is preferably a central methine group (in meso-position). Examples of the substituent include the substituents described above. These substituents may be further substituted.

Furthermore, it is preferable that two substituents in at least two methine groups in the methine chain are bonded to each other so as to form a 5-membered or 6-membered ring.

X² in Formula (II) represents a hydrogen atom or an atomic group which can become a cation. The cation may be a monovalent cation or a cation having a valency equal to or higher than 2. Examples of the cation (X²⁺) include an alkali metal (for example, Na or K) ion, an ammonium ion, a triethylammonium ion, a tributylammonium ion, a pyridinium ion, and a tetrabutylammonium ion.

Specifically, as the oxonol dye represented by Formula (II), for example, the oxonol dyes described paragraphs “0055” to “0062” in JP2010-072575A are suitable.

In the thermally-developable photosensitive material according to the present disclosure, at least the image forming layer or the non-photosensitive back layer contains the oxonol dye represented by Formula (II). Therefore, the thermally-developable photosensitive material demonstrates an excellent antireflection (antihalation) performance and results in further improved sharpness as image quality of the image to be obtained.

In the thermally-developable photosensitive material according to the present disclosure, from the viewpoint of the sharpness as image quality of the image to be obtained, the oxonol dye represented by Formula (II) is preferably contained in the non-photosensitive back layer, and particularly preferably contained only in the non-photosensitive back layer.

In the thermally-developable photosensitive material according to the present disclosure, the image forming layer and the non-photosensitive back layer may contain one kind of infrared absorbing dye, which absorbs at least infrared having a wavelength equal to or longer than 700 nm, singly, or contain two or more kinds of infrared absorbing dyes described above.

In order to preferably adjust the tone of the image obtained after the thermal development treatment, the amount of the infrared absorbing dye added to the image forming layer is determined in combination with the tone of silver or tone resulting from other additives. It is preferable that the infrared absorbing dye is used in such an amount that prevents an optical density, which is measured at an intended wavelength, from exceeding 1.0. The optical density is preferably 0.1 to 1.0, more preferably 0.2 to 0.9, and particularly preferably 0.3 to 0.8.

The amount of the infrared absorbing dye used for obtaining the optical density described above may be optionally adjusted preferably within a range of about 1×10⁻⁶ mol/m² to 5×10⁻⁴ mol/m², more preferably within a range of about 2×10⁻⁶ mol/m² to 2.5×10⁻⁴ mol/m², and even more preferably within a range of about 5×10⁻⁶ mol/m² to 1×10⁻⁴ mol/m².

<<Photosensitive Silver Halide>>

The image forming layer contains a photosensitive silver halide.

1) Halogen Composition

The photosensitive silver halide used in the present disclosure is not particularly limited as a halogen composition, and silver halide, silver chlorobromide, silver bromide, silver iodobromide, silver iodochlorobromide, and silver iodide can be suitably used. Among these, for example, silver bromide, silver iodobromide, and silver iodide are more preferable. In the particles, the halogen composition may be evenly distributed, may change stepwise, or may change continuously. Furthermore, silver halide particles each having a core/shell structure can be preferably used. Core/shell particles each having a structure constituted with 2 to 5 layers can be preferably used, and core/shell particles each having a structure constituted with 2 to 4 layers can be more preferably used. Furthermore, it is possible to preferably use a technique of localizing silver bromide or silver iodide on the surface of a silver chloride particle, a silver bromide particle, or a silver chlorobromide particle.

2) Particle Forming Method

The method for forming the photosensitive silver halide is well known in the field of the related art. For example, it is possible to use the methods described in Research Disclosure, June 1978, No. 17029 and the specification of U.S. Pat. No. 3,700,458A. Specifically, a method is used in which a silver supply compound and a halogen supply compound are added to gelatin or another polymer solution such that a photosensitive silver halide is prepared, and then the photosensitive silver halide is mixed with an organic silver salt. In addition, the method described in paragraphs “0217” to “0224” in JP1999-119374A (JP-H11-119374A) and the method described in JP1999-352627A (JP-H11-352627A) or JP2000-347335A are also preferable.

3) Particle Size

In order to reduce the turbidity after the formation of an image, the photosensitive silver halide preferably has a small particle size. Specifically, the particle size is preferably equal to or smaller than 0.20 μm, more preferably equal to or greater than 0.01 μm and equal to or smaller than 0.15 μm, and even more preferably equal to or greater than 0.02 μm and equal to or smaller than 0.12 μm. The particle size mentioned herein refers to a diameter expressed in terms of the diameter of a circle having the same area as the projected area of a silver halide particle (in the case of a flat particle, the projected area of a main plane).

4) Particle Shape

Examples of the shape of the photosensitive silver halide particles include a cubical shape, an octahedral shape, a flat plate shape, a spherical shape, a rod shape, a potato shape, and the like. In the present disclosure, cubical particles are particularly preferable. Furthermore, it is possible to preferably use silver halide particles having corners rounded off.

The plane index (Miller index) of the outer surface of the photosensitive silver halide particles is not particularly limited. However, it is preferable that the (100) plane, which shows a high spectral sensitizing efficiency in a case where a spectral sensitizing dye is adsorbed onto the particles, accounts for a high proportion. The proportion is preferably equal to or higher than 50%, more preferably equal to or higher than 65%, and even more preferably equal to or higher than 80%. The proportion of the (100) plane defined by the Miller index can be determined by the method described in T. Tani; J. Imaging Sci., 29, 165 (1985) exploiting the adsorption dependence of the (111) plane and the (100) plane in the adsorption of a sensitizing dye.

5) Heavy Metal

The photosensitive silver halide particles in the present disclosure can contain a metal or a metal complex in group 6 to group 13 on the periodic table (showing group 1 to group 18). It is preferable that the photosensitive silver halide particles contain a metal or a metal complex in group 6 to group 10. As the central metal of the metal or the metal complex in group 6 to group 10 on the periodic table, for example, iron, rhodium, ruthenium, and iridium are preferable. One kind of these metal complexes may be used singly, or two or more kinds of complexes of similar metals or dissimilar metals may be used in combination. The content rate of the metal or the metal complex with respect to 1 mol of silver is preferably within a range of 1×10⁻⁹ mol to 1×10⁻³ mol. These heavy metals, metal complexes, and how to add these are described in JP1995-225449A (JP-H07-225449A), paragraphs “0018” to “0024” in JP1999-065021A (JP-H11-065021A), or paragraphs “0227” to “0240” in JP1999-119374A (JP-H11-119374A).

In the present disclosure, silver halide particles in which a hexacyano metal complex is present on the outermost surface of each of the particles are preferable. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻, and the like. In the present disclosure, a hexacyanoferrate complex is preferable.

In an aqueous solution, the hexacyano metal complex is present in the form of an ion. Therefore, the countercation thereof is not important. However, it is preferable to use an alkali metal ion such as a sodium ion, a potassium ion, a rubidium ion, a cesium ion, and a lithium ion, an ammonium ion, and an alkyl ammonium ion (for example, a tetramethylammonium ion, a tetraethylammonium ion, a tetrapropylammonium ion, or a tetra(n-butyl)ammonium ion) that are easily mixed with water and suitable for a precipitation operation of a silver halide emulsion.

The hexacyano metal complex can be added to the particles by being mixed with a mixed solvent, which is formed of water and an appropriate organic solvent (for example, alcohols, ethers, glycols, ketones, esters, amides, or the like) miscible with water, or gelatin.

The amount of the hexacyano metal complex added per 1 mol of silver is preferably equal to or greater than 1×10⁻⁵ mol and equal to or smaller than 1×10⁻² mol, and more preferably equal to or greater than 1×10⁻⁴ mol and equal to or smaller than 1×10⁻³ mol.

In order to make the hexacyano metal complex present on the outermost surface of the silver halide particles, the hexacyano metal complex is directly added before the end of a preparation step, which starts after the end of the addition of an aqueous silver nitrate solution used for forming the particles and lasts before a chemical sensitization step of performing chalcogen sensitization such as sulfur sensitization, selenium sensitization, or tellurium sensitization or precious metal sensitization such as gold sensitization, during a rinsing step or dispersion step, or before the chemical sensitization step. In order to prevent the growth of silver halide particles, it is preferable that the hexacyano metal complex is promptly added after the particles are formed or added before the end of the preparation step.

The addition of the hexacyano metal complex may be started after the amount of silver nitrate, which is added for forming particles, added becomes 96% by mass of the total amount thereof, more preferably be started after the amount of silver nitrate added becomes 98% by mass, and particularly preferably be started after the amount of silver nitrate added becomes 99% by mass.

In a case where the hexacyano metal complex is added after the addition of the aqueous silver nitrate solution immediately before the end of the formation of particles, the hexacyano metal complex can be adsorbed onto the outermost surface of the silver halide particles, and most of the hexacyano metal complex forms a poorly soluble salt together with the silver ion on the particle surface. The silver salt of hexacyanoferrate (II) is a salt having solubility poorer than that of AgI. Therefore, it is possible to prevent the occurrence of redissolution caused by fine particles and to manufacture silver halide fine particles having a small particle size.

The metal atom (for example, [Fe(CN)₆]⁴⁻) which can be incorporated into the silver halide particles used in the present disclosure, the desalting method of the silver halide emulsion, or the chemical sensitization method is described in paragraphs “0046” to “0050” in JP1999-084574A (JP-H11-084574A), paragraphs “0025” to “0031” in JP1999-065021A (JP-H11-065021A), or paragraphs “0242” to “0250” in JP1999-119374A (JP-H11-119374A).

6) Gelatin

The photosensitive silver halide emulsion used in the present disclosure may contain gelatin.

As the gelatin, various gelatins can be used. The photosensitive silver halide emulsion needs to remain excellently dispersed in the organic silver salt-containing coating solution. Therefore, it is preferable to use gelatin having a molecular weight (Mw) of 10,000 to 1,000,000. Furthermore, it is preferable that the substituent of the gelatin is subjected to a phthalating treatment. The gelatin may be used at the time of forming particles or at the time of dispersion after a desalting treatment, but it is preferable to use the gelatin at the time of forming particles.

The amount of the photosensitive silver halide added that is expressed as the amount of silver (amount of the element silver) used for coating per 1 m² of the aforementioned image forming layer is preferably equal to or greater than 0.03 g/m² and equal to or smaller than 0.6 g/m², more preferably equal to or greater than 0.05 g/m² and equal to or smaller than 0.5 g/m², and particularly preferably equal to or greater than 0.07 g/m² and equal to or smaller than 0.4 g/m².

Furthermore, the amount of the photosensitive silver halide added with respect to 1 mol of the non-photosensitive organic silver salt is preferably equal to or greater than 0.01 mol and equal to or smaller than 0.5 mol, more preferably equal to or greater than 0.02 mol and equal to or smaller than 0.3 mol, and even more preferably equal to or greater than 0.03 mol and equal to or smaller than 0.2 mol.

Examples of the mixing method and the mixing condition of the photosensitive silver halide and the non-photosensitive organic silver salt, which will be described later, separately prepared include a method of mixing together the silver halide particles and the organic silver salt, which have been separately prepared, by using a high-speed stirrer, a ball mill, a sand mill, a colloidal mill, a colloid mill, a vibratory mill, a homogenizer, or the like, a method of preparing the organic silver salt by mixing this with the photosensitive silver halide, which has been prepared, at any timing in the process of preparing the organic silver salt, and the like. However, as long as the effects of the present disclosure are sufficiently demonstrated, the mixing method is not particularly limited. Furthermore, at the time of mixing, in order to control the photographic characteristics, it is preferable to use a method of mixing two or more kinds of aqueous dispersion liquids of organic silver salts with two or more kinds of aqueous dispersion liquids of photosensitive silver salts.

The period of time for adding the photosensitive silver halide to the image forming layer coating solution is preferably from 180 minutes before coating to immediately before coating, and more preferably from 60 minutes before coating to 10 seconds before coating. However, the mixing method and the mixing condition are not particularly limited as long as the effects of the present disclosure are sufficiently demonstrated. Specifically, the mixing method includes a method of performing mixing in a tank which is controlled such that an average retention time calculated from the flow rate of the solution added and the amount of the solution supplied to a coater becomes a desired time, and a method of using the static mixer described in “Liquid Mixing Technique” (N. Harnby, M. F. Edwards, A. W. Nienow, translated by Koji Takahashi, The Nikkan Kogyo Shimbun, Ltd., 1989, Chapter 8), and the like.

<<Non-Photosensitive Organic Silver Salt>>

The image forming layer contains a non-photosensitive organic silver salt.

1) Composition

The non-photosensitive organic silver salt which can be used in the image forming layer (hereinafter, in some cases, the non-photosensitive organic silver salt will be described as first non-photosensitive organic silver salt such that it is distinguished from a second non-photosensitive organic silver salt which will be described later) is a silver salt which is relatively stable against light and forms a silver image by functioning as a silver ion supply source in a case where the silver salt is heated at a temperature equal to or higher than 80° C. in the presence of an exposed photosensitive silver halide and a reducing agent. The organic silver salt may be any organic substance capable of supplying silver ions which can be reduced by the reducing agent. Such a non-photosensitive organic silver salt is described in paragraphs “0048” and “0049” in JP1998-062899A (JP-H10-062899A), line 24 on p. 18 to line 37 on p. 19 in the specification of EP0803764A1, the specification of EP0962812A1, JP1999-349591A (JP-H11-349591A), JP2000-007683A, JP2000-072711A, and the like. A silver salt of an organic acid, particularly is a silver salt of a long-chain aliphatic carboxylic acid (having 10 to 30 carbon atoms and preferably having 15 to 28 carbon atoms) is preferable. As a fatty acid silver salt, for example, silver lignocerate, silver behenate, silver arachidate, silver stearate, silver oleate, silver laurate, silver caproate, silver myristate, silver palmitate, silver erucate, a mixture of these, and the like are preferable. In the present disclosure, among these fatty acid silver, it is preferable to use fatty acid silver in which the content rate of silver behenate is equal to or higher than 50 mol % and equal to or lower than 100 mol %, more preferably equal to or higher than 85 mol % and equal to or lower than 100 mol %, and even more preferably equal to or higher than 95 mol % and equal to or lower than 100 mol %. Furthermore, it is preferable to use fatty acid silver in which the content rate of silver erucate is equal to or lower than 2 mol %, more preferably equal to or lower than 1 mol %, and even more preferably equal to or lower than 0.1 mol %.

The content rate of silver stearate is preferably equal to or lower than 1 mol %. In a case where the content rate of silver stearate is equal to or lower than 1 mol %, a silver salt of an organic acid is obtained which responds at a low minimum density (Dmin), has high sensitivity, and results in excellent image preservability. The content rate of silver stearate is preferably equal to or lower than 0.5 mol %. It is particularly preferable that the image forming layer substantially does not contain the stearic acid.

In a case where the image forming layer contains silver arachidate as a silver salt of a non-photosensitive organic acid, the content rate of the silver arachidate is preferably equal to or lower than 6 mol % in view of obtaining low Dmin and obtaining a silver salt of an organic acid resulting in excellent image preservability, and more preferably equal to or lower than 3 mol %.

2) Shape

The shape of the non-photosensitive organic silver salt which can be used in the present disclosure is not particularly limited, and may be any of a needle shape, a rod shape, a flat plate shape, and a scale shape. Among these, an organic silver salt having a scale shape is preferable. Furthermore, needle-like particles in which the length ratio between a major axis and a minor axis is equal to or lower than 5, rectangular particles, cubical particles, or amorphous particles having the shape of a potato are also preferably used. Compared to long needle-like particles in which the length ratio between the major axis and the minor axis is equal to or higher than 5, these organic silver particles less cause fogging at the time of thermal development. Particularly, particles in which the ratio between the major axis and the minor axis is equal to or lower than 3 are preferable because these particles improve the mechanical stability of a coating film. In the present specification, the organic silver salt having a scale shape is defined as below. An organic acid silver salt is observed using an electron microscope, and the shape of the organic acid silver salt particle is approximated to a rectangle. The sides of the rectangle are named a, b, and c in ascending order of the length of the sides (c and b may be the same as each other), and x is calculated as below from the numerical values a and b of the short sides.

x=b/a

In this way, x is calculated for about 200 particles, and the average thereof is adopted as x (average). At this time, the particles satisfying the relationship of x (average)≥1.5 are regarded as scale-like particles. The particles preferably satisfy 30≥x (average)≥1.5 and more preferably satisfy 15≥x (average)≥1.5. In addition, needle-like particles are particles satisfying 1≤x (average)≤1.5.

In the scale-like particles, a can be regarded as the thickness of a flat plate-like particle having a surface with sides b and c as a main plane. The average of a is preferably equal to or greater than 0.01 μm and equal to or smaller than 0.3 μm, and more preferably equal to or greater than 0.1 μm and equal to or smaller than 0.23 μm. The average of c/b is preferably equal to or greater than 1 and equal to or smaller than 9, more preferably equal to or greater than 1 and equal to or smaller than 6, even more preferably equal to or greater than 1 and equal to or smaller than 4, and particularly preferably equal to or greater than 1 and equal to or smaller than 3.

In a case where the equivalent spherical diameter of the particles is equal to or greater than 0.05 m and equal to or smaller than 1 m, the particles are hardly aggregated in the thermally-developable photosensitive material, and the image preservability is improved. The equivalent spherical diameter is preferably equal to or greater than 0.1 m and equal to or smaller than 1 μm. In the present disclosure, the equivalent spherical diameter is measured by a method of directly imaging a sample by using an electron microscope and then performing an image processing on negative images.

For the scale-like particles, (equivalent spherical diameter of particles)/a is defined as an aspect ratio. From the viewpoint of making it difficult for the particles to be aggregated in the thermally-developable photosensitive material and improving the image preservability, the aspect ratio of the scale-like particles is preferably equal to or higher than 1.1 and equal to or lower than 30, and more preferably equal to or higher than 1.1 and equal to or lower than 15.

The particle size distribution of the organic silver salt is preferably monodispersed. “Monodispersed” means that a percentage of a value, which is obtained by dividing a standard deviation of the length of each of the minor axis and the major axis by the minor axis and the major axis respectively, is preferably equal to or lower than 100%, more preferably equal to or lower than 80%, and even more preferably equal to or lower than 50%. The shape of the organic silver salt can be measured by a method of using a transmission electron micrograph of the organic silver salt dispersion. As another method for measuring the monodispersity, there is a method of calculating a standard deviation of volume weighted average diameter of the organic silver salt. The percentage (coefficient of variation) of the value obtained by dividing the standard deviation by the volume weighted average diameter is preferably equal to or lower than 100%, more preferably equal to or lower than 80%, and even more preferably equal to or lower than 50%. As the measurement method, for example, the organic silver salt dispersed in a liquid is irradiated with laser light, and a coefficient of autocorrelation relative to the temporal change of fluctuation of the scattered light is determined. From the particle size (volume weighted average diameter) obtained in this way, the monodispersity can be determined.

3) Preparation

The non-photosensitive organic silver salt used in the present disclosure can be manufactured and dispersed using known methods and the like. For example, it is possible to refer to JP1998-062899A (JP-H10-062899A), the specification of EP0803763A1, the specification of EP0962812A1, JP1999-349591A (JP-H11-349591A), JP2000-007683A, and JP2000-072711A described above, JP2001-163889A, JP2001-163890A, JP2001-163827A, JP2001-033907A, JP2001-188313A, JP2001-083652A, JP2002-006442A, JP2002-049117A, JP2002-031870A, and JP2002-107868A.

In a case where a photosensitive silver salt coexists at the time of dispersing the non-photosensitive organic silver salt, fogging occurs to a higher extent, and sensitivity is significantly reduced. Therefore, it is more preferable that the non-photosensitive organic silver salt substantially does not contain the photosensitive silver salt at the time of dispersion. In the present disclosure, the amount of the photosensitive silver salt in the aqueous dispersion liquid to be dispersed with respect to 1 mol of the organic acid silver salt in the liquid is preferably equal to or smaller than 1 mol %, and more preferably equal to or smaller than 0.1 mol %. It is even more preferable that the photosensitive silver salt is not added as far as possible.

In the present disclosure, the thermally-developable photosensitive material can be manufactured by mixing the aqueous dispersion liquid of the non-photosensitive organic silver salt with an aqueous dispersion liquid of the photosensitive silver salt. The mixing ratio between the non-photosensitive organic silver salt and the photosensitive silver salt is selected according to the purpose. The ratio of the photosensitive silver salt to the organic silver salt is preferably within a range of 1 mol % to 30 mol %, more preferably within a range of 2 to 20 mol %, and particularly preferably within a range of 3 mol % to 15 mol %. At the time of mixing, in order to control the photographic characteristics, it is preferable to use a method of mixing two or more kinds of aqueous dispersion liquids of organic silver salts with two or more kinds of aqueous dispersion liquids of photosensitive silver salts.

4) Added Amount

The non-photosensitive organic silver salt can be used in a desired amount. In the image forming layer, from the viewpoint of the sensitivity and the image preservability, the total amount of silver (amount of the element silver) used for coating including the silver halide is preferably 0.1 g/m² to 1.5 g/m², more preferably 0.3 g/m² to 1.5 g/m², even more preferably 0.3 g/m² to 1.4 g/m², and particularly preferably 0.5 g/m² to 1.3 g/m². Particularly, in order to improve the image preservability, the total amount of silver used for coating is preferably equal to or smaller than 1.5 g/m², and more preferably 0.8 g/m² to 1.3 g/m². In a case where the preferable reducing agent, which will be described later, is used, even though the amount of silver is small as described above, a sufficient image density can be obtained.

<<Reducing Agent>>

The image forming layer contains a reducing agent.

The thermally-developable photosensitive material according to the present disclosure contains a reducing agent which is preferably a reducing agent for the non-photosensitive organic silver salt. The reducing agent for the non-photosensitive organic silver salt may be any substance (preferably an organic substance) reducing silver ions into metallic silver. Examples of such a reducing agent are described in paragraphs “0043” to “0045” in JP1999-065021A (JP-H11-065021A) or line 34 on p. 7 to line 12 on p. 18 in the specification of EP0803764A1.

In the present disclosure, as the reducing agent, a so-called hindered phenol-based reducing agent or bisphenol-based reducing agent having a substituent on the ortho-position of a phenolic hydroxyl group is preferable, and a compound represented by Formula R is more preferable.

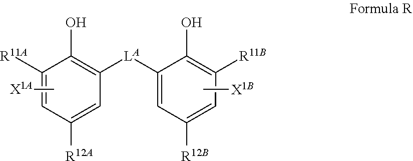

In Formula R, R^{11A} and R^{11B} each independently represent an alkyl group having 1 to 20 carbon atoms, R^{12A} and R^{12B} each independently represent a hydrogen atom or a substituent which can be substituted with a benzene ring, L^{A} represents a —S— group or a CHR^{13A}-group, R^{13A} represents a hydrogen atom or an alkyl group having 1 to 20 carbon atoms, and X^{1A} and X^{1B} each independently represent a hydrogen atom or a group which can be substituted with a benzene ring.

Formula R will be specifically described.

Hereinafter, unless otherwise specified, in a case where an alkyl group is mentioned, a cycloalkyl group is also included in the alkyl group.

1) R^{11A} and R^{11B}

R^{11A} and R^{11B} each independently represent a substituted or unsubstituted alkyl group having 1 to 20 carbon atoms. The substituent of the alkyl group is not particularly limited, and preferable examples thereof include an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, a ureide group, a urethane group, a halogen atom, and the like.

2) R^{12A}, R^{12B}, X^{1A}, and X^{1B}

R^{12A} and R^{12B} each independently represent a hydrogen atom or a substituent which can be substituted with a benzene ring. X^{1A} and X^{1B} each independently represent a hydrogen atom or a group which can be substituted with a benzene ring. As the group which can be substituted with a benzene ring, for example, an alkyl group, an aryl group, a halogen atom, an alkoxy group, and an acylamino group are preferable.

3) L^{A}

L^{A} represents a —S— group or a CHR^{13A}-group. R^{13A} represents a hydrogen atom or an alkyl group having 1 to 20 carbon atoms. The alkyl group may have a substituent. Specific examples of an unsubstituted alkyl group represented by R^{13A} include a methyl group, an ethyl group, a propyl group, a butyl group, a heptyl group, a undecyl group, an isopropyl group, a 1-ethylpentyl group, a 2,4,4-trimethylpentyl group, a cyclohexyl group, a 2,4-dimethyl-3-cyclohexenyl group, a 3,5-dimethyl-3-cyclohexenyl group, and the like. Examples of the substituent of the alkyl group are the same as the examples of the substituent of R^{11A}, which include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, a sulfamoyl group, and the like.

4) Preferable Substituent

As R^{11A} and R^{11B}, a primary, secondary, or tertiary alkyl group having 1 to 15 carbon atoms is preferable. Specifically, examples thereof include a methyl group, an isopropyl group, a t-butyl group, a t-amyl group, a t-octyl group, a cyclohexyl group, a cyclopentyl group, a 1-methylcyclohexyl group, a 1-methylcyclopropyl group, and the like. As R^{11A} and R^{11B}, an alkyl group having 1 to 4 carbon atoms is more preferable. Among these, a methyl group, a t-butyl group, a t-amyl group, or a 1-methylcyclohexyl group is more preferable, and a methyl group or a t-butyl group is most preferable.

As R^{12A} and R^{12B}, an alkyl group having 1 to 20 carbon atoms is preferable. Specifically, examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, and the like. Among these, a methyl group, an ethyl group, a propyl group, an isopropyl group, or a t-butyl group is more preferable, and a methyl group or an ethyl group is particularly preferable.

As X^{1A} and X^{1B}, a hydrogen atom, a halogen atom, or an alkyl group is preferable, and a hydrogen atom is more preferable.

L^{A} is preferably a CHR^{13A}-group.

R^{13A} is preferably a hydrogen atom or an alkyl group having 1 to 15 carbon atoms. As the alkyl group, in addition to a chain-like alkyl group, a cyclic alkyl group is also preferably used. Among these alkyl groups, those having a C═C bond can also be preferably used. As the alkyl group, for example, a methyl group, an ethyl group, a propyl group, an isopropyl group, a 2,4,4-trimethylpentyl group, a cyclohexyl group, a 2,4-dimethyl-3-cyclohexenyl group, a 3,5-dimethyl-3-cyclohexenyl group, or the like is preferable. R^{13A} is particularly preferably a hydrogen atom, a methyl group, an ethyl group, a propyl group, an isopropyl group, or a 2,4-dimethyl-3-cyclohexenyl group.

In a case where R^{11A} and R^{11B} each represent a tertiary alkyl group, and R^{12A} and R^{12B} each represent a methyl group, R^{13A} is preferably a primary or secondary alkyl group having 1 to 8 carbon atoms (a methyl group, an ethyl group, a propyl group, an isopropyl group, a 2,4-dimethyl-3-cyclohexenyl group, or the like).

In a case where R^{11A} and R^{11B} each represent a tertiary alkyl group, and R^{12A} and R^{12B} each represent an alkyl group other than a methyl group, R^{13A} is preferably a hydrogen atom. In a case where R^{11A} and R^{11B} do not represent a tertiary alkyl group, R^{13A} is preferably a hydrogen atom or a secondary alkyl group, and particularly preferably a secondary alkyl group. As the secondary alkyl group represented by R^{13A}, an isopropyl group and a 2,4-dimethyl-3-cyclohexenyl group are preferable.

The thermal developability, the tone of silver developed, and the like are changed according to the combination of R^{11A}, R^{11B}, R^{12A}, R^{12B}, and R^{13A} in the reducing agent, and can be adjusted by combining two or more kinds of reducing agents. Therefore, it is preferable to use two or more kinds of reducing agents in combination according to the purpose.

Specific examples of the reducing agent including the compound represented by Formula R that is suitably used in the present disclosure will be shown below, but the present disclosure is not limited thereto.

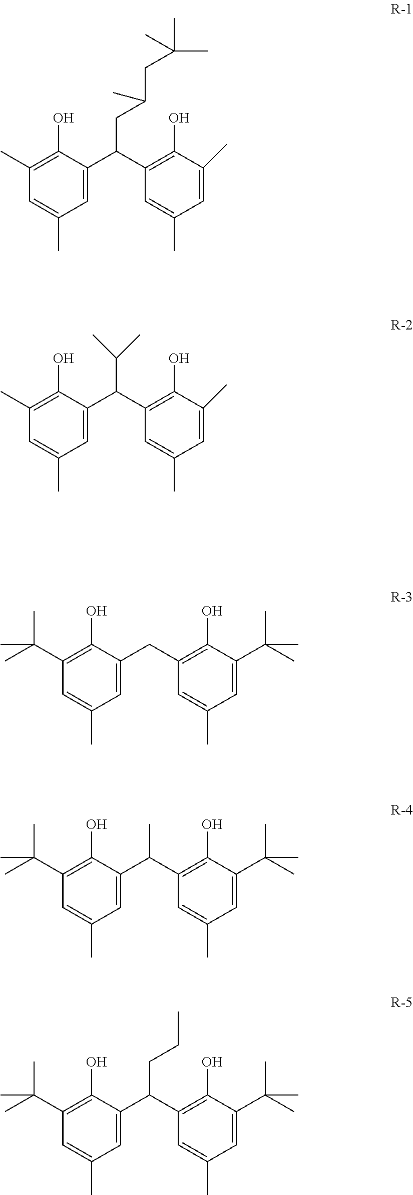

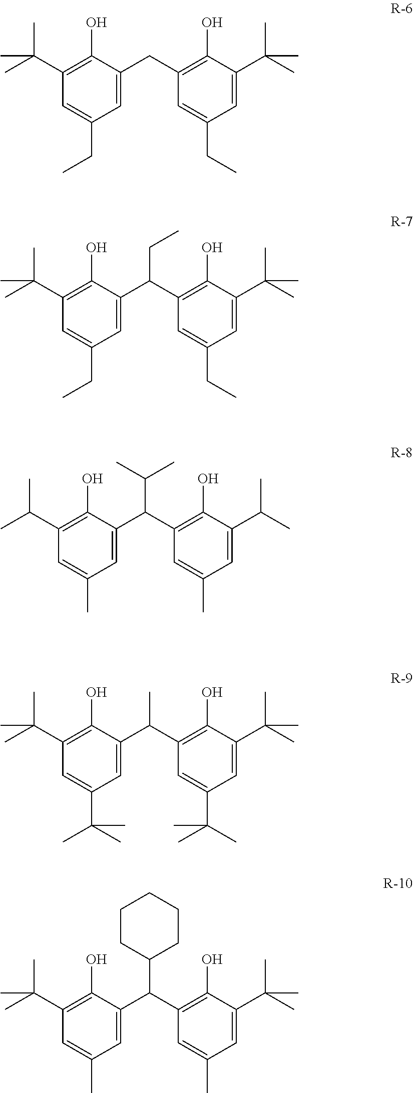

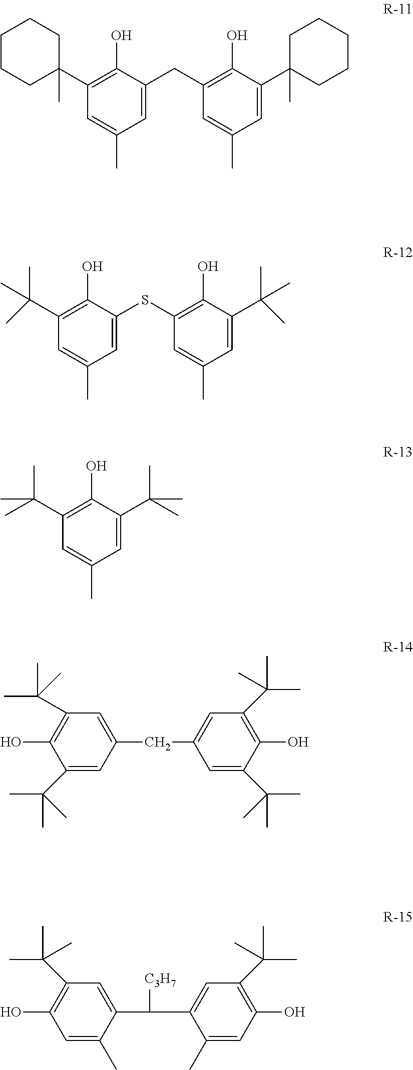

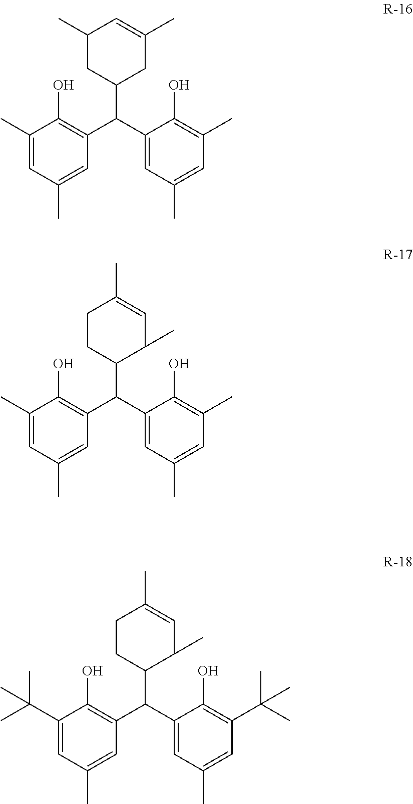

Examples of the preferable reducing agent of the present disclosure other than the above include the compounds described in JP2001-188314A, JP2001-209145A, JP2001-350235A, JP2002-156727A, and the specification of EP1278101A2.

In the present disclosure, the amount of the reducing agent added is preferably 0.1 g/m² to 3.0 g/m², more preferably 0.2 g/m² to 2.0 g/m², and even more preferably 0.3 g/m² to 1.0 g/m². The content of the reducing agent with respect to 1 mol of silver within a surface having the image forming layer is preferably 5 mol % to 50 mol %, more preferably 8 mol % to 30 mol %, and even more preferably 10 mol % to 20 mol %. It is preferable that the image forming layer and the adjacent layer contain the reducing agent.

The reducing agent may be incorporated into the thermally-developable photosensitive material by being incorporated into the coating solution by any method such as being made into a solution, emulsification dispersion, or being made into a solid particle dispersion.

As the emulsification dispersion method, for example, a method is well known in which the reducing agent is dissolved using oil such as dibutyl phthalate, tricresyl phosphate, dioctyl sebacate, or tri(2-ethylhexyl)phosphate and an auxiliary solvent such as ethyl acetate or cyclohexanone, a surfactant such as sodium dodecylbenzene sulfonate, sodium N-methyl-oleyl laurate, or sodium di(2-ethylhexyl)sulfosuccinate is added thereto, and an emulsified dispersion is mechanically prepared. At this time, for the purpose of adjusting the viscosity of oil droplets or refractive index, it is also preferable to add a polymer such as an α-methylstyrene oligomer or poly(t-butylacrylamide).

Examples of the solid particle dispersion method include a method of preparing a solid dispersion by dispersing reducing agent powder in an appropriate solvent such as water by using a ball mill, a colloid mill, a vibratory ball mill, a sand mill, a jet mill, a roller mill, or ultrasound. At this time, a protective colloid (for example, polyvinyl alcohol) or a surfactant (for example, an anionic surfactant such as sodium triisopropyl naphthalene sulfonate (mixture in which three isopropyl groups are substituted in different positions)) may be used. Generally, in the aforementioned mills, beads such as zirconia are used as a dispersion medium. In some cases, zirconium (Zr) and the like eluted from these beads are mixed into the dispersion. The concentration of Zr and the like is within a range of 1 ppm to 1,000 ppm, although the concentration depends on the dispersion conditions as well. The content of Zr in the thermally-developable photosensitive material is preferably equal to or smaller than 0.5 mg per 1 g of silver.

It is preferable to incorporate a preservative (for example, sodium benzisothiazolinone) into the aqueous dispersion.

It is particularly preferable to add the reducing agent after making the reducing agent into particles by the solid particle dispersion method. The average particle size of the particles is preferably 0.01 μm to 10 μm, more preferably 0.05 μm to 5 μm, and even more preferably 0.1 μm to 2 μm. In the present disclosure, other solid dispersions are preferably used by being dispersed to obtain the particle size within the above range.

<<Binder>>

The image forming layer contains a binder.

In the present disclosure, as the binder (binder polymer) used in the image forming layer, any polymer may be used. Examples of a suitable binder include a natural resin, polymer, or oligomer, a synthetic resin, polymer, or oligomer, and other film forming media that are transparent or semi-transparent and colorless in general, such as gelatins, rubbers, poly(vinylalcohols), hydroxyethyl celluloses, cellulose acetates, cellulose acetate buytyrates, poly(vinylpyrrolidones), casein, starch, poly(acrylic acids), poly(methyl methacrylates), poly(vinyl chlorides), poly(methacrylic acids), styrene-maleic acid anhydride copolymers, styrene-acrylonitrile copolymers, styrene-butadiene copolymers, poly(vinylacetals) (for example, poly(vinylformal) and poly(vinylbutyral)), poly(esters), poly(urethanes), a phenoxy resin, poly(vinylidene clorides), poly(epoxides), poly(carbonates), poly(vinyl acetates), poly(olefins), cellulose esters, and poly(amides). The binder may form a coat from water, an organic solvent, or an emulsion.

In the present disclosure, regarding the binder, “transparent” means that the visible light (400 to 700 nm) transmittance of the binder is equal to or higher than 80%, and “semi-transparent” means the visible light (400 to 700 nm) transmittance of the binder is equal to or higher than 10% and less than 80%.

The glass transition temperature (Tg) of the binder is preferably equal to or higher than 0° C. and equal to or lower than 80° C. (hereinafter, referred to as high Tg binder as well in some cases), more preferably equal to or higher than 10° C. and equal to or lower than 70° C., and even more preferably equal to or higher than 15° C. and equal to or lower than 60° C.

In the present specification, Tg is calculated by the following equation.

1/Tg=Σ(Xᵢ/Tgᵢ)

Herein, i represents an integer of 1 to n, and a polymer is regarded as being obtained by the copolymerization of n pieces of monomer components. Xᵢ represents a mass fraction of the i^{th} monomer (ΣXᵢ=1), and Tgᵢ represents a glass transition temperature (absolute temperature) of a homopolymer of the i^{th} monomer. Here, Σ represents the sum of the integers 1 to n represented by i. As the value (Tgᵢ) of the glass transition temperature of the homopolymer of each monomer, the value described in Polymer Handbook (3^{rd} Edition) (J. Brandrup, E. H. Immergut (Wiley-Interscience, 1989)) is adopted.

If necessary, two or more kinds of binders may be used in combination. Furthermore, a binder having a glass transition temperature equal to or higher than 20° C. and a binder having a glass transition temperature lower than 20° C. may be used in combination. In a case where two or more kinds of polymers having different Tg are blended and used, a mass-average Tg thereof is preferably within the above range.

In the present disclosure, the image forming layer is preferably formed by performing coating by using a coating solution containing a solvent, in which the proportion of water is equal to or higher than 30% by mass, and drying the coating solution so as to form a coating film.

In the present disclosure, in a case where the image forming layer is formed by performing coating by using the coating solution containing a solvent, in which the proportion of water is equal to or higher than 30% by mass, and drying the coating solution, and in a case where the binder in the image forming layer is soluble or dispersible in an aqueous solvent (water solvent) and is particularly formed of latex of a polymer having an equilibrium moisture content equal to or smaller than 2% by mass at 25° C. and 60% RH, the performance is improved. In the most preferable aspect, the binder is prepared such that an ion conductivity thereof becomes equal to or lower than 2.5 mS/cm. Examples of the preparation method include a method of synthesizing a polymer and then performing a purification treatment by using a functional membrane for separation.

The aqueous solvent in which the polymer is soluble or dispersible is water or a solvent obtained by mixing water with a water-miscible organic solvent in an amount of equal to or smaller than 70% by mass. Examples of the water-miscible organic solvent include alcohols such as methyl alcohol, ethyl alcohol, and propyl alcohol, cellosolves such as methyl cellosolve, ethyl cellosolve, and butyl cellosolve, ethyl acetate, dimethylformamide, and the like.

Herein, for the solvents in which a polymer is present in a so-called dispersion state without being thermodynamically dissolved, the term “aqueous solvent” is used.

“Equilibrium moisture content at 25° C. and 60% RH” can be represented by the following equation by using a mass W₁ of a polymer controlled to be in humidity equilibrium in an atmosphere of 25° C. and 60% RH and a mass W₀ of the polymer in an absolute dry condition at 25° C.

[Equilibrium moisture content at 25° C. and 60% RH]={(W₁−W₀)/W₀}×100(% by mass)

Regarding the definition and the measurement method of the equilibrium moisture content, for example, “Polymer Engineering Course 14, Polymer Material Testing Method (edited by The Society of Polymer, Japan, Chijinshokan Co., Ltd.) can be referred to.

In the present disclosure, the equilibrium moisture content of the binder polymer at 25° C. and 60% RH is preferably equal to or smaller than 2% by mass, more preferably equal to or greater than 0.01% by mass and equal to or smaller than 1.5% by mass, and even more preferably equal to or greater than 0.02% by mass and equal to or smaller than 1% by mass.

In the present disclosure, a polymer dispersible in an aqueous solvent is particularly preferable. The polymer may be dispersed in any state, and examples thereof include a state where hydrophobic polymer particles insoluble in water are dispersed to form latex, a state where polymer molecules are dispersed as they are or dispersed to form a micelle, and the like. The particles dispersed to form latex are more preferable. The average particle size of the dispersed particles is equal to or greater than 1 nm and equal to or smaller than 50,000 nm, preferably is within a range equal to or greater than 5 nm and equal to or smaller than 1,000 nm, more preferably within a range equal to or greater than 10 nm and equal to or smaller than 500 nm, and even more preferably within a range equal to or greater than 50 nm and equal to or smaller than 200 nm. The particle size distribution of the dispersed particles is not particularly limited. The particles may have a wide particle size distribution or a monodisperse particle size distribution. In order to control the physical properties of the coating solution, it is preferable to use a mixture of two or more kinds of particles having a monodisperse particle size distribution.

In the present disclosure, as a preferable aspect of the polymer dispersible in an aqueous solvent, it is possible to preferably use hydrophobic polymers such as an acrylic polymer, poly(esters), rubbers (for example, styrene butadiene rubber (SBR resin)), poly(urethanes), poly(vinyl chlorides), poly(vinyl acetates), poly(vinylidene chlorides), and poly(olefins). These polymers may be linear polymers, branched polymers, or crosslinked polymers. Furthermore, these polymers may be so-called homopolymers formed by the polymerization of one kind of monomer or copolymers formed by the polymerization of two or more kinds of monomers. The copolymers may be random copolymers or block copolymers. The molecular weight, expressed as a number-average molecular weight, of these polymers is preferably equal to or greater than 5,000 and equal to or smaller than 1,000,000, and more preferably equal to or greater than 10,000 and equal to or smaller than 200,000. In a case where the molecular weight is within the above range, the image forming layer has sufficient mechanical strength, and film forming properties become excellent. Furthermore, crosslinking polymer latex is particularly preferably used.

### Specific Examples of Latex

Specific examples of preferable polymer latex include the following ones. Hereinafter, the polymer latex is represented using raw material monomers, the numerical value in a parenthesis represents % by mass, and the molecular weight is a number-average molecular weight. In a case where a polyfunctional monomer is used, a crosslinked structure is formed, and hence the concept of molecular weight is not applicable. Therefore, the polymer latex is described as “crosslinking”, and the molecular weight thereof is not described. Tg represents a glass transition temperature.

P-1; latex of MMA (70)-EA (27)-MAA (3) (molecular weight 37,000, Tg 61° C.)

P-2; latex of MMA (70)-2EHA (20)-St (5)-AA (5) (molecular weight 40,000, Tg 59° C.)

P-3; latex of St (50)-Bu (47)-MAA (3) (crosslinking, Tg −17° C.)

P-4; latex of St (68)-Bu (29)-AA (3) (crosslinking, Tg 17° C.)

P-5; latex of St (71)-Bu (26)-AA (3) (crosslinking, Tg 24° C.)

P-6; latex of St (70)-Bu (27)-IA (3) (crosslinking)

P-7; latex of St (75)-Bu (24)-AA (1) (crosslinking, Tg 29° C.)

P-8; latex of St (60)-Bu (35)-DVB (3)-MAA (2) (crosslinking)

P-9; latex of St (70)-Bu (25)-DVB (2)-AA (3) (crosslinking)

P-10; latex of VC (50)-MMA (20)-EA (20)-AN (5)-AA (5) (molecular weight 80,000)

P-11; latex of VDC (85)-MMA (5)-EA (5)-MAA (5) (molecular weight 67,000)

P-12; latex of Et (90)-MAA (10) (molecular weight 12,000)

P-13; latex of St (70)-2EHA (27)-AA (3) (molecular weight 130,000, Tg 43° C.)

P-14; latex of MMA (63)-EA (35)-AA (2) (molecular weight 33,000, Tg 47° C.)

P-15; latex of St (70.5)-Bu (26.5)-AA (3) (crosslinking, Tg 23° C.)

P-16; latex of St (69.5)-Bu (27.5)-AA (3) (crosslinking, Tg 20.5° C.)

P-17; latex of St (61.3)-isoprene (35.5)-AA (3) (crosslinking, Tg 17° C.)

P-18; latex of St (67)-isoprene (28)-Bu (2)-AA (3) (crosslinking, Tg 27° C.)

The abbreviations for the above structures represent the following monomers.

MMA; methyl methacrylate, EA; ethyl acrylate, MAA; methacrylic acid, 2EHA; 2-ethylhexyl acrylate, St; styrene, Bu; butadiene, AA; acrylic acid, DVB; divinyl benzene, VC; vinyl chloride, AN; acrylonitrile, VDC; vinylidene chloride, Et; ethylene, IA; itaconic acid

The polymer latex described above is commercially available as well, and the following polymers can be used. Examples of the acrylic polymer include CEBIAN A-4635, 4718, and 4601 (manufactured by Daicel Corporation), Nipol Lx811, 814, 821, 820, and 857 (manufactured by ZEON CORPORATION), and the like. Examples of the poly(esters) include FINETEX ES650, 611, 675, and 850 (manufactured by DIC Corporation), WD-size and WMS (manufactured by Eastman Chemical Company), and the like. Examples of the poly(urethanes) include HYDRAN AP10, 20, 30, and 40 (manufactured by DIC Corporation), and the like. Examples of the rubbers include LACSTAR 7310K, 3307B, 4700H, and 7132C (manufactured by DIC Corporation), Nipol Lx416, 410, 438C, and 2507 (manufactured by ZEON CORPORATION), and the like. Examples of the poly(vinyl chlorides) include G351 and G576 (manufactured by ZEON CORPORATION), and the like. Examples of the poly(vinylidene chlorides) include L502 and L513 (manufactured by Asahi Kasei Corporation), and the like. Examples of the poly(olefins) include CHEMIPEARL S120 and SA100 (manufactured by Mitsui Petrochemical Industries, Ltd.), and the like.

One kind of the polymer latex may be used singly. If necessary, two or more kinds of the polymer latex may be used in combination.

—Preferable Latex—

As the polymer latex used in the present disclosure, polymer latex is preferable which has a monomer component represented by General Formula (M) to be described as a binder of an interlayer that will be described later. Particularly, a styrene-butadiene copolymer or styrene-isoprene copolymer latex is preferable. In the styrene-butadiene copolymer, a mass ratio between a styrene monomer unit and a butadiene monomer unit is preferably 40:60 to 95:5. Furthermore, the proportion of the styrene monomer unit and the butadiene monomer unit in the copolymer is preferably 60% by mass to 99% by mass. In the polymer latex of the present disclosure, the content of an acrylic acid or a methacrylic acid with respect to the total content of the styrene and the butadiene is preferably 1% by mass to 6% by mass, and more preferably 2% by mass to 5% by mass. It is preferable that the polymer latex of the present disclosure contains an acrylic acid. A preferable monomer content is the same as described above. Furthermore, the copolymer ratio and the like in the styrene-isoprene copolymer is the same as those in the styrene-butadiene copolymer.

Examples of the styrene-butadiene copolymer latex preferably used in the present disclosure include P-3 to P-9 and P-15 described above, commercial products such as LACSTAR-3307B and 7132C, Nipol Lx416, and the like. Examples of the styrene-isoprene copolymer include P-16 and P-17 described above.

If necessary, a hydrophilic polymer such as gelatin, polyvinyl alcohol, methyl cellulose, hydroxypropyl cellulose, or carboxymethyl cellulose may be added to the image forming layer of the thermally-developable photosensitive material according to the present disclosure. The amount of these hydrophilic polymers added with respect the total amount of the binder in the image forming layer is preferably equal to or smaller than 30% by mass, and more preferably equal to or smaller than 20% by mass.

In the present disclosure, the non-photosensitive organic silver salt-containing layer (that is, the image forming layer) is preferably formed using the polymer latex. The amount of the binder in the image forming layer is set such that the mass ratio of the entirety of the binder/non-photosensitive organic silver salt becomes 1/10 to 10/1, more preferably becomes within a range of 1/3 to 5/1, and even more preferably becomes within a range of 1/1 to 3/1.

Generally, such an organic silver salt-containing layer is a photosensitive layer (image forming layer) containing photosensitive silver halide which is a photosensitive silver salt. In such a layer, the mass ratio of the entirety of the binder/silver halide is within a range of 400 to 5, and more preferably within a range of 200 to 10.

In the present disclosure, the total amount of the binder in the image forming layer is preferably equal to or greater than 0.2 g/m² and equal to or smaller than 30 g/m², more preferably equal to or greater than 1 g/m² and equal to or smaller than 15 g/m², and even more preferably equal to or greater than 2 g/m² and equal to or smaller than 10 g/m². In the present disclosure, a crosslinking agent for crosslinking, a surfactant for improving coating properties, and the like may be added to the image forming layer.

<<Sensitizing Compound>>

It is preferable that the image forming layer contains a sensitizing compound. As the sensitizing compound, a sensitizing dye having a maximum absorption wavelength at 700 nm to 1,400 nm is preferable, and a sensitizing dye having a maximum absorption wavelength at 750 nm to 900 nm is more preferable.

As the sensitizing compound, for example, at least one kind of sensitizing compound selected from the group consisting of an infrared sensitizing dye represented by Formula (III) which will be described later, an intensely color-sensitizing compound represented by Formula (IV), and an intensely color-sensitizing compound represented by Formula (V) is preferable.

From the viewpoint of the sensitivity and the sharpness as image quality of the image to be obtained, it is particularly preferable that image forming layer contains three kinds of sensitizing compounds including the infrared sensitizing dye represented by Formula (III) which will be described later, the intensely color-sensitizing compound represented by Formula (IV), and the intensely color-sensitizing compound represented by Formula (V).

—Infrared Sensitizing Dye Represented by Formula (III)—

From the viewpoint of the sensitivity and the sharpness as image quality of the image to be obtained, it is preferable that the image forming layer contains the infrared sensitizing dye represented by Formula (III).

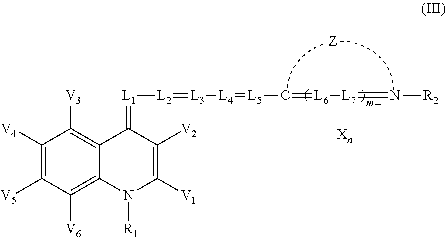

In the formula, V₁, V₂, V₃, V₄, V₅, and V₆ each independently represent a substituent satisfying Y=σp1+σp2+σp3+σp4+σp5+σp6<−0.27 provided that a Hammett constant σp of each of V₁, V₂, V₃, V₄, V₅, and V₆ is σpi (i=1 to 6); R₁ and R₂ each independently represent an alkyl group; L₁, L₂, L₃, L₄, L₅, L₆, and L₇ each independently represent a methine group; m represents 0 or 1; Z represents an atomic group necessary for forming a 5- or 6-membered nitrogen-containing heterocyclic ring; Xₙ represents a charge balancing counterion; and n represents a number equal to or greater than 0 that is necessary for charge neutralization.

Regarding the Hammett constant op, Journal of Medicinal Chemistry, 1973, Vol. 16, No. 11, 1207-1216 and the like can be referred to.

In Formula (III), V₁, V₂, V₃, V₄, V₅, and V₆ preferably each independently represent a hydrogen atom, a halogen atom, an alkyl group, an acyl group, an acyloxy group, an alkoxycarbonyl group, a carbamoyl group, a sulfamoyl group, a carboxy group, a cyano group, a hydroxy group, an amino group, an acylamino group, an alkoxy group, an alkylthio group, an alkylsulfonyl group, a sulfo group, an aryloxy group, or an aryl group, and more preferably each independently represent a hydrogen atom, an alkyl group, a hydroxy group, an amino group, an alkoxy group, or an aryloxy group.

The number of carbon atoms in each of V₁, V₂, V₃, V₄, V₅, and V₆ is preferably 0 to 10.

In Formula (III), R₁ and R₂ preferably each independently represent an alkyl group having 1 to 8 carbon atoms, and more preferably each independently represent an alkyl group having 1 to 4 carbon atoms.

In Formula (III), L₁, L₂, L₃, L₄, L₅, L₆, and L₇ preferably each independently represent an unsubstituted methine group (═CH—), a methine group substituted with an alkyl group, or a methyl group bonded to other structures (other L₁ to L₆ or V₂) such that the group forming the ring structure is substituted, and more preferably each independently represent an unsubstituted methine group or a methine group substituted with an alkyl group.

In Formula (III), m is preferably 0.

In Formula (III), Z preferably represents a group forming a nitrogen-containing heterocyclic ring selected from the group consisting of a thiazole ring, a thiazoline ring, an oxazole ring, an oxazoline ring, a selenazole ring, a selenazoline ring, a tellurazole ring, a tellurazoline ring, an imidazole ring, a 3,3-dialkylindolenine ring, a pyridine ring, a quinoline ring, an isoquinoline ring, an imidazo[4,5-b]quinoxaline ring, an oxadiazole ring, a thiadiazole ring, a tetrazole ring, and a pyrimidine ring. These rings may be further fused with a benzene ring or a naphthalene ring.

Among these, Z more preferably represents a group forming a nitrogen-containing heterocyclic ring selected from the group consisting of a benzothiazole ring, a naphthothiazole ring, a benzoselenazole ring, and a naphthoselenazole ring.

In Formula (III), Xₙ preferably represents a charge balancing counterion, and X preferably represents an anion. The anion may be a monovalent anion or an anion having a valency equal to or higher than 2. Examples of the anion (X) include halide ions (Cl⁻, Br⁻, and I⁻), a p-toluenesulfonate ion, an ethyl sulfate ion, a sulfate ion, an acetate ion, a trifluoromethanesulfonate ion, PF₆⁻, BF₄⁻, and ClO₄⁻.

Specifically, as the infrared sensitizing dye represented by Formula (III), for example, the compounds described in paragraphs “0017” to “0024” in JP1992-335342A (JP-H04-335342A) are suitable.

—Intensely Color-Sensitizing Compound Represented by Formula (IV)—

From the viewpoint of the sensitivity and the sharpness as image quality of the image to be obtained, it is preferable that the image forming layer contains the intensely color-sensitizing compound represented by Formula (IV).

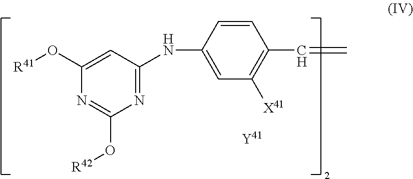

In the formula, R⁴¹ and R⁴² each independently represent a hydrogen atom or a monovalent substituent; X⁴¹ represents an acid anion group; and Y⁴¹ represents a monovalent metal ion.

Examples of the monovalent substituent represented by R⁴¹ and R⁴² in Formula (IV) include a halogen atom; an aliphatic group [a saturated aliphatic group (meaning a cyclic saturated aliphatic group including an alkyl group, a cycloalkyl group, a bicycolalkyl group, a crosslinking cyclic saturated hydrocarbon group, or a spiro saturated hydrocarbon group); an unsaturated aliphatic group (meaning a cyclic unsaturated aliphatic group including an alkenyl group or a chain-like unsaturated aliphatic group similar to an alkenyl group, a cycloalkenyl group, a bicycloalkenyl group, a crosslinking cyclic unsaturated hydrocarbon group, or a spiro saturated hydrocarbon group that have a double bond or a triple bond); an aryl group (preferably a phenyl group which may have a substituent); a heterocyclic group (preferably a 5- to 8-membered ring which contains an oxygen atom, a sulfur atom, or a nitrogen atom as a ring-constituting atom and may be fused with an alicyclic ring, an aromatic ring, or a hetero ring); a cyano group; an aliphatic oxy group (represented by an alkoxy group); an aryloxy group; an acyloxy group; a carbamoyloxy group; an aliphatic oxycarbonyloxy group (represented by an alkoxycarbonyloxy group); an aryloxycarbonyloxy group; an amino group [including an aliphatic amino group (represented by an alkylamino group), an anilino group, and a heterocyclic amino group]; an acylamino group; an aminocarbonylamino group; an aliphatic oxycarbonylamino group (represented by an alkoxycarbonylamino group); an aryloxycarbonylamino group; a sulfamoylamino group; an aliphatic (represented by alkyl) sulfonylamino group or an arylsulfonyl amino group; an aliphatic (represented by alkyl) sulfonyloxy group or an arylsulfonyloxy group; an aliphatic thio group (represented by an alkylthio group); an arylthio group; a sulfamoyl group; an aliphatic (represented by alkyl) sulfinyl group or an arylsulfinyl group; an aliphatic (represented by alkyl) sulfonyl group or an arylsulfonyl group; an acyl group; an aryloxycarbonyl group; an aliphatic oxycarbonyl group (represented by an alkoxycarbonyl group); a carbamoyl group; an arylazo group or a heterocyclic azo group; an imide group; an aliphatic oxysulfonyl group (represented by an alkoxysulfonyl group); an aryloxysulfonyl group; a hydroxyl group; a nitro group; a carboxyl group; and a sulfo group. Each of these groups may further have a substituent (for example, the substituent exemplified above).

X⁴¹ in Formula (IV) is preferably a sulfo group.

Y⁴¹ in Formula (IV) is preferably an alkyl metal ion.

As the intensely color-sensitizing compound represented by Formula (IV), for example, disodium 4,4′-bis(2,6-dinaphthoxypyrimidin-2-ylamino)stilbene disulfonate and isomers and analogs thereof are particularly preferable.

—Intensely Color-Sensitizing Compound Represented by Formula (V)—

From the viewpoint of the sensitivity and the sharpness as image quality of the image to be obtained, it is preferable that the image forming layer contains the intensely color-sensitizing compound represented by Formula (V).

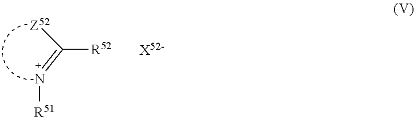

In the formula, Z⁵² represents a non-metal atomic group necessary for forming a 5- or 6-membered nitrogen-containing heterocyclic ring; R⁵¹ represents a hydrogen atom, an alkyl group, or an alkenyl group; R⁵² represents a hydrogen atom or an alkyl group having 1 to 4 carbon atoms; and X⁵²⁻ represents an acid anion.

Z⁵² in Formula (V) is preferably a group forming a nitrogen-containing heterocyclic ring selected from the group consisting of a thiazolinium ring, an oxazolium ring, an imidazolium ring, and a selenazolium ring. These rings may be further fused with a benzene ring or a naphthalene ring. Among these, a group forming a thiazolinium ring is more preferable.

R⁵¹ in Formula (V) is preferably an alkyl group or an alkenyl group, and more preferably an alkyl group. Furthermore, the number of carbon atoms in R⁵¹ is preferably 1 to 8, and more preferably 1 to 4.

As X⁵²⁻ in Formula (V), for example, a halide ion, a perchlorate ion, and a sulfonate ion are preferable.

Specifically, as the intensely color-sensitizing compound represented by Formula (V), for example, the compounds described in paragraphs “0045” to “0049” in JP1992-335342A (JP-H04-335342A) are suitable.

As the sensitizing compounds used in the present disclosure, the compounds described in EP587338A, the specification of U.S. Pat. No. 3,877,943A, the specification of U.S. Pat. No. 4,873,184A, JP1993-341432A (JP-H05-341432A), JP1999-109547A (JP-H11-109547A), JP1998-111543A (JP-H10-111543A), and the like may also be used.

In the thermally-developable photosensitive material according to the present disclosure, other sensitizing compounds known in the related art may also be used in combination. The sensitizing compounds which can be used in combination and how to add these are described in paragraphs “0103” to “0109” in JP1999-065021A (JP-H11-065021A), the compound represented by General Formula (II) in JP1998-186572A (JP-H10-186572A), the colorant represented by General Formula (I) in JP1999-119374A (JP-H11-119374A) and paragraph “0106” in the same publication, the specification of U.S. Pat. No. 5,510,236A, the colorant described in Example 5 in U.S. Pat. No. 3,871,887A, JP1990-096131A (JP-H02-096131A), the colorant disclosed in JP1984-048753A (JP-S59-048753A), line 38 on p. 19 to line 35 on p. 20 in the specification of EP0803764A1, JP2001-272747A, JP2001-290238A, JP2002-023306A, and the like.

One kind of sensitizing compound may be used singly, or two or more kinds of sensitizing compounds may be used in combination.

The content of the sensitizing compound in the image forming layer per 1 mol of the photosensitive silver halide is preferably 1×10⁻⁶ mol to 5×10⁻³ mol, more preferably 1×10⁻⁵ mol to 2.5×10⁻³ mol, and even more preferably 4×10⁻⁵ mol to 1×10⁻³ mol.

<<Development Accelerator>>

It is preferable that the image forming layer contains a development accelerator.

As the development accelerator in the image forming layer, the sulfonamidophenol-based compound represented by General Formula (A) described in JP2000-267222A, JP2000-330234A, or the like, the hindered phenol-based compound represented by General Formula (II) described in JP2001-092075A, the hydrazine-based compound represented by General Formula (I) described in JP1998-062895A (JP-H10-062895A) or JP1999-015116A (JP-H11-015116A), General Formula (D) described in JP2002-156727A, or General Formula (1) described in JP2002-278017A, and the phenol-based or naphthol-based compound represented by General Formula (2) described in JP2001-264929A are preferably used. Furthermore, the phenol-based compounds described in JP2002-311533A and JP2002-341484A are also preferable. Particularly, the naphthol-based compound described in JP2003-066558A is preferable. The content of these development accelerators with respect to the reducing agent is preferably within a range of 0.1 mol % to 20 mol %, more preferably within a range of 0.5 mol % to 10 mol %, and even more preferably within a range of 1 mol % to 5 mol %. The development accelerator can be introduced into the thermally-developable photosensitive material by the same method as that used for introducing the reducing agent. It is particularly preferable that the development accelerator is added as a solid dispersion or an emulsified dispersion. In a case where the development accelerator is added as an emulsified dispersion, it is preferable that the development accelerator is added as an emulsified dispersion dispersed using a high-boiling-point solvent which remains as a solid at room temperature and an auxiliary solvent having a low boiling point or added as a so-called oilless emulsified dispersion in which a high-boiling-point solvent is not used.

In the present disclosure, among the above development accelerators, the hydrazine-based compound described in JP2002-156727A and JP2002-278017A and the naphthol-based compound described in JP2003-066558A are more preferable.

As the development accelerator of the present disclosure, for example, the compounds represented by General Formula (A-1) and General Formula (A-2) described in paragraphs “0253” to “0265” in JP2008-058820A are particularly preferable.

<<Hydrogen Bonding Compound>>

It is preferable that the image forming layer contains a hydrogen bonding compound. In a case where the reducing agent of the present disclosure has an aromatic hydroxyl group (—OH) or amino group (—NHR, R represents a hydrogen atom or an alkyl group), particularly, in a case where the reducing agent is bisphenols described above, it is preferable to use a non-reducing compound, which has a group capable of forming a hydrogen bond with the above groups, in combination.

Examples of the group forming a hydrogen bond with a hydroxyl group or an amino group include a phosphoryl group, a sulfoxide group, a sulfonyl group, a carbonyl group, an amide group, an ester group, a urethane group, a ureide group, a tertiary amino group, a nitrogen-containing aromatic group, and the like. Among these, the compounds having a phosphoryl group, a sulfoxide group, an amide group (here, the compound does not have a >N—H group and is blocked like >N—Ra (Ra represents a substituent other than H)), a urethane group (here, the compound does not have a >N—H group and is blocked like >N—Ra (Ra represents a substituent other than H)), or a ureide group (here, the compound does not have a >N—H group and is blocked like >N—Ra (Ra represents a substituent other than H)) are preferable.

In the present disclosure, the hydrogen bonding compound is particularly preferably a compound represented by General Formula (D).

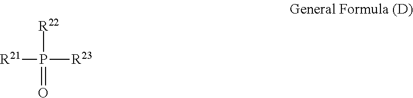

In General Formula (D), R²¹ to R²³ each independently represent an alkyl group, an aryl group, an alkoxy group, an aryloxy group, an amino group, or a heterocyclic group. These groups may be unsubstituted or have a substituent.

In a case where R²¹ to R²³ have a substituent, examples of the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, a phosphoryl group, and the like. As the substituent, an alkyl group or an aryl group is preferable, and examples thereof include a methyl group, an ethyl group, an isopropyl group, a t-butyl group, a t-octyl group, a phenyl group, a 4-alkoxyphenyl group, a 4-acyloxyphenyl group, and the like.

Specifically, examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, a 2-phenoxypropyl group, and the like.

Examples of the aryl group include a phenyl group, a cresyl group, a xylyl group, a naphthyl group, a 4-t-butylphenyl group, a 4-t-octylphenyl group, a 4-anicidyl group, a 3,5-dichlorophenyl group, and the like.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

Examples of the aryloxy group include a phenoxy group, a cresyloxy group, an isopropyl phenoxy group, a 4-t-butylphenoxy group, a naphthoxy group, a biphenyloxy group, and the like.

Examples of the amino group include a dimethylamino group, a diethylamino group, a dibutylamino group, a dioctylamino group, a N-methyl-N-hexylamino group, a dicyclohexylamino group, a diphenylamino group, a N-methyl-N-phenylamino group, and the like.

Examples of the heterocyclic group include a nitrogen-containing aliphatic heterocyclic group.

As R²¹ to R²³, an alkyl group, an aryl group, an alkoxy group, or an aryloxy group is preferable. In view of the effects of the present disclosure, it is preferable that at least one or more among R²¹ to R²³ are an alkyl group or an aryl group, and it is more preferable that two or more among R²¹ to R²³ are alkyl groups or aryl groups. Furthermore, R²¹ to R²³ are preferably the same groups because then R²¹ to R²³ become easily available at low costs.

Specific examples of the hydrogen bonding compound including the compound represented by General Formula (D) in the present disclosure will be shown below, but the present disclosure is not limited thereto.

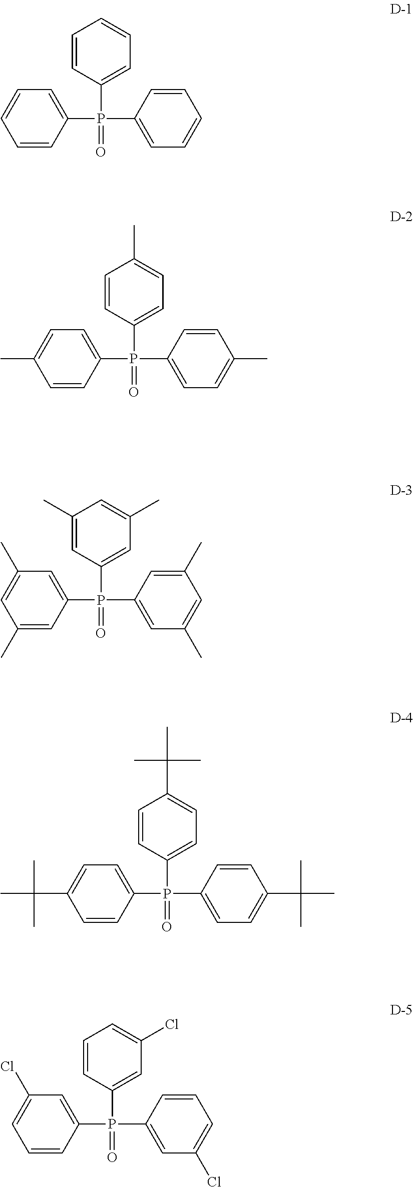

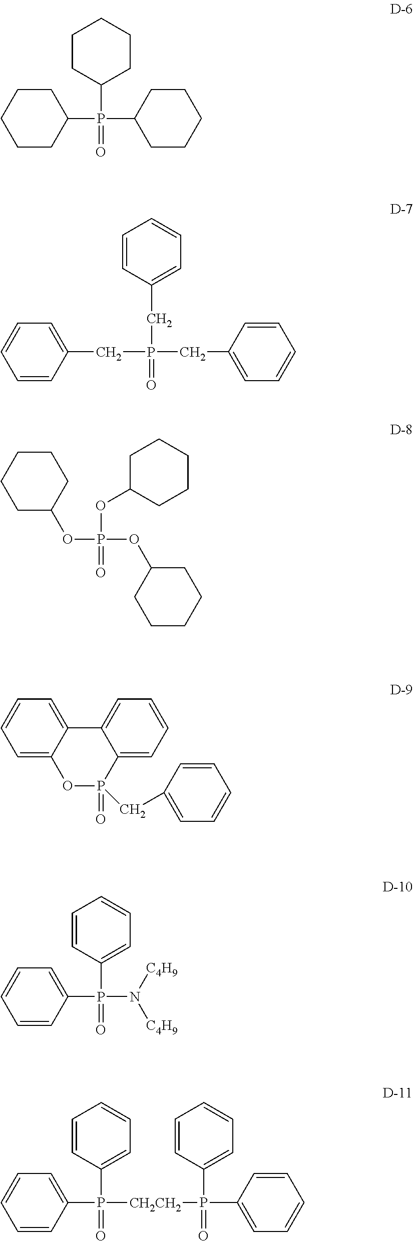

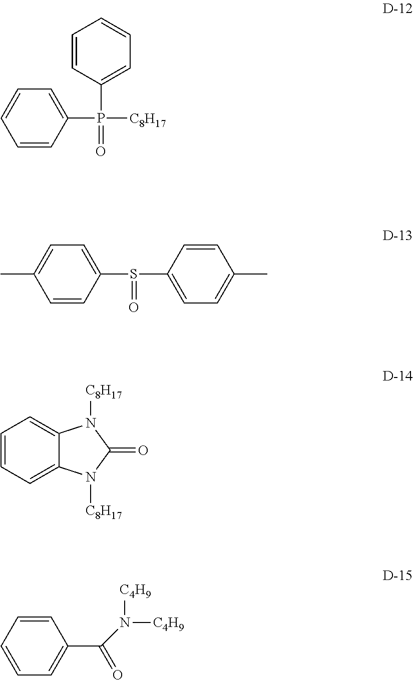

Specific examples of the hydrogen bonding compound include the above compounds and the compounds described in the specification of EP1096310B, JP2002-156727A, and JP2002-318431A.

The compound represented by General Formula (D) can be used in the thermally-developable photosensitive material by being incorporated into the coating solution in the form of a solution, an emulsified dispersion, or a dispersion of solid dispersed particles similarly to the reducing agent. It is preferable that the compound is used as a solid dispersion. The compound of the present disclosure forms a hydrogen bonding complex together with a compound having a phenolic hydroxyl group or an amino group in a solution state. Depending on the combination of the reducing agent and the compound represented by General Formula (D) of the present disclosure, the compound can be isolated as a complex in a crystal state.

In order to obtain stabilized performance, it is particularly preferable to use the crystal powder isolated in this way as a dispersion of solid dispersed particles. Furthermore, it is also possible to preferably use a method of mixing the reducing agent with the compound represented by General Formula (D) as powder and causing the powder to form a complex at the time of dispersion by using an appropriate dispersant and a sand grinding mill or the like.

The amount of the compound represented by General Formula (D) used with respect to the reducing agent is preferably within a range of 1 mol % to 200 mol %, more preferably within a range of 10 mol % to 150 mol %, and even more preferably within a range of 20 mol % to 100 mol %.

<<Compound which Generates One-Electron Oxidant Through One-Electron Oxidation that can Release One or More Electrons>>

It is preferable that the thermally-developable photosensitive material according to the present disclosure contains a compound which generates a one-electron oxidant through one-electron oxidation that can release one or more electrons. The compound may be used singly or used in combination with various chemical sensitizer compounds described above, and can increase the sensitivity of the silver halide.

The compound, which generates a one-electron oxidant through one-electron oxidation that can release one or more electrons, incorporated into the thermally-developable photosensitive material according to the present disclosure is a compound selected from the following types 1 and 2.

—Type 1—

A compound which generates a one-electron oxidant through one-electron oxidation, then undergoes a bond cleavage reaction, and thus can release one or more electrons.

—Type 2—

A compound which generates a one-electron oxidant through one-electron oxidation, then undergoes a bond forming reaction, and then can release one or more electrons.

First, the type 1 compound will be described.

Examples of the type 1 compound, which generates a one-electron oxidant through one-electron oxidation, then undergoes a bond cleavage reaction, and thus can release one electron, include the compounds referred to as “one-photon two-electron sensitizer” or “deprotonated electron-donating sensitizer” described in JP1997-211769A (JP-H09-211769A) (specific examples: compounds PMT-1 to S-37 described in Table E and Table F on pp. 28-32), JP1997-211774A (JP-H09-211774A), JP1999-095355A (JP-H11-095355A) (specific examples: compounds INV 1 to 36), and JP2001-500996A (specific examples: compounds 1 to 74, 80 to 87, and 92 to 122) and in patents in the specifications of U.S. Pat. Nos. 5,747,235A, 5,747,236A, EP786692A1 (specific examples: compounds INV 1 to 35), EP893732A1, U.S. Pat. Nos. 6,054,260A, and 5,994,051A. The preferable ranges of these compounds are the same as the preferable ranges described in the cited patent specifications.

Examples of the type 1 compound, which generates a one-electron oxidant through one-electron oxidation, then undergoes a bond cleavage reaction, and thus can release one or more electrons, also include the compound represented by General Formula (1) or General Formula (2) described in JP2003-114487A, the compound represented by General Formula (1), General Formula (2), or General Formula (3) described in JP2003-114488A, the compound represented by General Formula (1) or General Formula (2) described in JP2003-075950A, the compound represented by General Formula (1) described in JP2004-239943A, the compound represented by General Formula (3) described in JP2004-245929A, and the like. The preferable ranges of these compound are the same as the preferable ranges described in the cited patent specifications.

Next, the type 2 compound will be described.

Examples of the type 2 compound, which generates a one-electron oxidant through one-electron oxidation, then undergoes a bond forming reaction, and thus can release one or more electrons, include the compound represented by General Formula (1) described in JP2003-140287A, the compound represented by General Formula (2) described in JP2004-245929A, and the like. The preferable ranges of these compound are the same as the preferable ranges described in the cited patent specifications.

Among the type 1 and type 2 compounds, “compound having an adsorptive group to be adsorbed onto silver halide in a molecule” and “compound having a partial structure of a spectral sensitizing dye in a molecule” are preferable. As the adsorptive group to be adsorbed onto silver halide, the group described in line 1 on the right side on p. 16 to line 12 on the right side on p. 17 in JP2003-156823A are typical. The partial structure of the spectral sensitizing dye is the structure described in line 34 on the right side on p. 17 to line 6 on the left side on p. 18 in JP2003-156823A.

As the type 1 and type 2 compounds, “compound having at least one adsorptive group to be adsorbed onto silver halide, in a molecule” is more preferable, and “compound having two or more adsorptive groups to be adsorbed onto silver halide in the same molecule” is even more preferable. In a case where there are two or more adsorptive groups in a single molecule, these adsorptive groups may be the same as or different from each other.

As the adsorptive group, a mercapto-substituted nitrogen-containing heterocyclic group (for example, a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group, or the like) or a nitrogen-containing heterocyclic group having a —NH— group capable of forming imino silver (>NAg) as a partial structure of a heterocyclic ring (for example, a benzotriazole group, a benzimidazole group, an indazole group, or the like) is preferable. Among these, a 5-mercaptotetrazole group, a 3-mercapto-1,2,4-triazole group, and a benzotriazole group are particularly preferable, and a 3-mercapto-1,2,4-triazole group or a 5-mercaptotetrazole group is most preferable.

As the adsorptive group, a group having two or more mercapto groups as partial structures in a molecule is particularly preferable as well. In a case where the mercapto group (—SH) can be tautomerized, the mercapto group may become a thione group. As the adsorptive group having two or more mercapto groups as partial structures (a dimercapto-substituted nitrogen-containing heterocyclic group or the like), for example, a 2,4-dimercaptopyrimidine group, a 2,4-dimercaptotriazine group, and a 3,5-dimercapto-1,2,4-triazole group are preferable.

Furthermore, a quaternary salt structure of nitrogen or phosphorus is also preferably used as the adsorptive group. Specifically, the quaternary salt structure of nitrogen is a group including an ammonio group (a trialkyl ammonio group, a dialkyl aryl (or heteroaryl) ammonio group, an alkyl diaryl (or heteroaryl) ammonio group, or the like) or a nitrogen-containing heterocyclic group containing a quatemized nitrogen atom. Examples of the quaternary salt structure of phosphorus include a phosphonio group (a trialkyl phosphonio group, a dialkyl aryl (or heteroaryl) phosphonio group, an alkyl diaryl (or heteroaryl) phosphonio group, and a triaryl (or heteroaryl) phosphonio group, or the like). Among these, a quaternary salt structure of nitrogen is more preferably used, and a 5-membered or 6-membered nitrogen-containing aromatic heterocyclic group containing a quaternized nitrogen atom is even more preferably used. Particularly, a pyridinio group, a quinolinio group, and an isoquinolinio group are preferably used. These nitrogen-containing heterocyclic groups containing a quaternized nitrogen atom may have any substituent.

Examples of counter anions of the quaternary salt include a halide ion, a carboxylate ion, a sulfonate ion, a sulfate ion, a perchlorate ion, a carbonate ion, a nitrate ion, BF₄⁻, PF₆⁻, Ph₄B⁻, and the like. Ph represents a phenyl group. In a case where there is a group carrying a negative charge such as a carboxylate group or the like in a molecule, the compound may form an intramolecular salt together with such a group. As a counter anion that is not in the molecule, a chloride ion, a bromide ion, or a methanesulfonate ion is particularly preferable.

The type 1 and type 2 compounds are preferably added after being dissolved in water, a water-soluble solvent such as methanol or ethanol, or a mixed solvent of these. In a case where the compounds are dissolved in water, for the compound whose solubility is increased by increasing or reducing pH, the compound may be dissolved by increasing or reducing the pH and then added.

It is preferable that the type 1 and type 2 compounds are used in the image forming layer containing the photosensitive silver halide and the non-photosensitive organic silver salt. Furthermore, the compounds may be added in advance to the image forming layer containing the photosensitive silver halide and the non-photosensitive organic silver salt as well as a protective layer or an interlayer, and diffused at the time of coating.

The timing of adding the compounds of the present disclosure is not limited, and the compounds may be added before or after the sensitizing dye. The proportion of each of the compounds contained in the silver halide emulsion layer (image forming layer) per 1 mol of the silver halide is preferably 1×10⁻⁹ mol to 5×10⁻¹ mol, and more preferably 1×10⁻⁸ mol to 5×10⁻² mol.

<<Compound Having Adsorption Group and Reducing Group (Adsorptive Redox Compound)>>

In the present disclosure, it is preferable to incorporate an adsorptive redox compound, which has an adsorption group adsorbed onto silver halide and a reducing group in a molecule, into the image forming layer. As the adsorptive redox compound, a compound represented by Formula (Rd) is preferable.

A-(W)-n-B Formula (Rd)

In Formula (Rd), A represents a group which can be adsorbed onto silver halide (hereinafter, referred to as adsorption group), W represents a divalent linking group, n represents 0 or 1, and B represents a reducing group.

In Formula (Rd), the adsorption group represented by A is a group directly adsorbed onto silver halide or a group accelerating the adsorption onto silver halide. Specific examples thereof include a mercapto group (or a salt thereof), a thione group (—C(═S)—), a heterocyclic group having at least one atom selected from a nitrogen atom, a sulfur atom, a selenium atom, or a tellurium atom, a sulfide group, a disulfide group, a cationic group, an ethynyl group, and the like.

The mercapto group (or a salt thereof) as an adsorption group means a mercapto group (or a salt thereof) itself, and more preferably represents a heterocyclic group, an aryl group, or an alkyl group substituted with at least one mercapto group (or a salt thereof). Examples of the heterocyclic group include a monocyclic or fused aromatic or non-aromatic heterocyclic group with at least 5 to 7 members, such as an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. The heterocyclic group may also be a heterocyclic group containing a quaternized nitrogen atom, and in this case, the mercapto group substituting the heterocyclic group may be dissociated and become a meso ion. In a case where the mercapto group forms a salt, examples of counterions thereof include cations of an alkali metal, an alkali earth metal, and a heavy metal (Li⁺, Na⁺, K⁺, Mg²⁺, Ag⁺, Zn²⁺, and the like), an ammonium ion, a heterocyclic group containing a quaternized nitrogen atom, a phosphonium ion, and the like.

Furthermore, the mercapto group as an adsorption group may become a thione group by undergoing tautomerization.

The thione group as an adsorption group also includes a chain-like or cyclic thioamide group, a thioureide group, a thiourethane group, and a dithiocarbamic acid ester group.

The heterocyclic group as an adsorption group containing at least one atom selected from a nitrogen atom, a sulfur atom, a selenium atom, or a tellurium atom is a nitrogen-containing heterocyclic group which has a —NH— group capable of forming imino silver (>NAg) as a partial structure of a heterocyclic ring or a heterocyclic group which has a —S— group, a —Se— group, a —Te— group, or a ═N— group capable of being coordinated with silver ions through a coordinate bond as a partial structure of the heterocyclic ring. Examples of the former include a benzotriazole group, a triazole group, an indazole group, a pyrazole group, a tetrazole group, a benzimidazole group, an imidazole group, a purine group, and the like. Examples of the latter include a thiophene group, a thiazole group, an oxazole group, a benzothiophene group, a benzothiazole group, a benzoxazole group, a thiadiazole group, an oxadiazole group, a triazine group, a selenazole group, a benzoselenazole group, a tellurazole group, a benzotellurazole group, and the like.

Examples of the sulfide group or the disulfide group as an adsorption group include all the groups having the chemical structure of —S— or —S—S—.

The cationic group as an adsorption group means a group containing a quaternized nitrogen atom, and specifically is a group containing an ammonio group or a nitrogen-containing heterocyclic group containing a quaternized nitrogen atom. Examples of the nitrogen-containing heterocyclic group containing a quaternized nitrogen atom include a pyridinio group, an oxolinio group, an isoquinolinio group, an imidazolio group, and the like. The ethynyl group as an adsorption group means a —C≡CH group, and a hydrogen atom thereof may be substituted. The aforementioned adsorption group may have any substituent.

Specific examples of the adsorption group also include the groups described on p. 4 to p. 7 in the specification of JP1999-095355A (JP-H11-095355A).

In Formula (Rd), as the adsorption group represented by A, a mercapto-substituted heterocyclic group (for example, a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group, or the like) or a nitrogen-containing heterocyclic group having a —NH— group capable of forming imino silver (>NAg) as a partial structure of a heterocyclic ring (for example, a benzotriazole group, a benzimidazole group, an indazole group, or the like) is preferable, and a 2-mercaptobenzimidazole group and a 3,5-dimercapto-1,2,4-triazole group are more preferable.

In Formula (Rd), W represents a divalent linking group. The linking group is not particularly limited as long as the photographic performance are not negatively affected. For example, a divalent linking group constituted with a carbon atom, a hydrogen atom, an oxygen atom, a nitrogen atom, and a sulfur atom can be used. Specifically, examples thereof include an alkylene group having 1 to 20 carbon atoms (for example, a methylene group, an ethylene group, a trimethylene group, a tetramethylene group, a hexamethylene group, or the like), an alkenylene group having 2 to 20 carbon atoms, an alkynylene group having 2 to 20 carbon atoms, an arylene group having 6 to 20 carbon atoms (for example, a phenylene group, a naphthylene group, or the like), —CO—, —SO₂—, —O—, —S—, —NR₁—, a combination of these linking groups, and the like. R₁ represents a hydrogen atom, an alkyl group, a heterocyclic group, or an aryl group. The linking group represented by W may have any substituent.

In Formula (Rd), the reducing group represented by B represents a group which can reduce silver ions, and examples thereof include residues obtained by removing one hydrogen atom from a formyl group, an amino group, a functional group having a triple bond such as an acetylene group or a propargyl group, a mercapto group, hydroxyl amines, hydroxamic acids, hydroxyureas, hydroxyurethanes, hydroxysemicarbazides, reductones (including reductone derivatives), anilines, phenols (including polyphenols such as chroman-6-ols, 2,3-dihydrobenzofuran-5-ols, aminophenols, sulfonamidophenols, hydroquinones, catechols, resorcinols, benzenetriols, and bisphenols), acyl hydrazines, carbamoyl hydrazines, 3-pyrazolidones, and the like. It goes without saying that these may have any substituent.

In Formula (Rd), the oxidation potential of the reducing group represented by B can be measured using the measurement method described in “Electrochemical Measurement Method” (Akira Fujishima, pp, 150-208, GIHODO SHUPPAN Co., Ltd.) or “Experimental Chemistry Course” (The Chemical Society of Japan, 4^{th} edition, Vol. 9, pp. 282-344, Maruzen). For example, the technique of rotating disk voltammetry can be used. Specifically, a sample is dissolved in a solution of methanol:Britton-Robinson buffer (pH 6.5)=10%:90% (% by volume), and a nitrogen gas is allowed to flow in the solution for 10 minutes. Then, by using a rotating disk electrode (RDE) made of glassy carbon as a working electrode, a platinum wire as a counter electrode, and a saturated calomel electrode as a reference electrode, the oxidation potential can be measured at a sweep rate of 20 mV/sec at 25° C. and 1,000 rpm. From the obtained voltammogram, a half-wave potential (E1/2) can be determined.

In a case where the reducing group represented by B is measured by the measurement method described above, the oxidation potential thereof is preferably within a range of −0.3 V to 1.0 V, more preferably within a range of −0.1 V to 0.8 V, and particularly preferably within a range of 0 V to 0.7 V

In Formula (Rd), the reducing group represented by B is preferably a residue obtained by removing one hydrogen atom from hydroxylamines, hydroxamic acids, hydroxyureas, hydroxysemicarbazides, reductones, phenols, acyl hydrazines, carbamoyl hydrazines, or 3-pyrazolidones.

A ballast group or a polymer chain, which is generally used in additives for motionless photographs such as a coupler, may be incorporated into the compound represented by Formula (Rd). Examples of the polymer include those described in JP1989-100530A (JP-HO1-100530A).

The compound represented by Formula (Rd) may be a bis-compound or a tris-compound. The molecular weight of the compound represented by Formula (Rd) is preferably 100 to 10,000, more preferably 120 to 1,000, and particularly preferably 150 to 500.

Examples of the compound represented by Formula (Rd) will be shown below, but the present disclosure is not limited thereto.

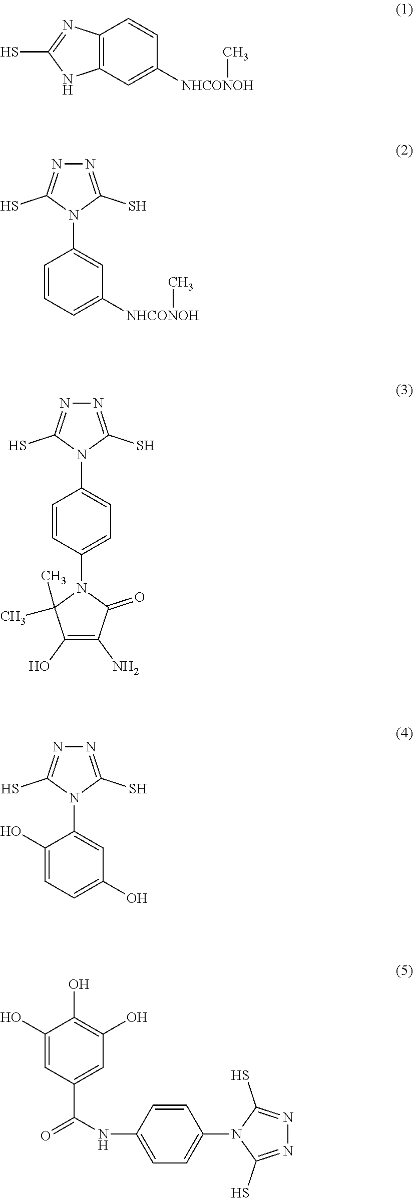

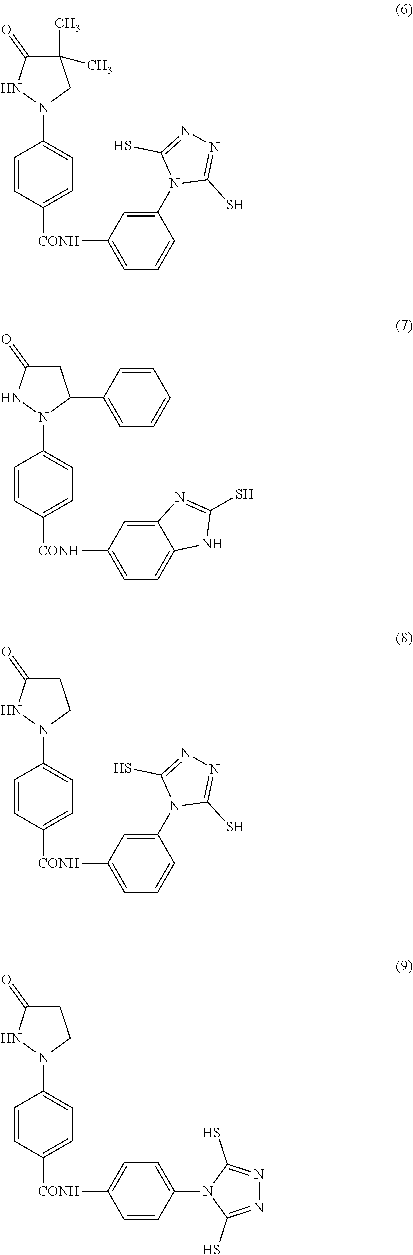

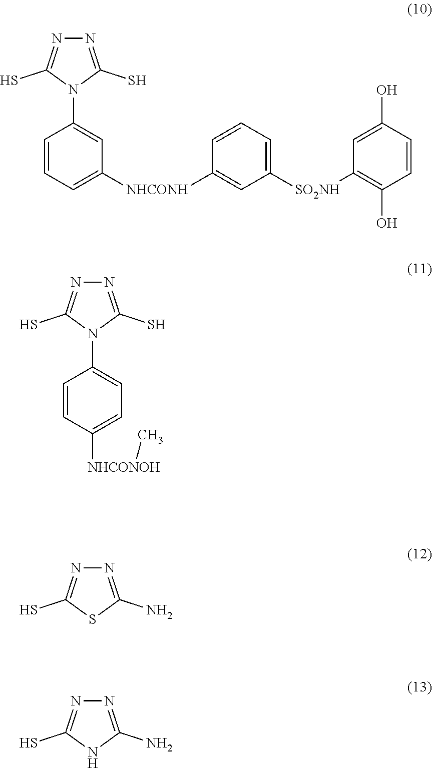

Furthermore, for example, the specific compounds 1 to 30 and 1″-1 to 1″-77 described on pp. 73-87 in the specification of EP1308776A2 are also preferable as the compound having an adsorption group and a reducing group.

The preferable amount of the compound having an adsorption group and a reducing group added heavily depends on the aforementioned addition method or the type of compound to be added. The amount of the compound added per 1 mol of the photosensitive silver halide is preferably 1×10⁻⁶ mol to 1 mol, more preferably 1×10⁻⁵ mol to 5×10⁻¹ mol, and even more preferably 1×10⁻⁴ mol to 1×10⁻¹ mol.

<<Antifoggant>>

It is preferable that the image forming layer contains an antifoggant.

Examples of the antifoggant, a stabilizer, and a stabilizer precursor which can be used in the present disclosure include the patented compounds described in paragraph “0070” in JP1998-062899A (JP-H10-062899A) and line 57 on p. 20 to line 7 on p. 21 in the specification of EP0803764A1, the compounds described in JP1997-281637A (JP-H09-281637A) and JP1997-329864A (JP-H09-329864A), and the compounds described in the specification of U.S. Pat. No. 6,083,681A and the specification of EP1048975B.

1) Description of Organic Polyhalogen Compound

The polyhalogen compound in the present disclosure is preferably a compound represented by General Formula (H).

Q-(Y)ₙ—C(Z₁)(Z₂)X General Formula (H)

In General Formula (H), Q represents an alkyl group, an aryl group, or a heterocyclic group, Y represents a divalent linking group, n represents 0 or 1, and Z₁ and Z₂ each represent a halogen atom, and X represents a hydrogen atom or an electron-withdrawing group.

In General Formula (H), Q is preferably an alkyl group having 1 to 6 carbon atoms, an aryl group having 6 to 12 carbon atoms, or a heterocyclic group having at least one nitrogen atom (pyridine, a quinoline group, or the like).

In a case where Q in General Formula (H) is an aryl group, Q preferably represents a phenyl group substituted with an electron-withdrawing group having a positive Hammett substituent constant op. Regarding the Hammett substituent constant 6, Journal of Medicinal Chemistry, 1973, Vol. 16, No. 11, 1207-1216 and the like can be referred to.

Examples of such an electron-withdrawing group include a halogen atom, an alkyl group substituted with an electron-withdrawing group, an aryl group substituted with an electron-withdrawing group, a heterocyclic group, an alkyl- or arylsulfonyl group, an acyl group, an alkoxycarbonyl group, a carbamoyl group, a sulfamoyl group, and the like. As the electron-withdrawing group, a halogen atom, a carbamoyl group, an arylsulfonyl group are preferable, and a carbamoyl group is particularly preferable.

X is preferably an electron-withdrawing group. As the electron-withdrawing group, a halogen atom, a sulfonyl group having an aliphatic group, aryl, or a heterocyclic ring, an acyl group having an aliphatic group, aryl, or a heterocyclic ring, an oxycarbonyl group having an aliphatic group, aryl, or a heterocyclic ring, a carbamoyl group, and a sulfamoyl group are preferable. Among these, a halogen atom and a carbamoyl group are preferable, and a bromine atom is particularly preferable.

Z₁ and Z₂ preferably each represent a bromine atom or an iodine atom, and more preferably each represent a bromine atom.

Y preferably represents —C(═O)—, —SO—, —SO₂—, —C(═O)N(R)—, or —SO₂N(R)—. R is more preferably —C(═O)—, —SO₂—, or —C(═O)N(R)—, and particularly preferably —SO₂— or —C(═O)N(R)—. R represents a hydrogen atom, an aryl group, or an alkyl group. R is more preferably a hydrogen atom or an alkyl group, and particularly preferably a hydrogen atom.

n represents 0 or 1, and preferably represents 1.

In a case where Q in General Formula (H) is an alkyl group, Y is preferably —C(═O)N(R)—. In a case where Q is an aryl group or a heterocyclic group, Y is preferably —SO₂—.

The type of compound (referred to as bis-type, tris-type, or tetrakis-type in general) obtained in a case where residues, which are formed by removing hydrogen atoms from the compound represented by General Formula (H), are bonded to each other can also be preferably used.

The compound represented by General Formula (H) having a dissociable group (for example, a COOH group or a salt thereof, a SO₃H group or a salt thereof, a PO₃H group or a salt thereof, or the like), a group containing a quaternary nitrogen cation (for example, an ammonium group or a pyridinium group), a polyethyleneoxy group, a hydroxyl group, or the like on a substituent is also a preferable type of compound.

Specific examples of the compound represented by General Formula (H) in the present disclosure will be shown below.

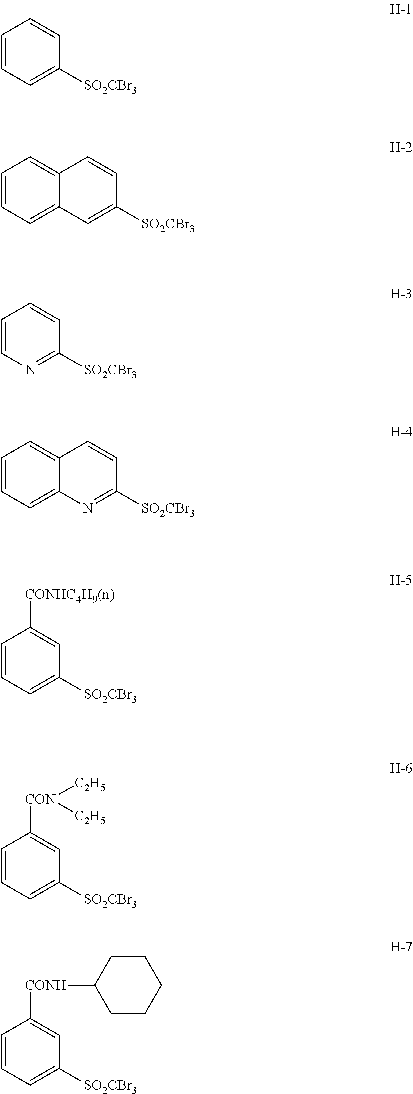

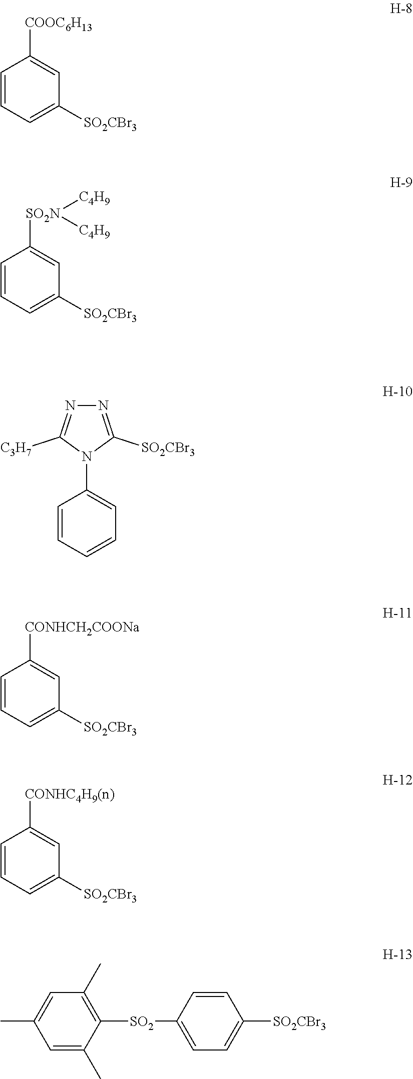

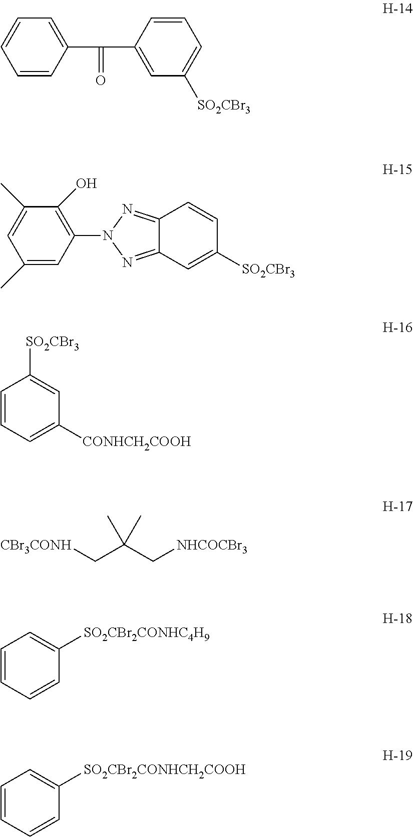

As polyhalogen compounds other than the above that can be used in the present disclosure, the compounds listed as example compounds in the specifications of U.S. Pat. No. 3,874,946A, U.S. Pat. Nos. 4,756,999A, 5,340,712A, 5,369,000A, 5,464,737A, and 6,506,548B and JP1975-137126A (JP-S50-137126A), JP1975-089020A (JP-S50-089020A), JP1975-119624A (JP-S50-119624A), JP1984-057234A (JP-S59-057234A), JP1995-002781A (JP-H07-002781A), JP1995-005621A (JP-H07-005621A), JP1997-160164A (JP-H09-160164A), JP1997-244177A (JP-H09-244177A), JP1997-244178A (JP-H09-244178A), JP1997-160167A (JP-H09-160167A), JP1997-319022A (JP-H09-319022A), JP1997-258367A (JP-H09-258367A), JP1997-265150A (JP-H09-265150A), JP1997-319022A (JP-H09-319022A), JP1998-197988A (JP-H10-197988A), JP1998-197989A (JP-H10-197989A), JP1999-242304A (JP-H11-242304A), JP2000-002963A, JP2000-112070A, JP2000-284410A, JP2000-284412A, JP2001-033911A, JP2001-031644A, JP2001-312027A, and JP2003-050441A are preferably used. Particularly, the compounds specifically exemplified in JP1995-002781A (JP-H07-002781A), JP2001-033911A, and JP2001-312027A are preferable.

In the present disclosure, the amount of the compound represented by General Formula (H) used per 1 mol of the non-photosensitive organic silver salt in the image forming layer is preferably within a range equal to or greater than 10⁻⁴ mol and equal to or smaller than 1 mol, more preferably within a range equal to or greater than 10⁻³ mol and equal to or smaller than 0.5 mol, and even more preferably within a range equal to or greater than 1×10⁻² mol and equal to or smaller than 0.2 mol.

In the present disclosure, the antifoggant is incorporated into the thermally-developable photosensitive material, for example, by the method described above regarding the method for incorporating the reducing agent. The organic polyhalogen compound is preferably added in the form of a solid fine particle dispersion as well.

Examples of other antifoggants include the mercury (II) salt in paragraph “0113” in JP1999-065021A (JP-H11-065021A), the benzoic acids in paragraph “0114” in JP1999-065021A (JP-H11-065021A), the salicylic acid derivative in JP2000-206642A, the formalin scavenger compound represented by Formula (S) in JP2000-221634A, the triazine compound according to claim 9 in JP1999-352624A (JP-H11-352624A), the compound represented by General Formula (III) in JP1994-011791A (JP-H06-011791A), 4-hydroxy-6-methyl-1,3,3a,7-tetrazaindene, and the like.

The thermally-developable photosensitive material according to the present disclosure may contain an azolium salt for the purpose of preventing fogging. Examples of the azolium salt include the compound represented by General Formula (XI) described in JP1984-193447A (JP-S59-193447A), the compounds described in JP1980-012581B (JP-S55-012581B), and the compound represented by General Formula (II) described in JP1985-153039A (JP-S60-153039A). The azolium salt may be added to any moiety of the thermally-developable photosensitive material. In a case where the azolium salt is added to a layer, the azolium salt is preferably added to a layer of a surface having the image forming layer, and more preferably added to the image forming layer. Regarding the timing of adding the azolium salt, the azolium salt may be added at any step during the preparation of the coating solution. In a case where the azolium salt is added to the image forming layer, the azolium salt may be added at any step during the period of time from the preparation of the organic silver salt to the preparation of the coating solution. It is preferable that the azolium salt is added during a period of time from when the preparation of the organic silver salt has been finished to when coating is about to start. Regarding the method for adding the azolium salt, the azolium salt may be added in the form of powder, a solution, or a fine particle dispersion. Furthermore, the azolium salt may be added as a solution mixed with other additives such as a sensitizing dye, a reducing agent, and a toning agent. In the present disclosure, the amount of the azolium salt added is not limited. However, the amount of the azolium salt added per 1 mol of silver is preferably equal to or greater than 1×10⁻⁶ mol and equal to or smaller than 2 mol, and more preferably equal to or greater than 1×10⁻³ mol and equal to or smaller than 0.5 mol.

<<Other Additives>>

In the image forming layer, additives other than the aforementioned additives can be used.

As those other additives, known additives can be used. For example, mercaptos, disulfides, thiones, a toning agent, a plasticizer, a lubricant, dyes different from the aforementioned infrared absorbing dye, a pigment, a nucleating agent, and a thickener are preferable.

Examples of those other additives also include the additives described in JP2009-086045A or JP2009-086588A.

In addition, an antioxidant, a stabilizer, a plasticizer, an ultraviolet absorber, a coating aid, and the like may be added to the thermally-developable photosensitive material according to the present disclosure. It is preferable that various additives are added to any of the image forming layer or the non-photosensitive layer. Regarding the additives, WO98/036322A, the specification of EP803764A1, JP1998-186567A (JP-H10-186567A), JP1998-018568A (JP-H10-018568A), and the like can be referred to.

<Non-Photosensitive Back Layer>

The thermally-developable photosensitive material according to the present disclosure has a non-photosensitive back layer on the other surface (surface opposite to the surface on which the image forming layer is formed) of the support.

The non-photosensitive back layer is described in paragraphs “0128” to “0130” in JP1999-065021A (JP-H11-065021A). The non-photosensitive back layer may contain an infrared absorbing dye which absorbs at least infrared having a wavelength equal to or longer than 700 nm. From the viewpoint of the sharpness as image quality of the image to be obtained, it is preferable that the non-photosensitive back layer contains an infrared absorbing dye which absorbs at least infrared having a wavelength equal to or longer than 700 nm.

From the viewpoint of the sharpness as image quality of the image to be obtained, it is preferable that the infrared absorbing dye, which is contained in the non-photosensitive back layer and absorbs at least infrared having a wavelength equal to or longer than 700 nm, contains an oxonol dye represented by Formula (II).

The content of the infrared absorbing dye in the non-photosensitive back layer is preferably 1×10⁻⁶ mol/m² to 5×10⁻⁴ mol/m², more preferably 2×10⁻⁶ mol/m² to 2.5×10⁻⁴ mol/m², and even more preferably 5×10⁻⁶ mol/m² to 1×10⁻⁴ mol/m².

It is preferable that the non-photosensitive back layer contains a matting agent. As the matting agent, polymethyl methacrylate (PMMA) is preferable. Regarding the average particle size of the matting agent, it is preferable to add at least one kind of matting agent having an average particle size equal to or greater than 3 μm, and it is more preferable to add at least one kind of matting agent having an average particle size equal to or greater than 5 μm.

As a binder, for example, the binders described above regarding the image forming layer are preferable.

It is preferable that the non-photosensitive back layer contains the binder. As the binder, for example, the binders described above regarding the image forming layer are preferable.

Furthermore, it is preferable that the non-photosensitive back layer contains at least gelatin as the binder. As the gelatin, gelatin in an outermost layer which will be described later is suitably used.

In addition, the non-photosensitive back layer may contain various components other than the photosensitive silver halide, the non-photosensitive organic silver salt, and the reducing agent described above regarding the image forming layer.

In the present disclosure, for the purpose of improving the tone of silver and the temporal change of an image, a coloring agent having maximum absorption at 300 to 450 nm can be added to the non-photosensitive back layer. Such a coloring agent is described in JP1987-210458A (JP-S62-210458A), JP1988-104046A (JP-S63-104046A), JP1988-103235A (JP-S63-103235A), JP1988-208846A (JP-S63-208846A), JP1988-306436A (JP-S63-306436A), JP1988-314535A (JP-S63-314535A), JP1989-061745A (JP-H01-061745A), JP2001-100363A, and the like.

The content of the coloring agent is preferably within a range of 0.1 mg/m² to 1 g/m². As the layer to which the coloring agent is to be added, the non-photosensitive back layer disposed on a side opposite to the image forming layer is preferable.

Furthermore, for the purpose of adjusting base tone, it is preferable to use a dye having an absorption peak at 580 to 680 nm. As the dye used for such a purpose, the azomethine-based oil-soluble dye described in JP1992-359967A (JP-H04-359967A) and JP1992-359968A (JP-H04-359968A) exhibiting low absorption intensity with respect to a short wavelength side and the phthalocyanine-based water-soluble dye described in JP2003-295388A are preferable. The dye used for the aforementioned purpose may be added to any layer. However, it is more preferable that the dye is added to the non-photosensitive layer of the image forming layer side or to the back surface side.

The thickness of the non-photosensitive back layer is not particularly limited, but is preferably set such that the amount of the binder in the non-photosensitive back layer preferably becomes equal to or greater than 0.1 g/m² and equal to or smaller than 5 g/m², and more preferably becomes equal to or greater than 0.5 g/m² and equal to or smaller than 3 g/m². Furthermore, it is preferable that the non-photosensitive back layer is constituted with at least two layers including a protective layer and a layer containing an infrared absorbing dye.

The amount of gelatin in the protective layer is preferably equal to or greater than 0.3 g/m² and equal to or smaller than 3 g/m², and more preferably equal to or greater than 0.5 g/m² and equal to or smaller than 2 g/m².

The amount of gelatin in the layer containing an infrared absorbing dye is preferably equal to or greater than 0.5 g/m² and equal to or smaller than 5 g/m², and more preferably equal to or greater than 1 g/m² and equal to or smaller than 4 g/m².

The amount of solid contents of emulsified latex in the protective layer is preferably equal to or greater than 0.02 g/m² and equal to or smaller than 2 g/m², and more preferably equal to or greater than 0.05 g/m² and equal to or smaller than 1 g/m².

The amount of solid contents of emulsified latex in the layer containing an infrared absorbing dye is preferably equal to or greater than 0.1 g/m² and equal to or smaller than 5 g/m², and more preferably equal to or greater than 0.2 g/m² and equal to or smaller than 2 g/m².

<Support>

The thermally-developable photosensitive material according to the present disclosure has a support.

As the support, a transparent support is preferable. As the material of the support, a resin is preferable. In the present disclosure, “transparent” means that the visible light (400 nm to 700 nm) transmittance is equal to or higher than 80%.

As the support, in order to relieve the internal strain remaining in the film at the time of biaxial stretching and to remove the thermal contraction strain occurring during a thermal development treatment, polyester having undergone a thermal treatment in a temperature range of 130° C. to 185° C., particularly, polyethylene terephthalate is preferably used. For the thermally-developable photosensitive material for medical uses, the transparent support may be colored by a blue dye (for example, the dye 1 described in Examples in JP1996-240877A (JP-H08-240877A) or may not be colored. As the support, it is preferable to use the water-soluble polyester described in JP1999-084574A (JP-H11-084574A), the styrene-butadiene copolymer described in JP1998-186565A (JP-H10-186565A), the vinylidene chloride copolymer described in JP2000-039684A, and the like. The moisture content of the support is preferably equal to or smaller than 0.5% by mass.

The thickness of the support is not particularly limited, but is preferably equal to or greater than 10 μm and equal to or smaller than 500 μm, more preferably equal to or greater than 100 μm and equal to or smaller than 300 μm, and even more preferably equal to or greater than 150 μm and equal to or smaller than 190 μm.

<Other Layer Constitutions>

The thermally-developable photosensitive material according to the present disclosure may have the image forming layer and a non-photosensitive layer in this order on at least one surface of the support. It is preferable that the non-photosensitive layer is the outermost layer, and a non-photosensitive interlayer is between the image forming layer and the non-photosensitive layer. It is preferable that the image forming layer contains a first non-photosensitive organic silver salt, and the interlayer contains a second non-photosensitive organic silver salt.

In the thermally-developable photosensitive material according to the present disclosure, another non-photosensitive interlayer may be positioned between the image forming layer and the interlayer containing the second non-photosensitive organic silver salt. In the following description of the present disclosure, for better understanding, sometimes the non-photosensitive interlayer is described as an interlayer B, and the non-photosensitive layer containing the second non-photosensitive organic silver salt will be described as an interlayer A.

From the viewpoint of improving the adhesiveness of the support and the layer adjacent thereto, the thermally-developable photosensitive material according to the present disclosure may have an undercoat layer. The undercoat layer may be on both surfaces of the support.

In a case where a layer acting as an optical filter is provided, a light absorber (a dye, a pigment, or the like different from the aforementioned infrared absorbing dye) may be incorporated into any of the non-photosensitive layers on the exposure surface side of the image forming layer. In a case where an antihalation layer is provided, a light absorber (a dye, a pigment, or the like different from the aforementioned infrared absorbing dye) may be incorporated into any of the non-photosensitive layers on the side opposite to the exposure surface of the image forming layer.

—Second Non-Photosensitive Organic Silver Salt Incorporated into Non-Photosensitive Layer—

As the second non-photosensitive organic silver salt incorporated into the non-photosensitive layer in the present disclosure, for example, a nitrogen-containing heterocyclic silver salt is preferable.

These non-photosensitive layers containing the organic silver salt have at least one non-photosensitive layer on a side opposite to the support relative to the image forming layer, and correspond to a surface protective layer, which will be described later, an interlayer between the surface protective layer and the image forming layer, and the like. It is preferable that any one of the non-photosensitive layers contains the second non-photosensitive organic silver salt.

The nitrogen-containing heterocyclic silver salt is a silver salt of a nitrogen-containing heterocyclic compound. Examples of the nitrogen-containing heterocyclic compound include azoles, oxazoles, thiazoles, thiazolines, imidazoles, diazoles, pyridines, indolizines, and triazines, but the compound is not limited to these. Among these, indolizines, imidazoles, and azoles are more preferable. As azoles, triazole, tetrazole, and derivatives of these are preferable, and benzimidazoles and derivatives thereof and benzotriazoles and derivatives thereof are even more preferable. As the indolizines, triazaindolizine derivatives are preferable.

Typical examples of the nitrogen-containing heterocyclic compound will be shown below, but the compound is not limited thereto. Examples of the nitrogen-containing heterocyclic compound include 1,2,4-triazole and benzotriazole and derivatives thereof. Among these, benzotriazole, methyl benzotriazole, and 5-chlorobenzotriazole are preferable. The examples also include a 1H-tetrazole compound such as phenyl mercaptotetrazole described in the specification of U.S. Pat. No. 4,220,709A (de Mauriac), the imidazole and imidazole derivatives described in the specification of U.S. Pat. No. 4,260,677A (Winslow et al.), and the like, and among these, benzimidazole and nitrobenzimidazole are preferable. As the triazaindolizine derivative, 5-methyl-7-hydroxy-1,3,5-triazaindolizine is preferable, but the derivative is not limited to these.

In the present disclosure, the average equivalent circular diameter of the second non-photosensitive organic silver salt is preferably equal to or greater than 0.03 μm and equal to or smaller than 0.5 μm, more preferably equal to or greater than 0.05 μm and equal to or smaller than 0.4 μm, and even more preferably equal to or greater than 0.08 μm and equal to or smaller than 0.3 μm. In a case where the average equivalent circular diameter is within the above range, aggregation and the like are inhibited, and the generation of coarse particles is inhibited. Furthermore, the particle size is stabilized, and desired performances are easily obtained.

The particle size of the organic silver salt can be measured by a method of observing the organic silver salt particles with an electronic microscope and determining the equivalent circular diameter thereof by converting the projected area of the particles into an area equivalent to that of a circle.

In the present disclosure, in order to adjust the average equivalent circular diameter of the second non-photosensitive organic silver salt to be within the range of the present disclosure, it is possible to use the preparation conditions and the dispersion conditions of organic silver salt crystals.

<<Step of Preparing Crystals of Second Non-Photosensitive Organic Silver Salt>>

In the present disclosure, the crystals of the second non-photosensitive organic silver salt can be prepared by a general synthesis method. For example, an organic compound is dissolved by being heated in water at a temperature equal to or higher than the melting point thereof (preferably 10° C. to 90° C.), a sodium salt is prepared using sodium hydroxide, and an aqueous silver nitrate solution is added thereto such that silver salt crystals are precipitated. Alternatively, in a case where the alkali metal salt is highly soluble in water, an aqueous solution of a sodium salt, a potassium salt, or a lithium salt may be prepared using sodium hydroxide, potassium hydroxide, or lithium hydroxide, and the aqueous solution of the alkali metal salt may be mixed with an aqueous silver nitrate solution such that silver salt crystals are precipitated. If necessary, it is preferable to perform a step of desalting treatment. At the time of preparing the crystals, a hydrophilic colloid such as gelatin or modified polyvinyl alcohol may coexist. It is preferable to adjust the concentration, the mixing temperature, and the mixing rate of each of the chemical agents so as to prepare crystals having a soft structure that are finely dispersed by the following dispersion step.

It is preferable that the second non-photosensitive organic silver salt has a monodisperse particle size. In order to make the monodisperse particles, it is preferable to mix the aqueous solution of an alkali metal salt of an organic compound with the aqueous silver nitrate solution by a simultaneous addition method so as to prepare the non-photosensitive organic silver salt.

In a case where the second non-photosensitive organic silver salt is prepared by the simultaneous addition method, in order to obtain the particle size of the present disclosure, the reaction temperature at the time of addition is preferably equal to or higher than 30° C. and equal to or lower than 95° C., and more preferably equal to or higher than 50° C. and equal to or lower than 90° C. In a case where the reaction temperature is too low, an organic silver salt having a small particle size is generated, which is not preferable because the stability during storage deteriorates. Furthermore, in a case where the reaction temperature is too high, an organic silver salt having a large particle size is generated, which is not preferable because the effects expected to be demonstrated in the present disclosure are not obtained.

<<Dispersion Step>>

In order to obtain a fine dispersion, it is preferable to disperse the particles in the state of wet slurry obtained after the preparation of crystals. At the time of dispersion, it is preferable to use an appropriate dispersant. As dispersion means, various dispersion methods described above regarding the reducing agent of the present application can be used. Particularly, it is preferable to use a solid dispersion method. The synthesis method is specifically described in JP1989-100177A (JP-H01-100177A).

The amount of the second non-photosensitive organic silver salt added that is incorporated into the non-photosensitive layer is, in terms of a silver amount, preferably 0.001 g/m² to 3 g/m², more preferably 0.005 g/m² to 1 g/m², and even more preferably 0.01 g/m² to 0.5 g/m².

The ratio of the second non-photosensitive organic silver salt incorporated into the non-photosensitive layer to the first non-photosensitive organic silver salt added to the image forming layer is preferably equal to or higher than 0.5 mol % and equal to or lower than 50 mol %, and more preferably equal to or higher than 1 mol % and equal to or lower than 20 mol %.

<<Binder of Non-Photosensitive Layer (Interlayer A) Containing Second Non-Photosensitive Organic Silver Salt and Non-Photosensitive Interlayer (Interlayer B)>>

In the present disclosure, it is preferable that the proportion of polymer latex in the binder of the interlayer B is at least equal to or higher than 50% by mass. As the rest of the binder components, it is preferable to use a hydrophilic polymer which will be described later. The binder of the interlayer A is preferably a hydrophilic binder, and may contain additives such as a development accelerator, an antifoggant, a dye or a pigment different from the aforementioned infrared absorbing dye, a plasticizer or a lubricant, a crosslinking agent, and a surfactant.

As the polymer latex, polymer latex in which the content of a monomer component represented by General Formula (M) is equal to or greater than 10% by mass and equal to or smaller than 70% by mass is preferable.

CH₂═CR⁰¹—CR⁰²═CH₂ General Formula (M)

In the formula, R⁰¹ and R⁰² each represent a group selected from a hydrogen atom, an alkyl group having 1 to 6 carbon atoms, a halogen atom, and a cyano group.

As the alkyl group represented by R⁰¹ and R⁰², an alkyl group having 1 to 4 carbon atoms is preferable, and an alkyl group having 1 or 2 carbon atoms is more preferable. As the halogen atom represented by R⁰¹ and R⁰², a fluorine atom, a chlorine atom, or a bromine atom is preferable, and a chlorine atom is more preferable.

It is preferable that both of R⁰¹ and R⁰² represent a hydrogen atom. Alternatively, it is preferable that one of R⁰¹ and R⁰² is a hydrogen atom, and the other is a methyl group or a chlorine atom. It is more preferable that one of R⁰¹ and R⁰² is a hydrogen atom, and the other is a methyl group.

Specific examples of the monomer represented by General Formula (M) include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

The copolymerization ratio of the monomer represented by General Formula (M) in the polymer latex is preferably 10% by mass to 70% by mass, more preferably 15% by mass to 65% by mass, and even more preferably 20% by mass to 60% by mass. In a case where the copolymerization ratio is within the above range, the amount of fusion components in the binder becomes sufficient, processing brittleness becomes excellent, the binder has appropriate motility, and the image preservability becomes excellent.

The polymer latex may contain a monomer having an acid group. As the acid group, a carboxylic acid group (—COOH), a sulfonic acid group (—SO₃H—), or a phosphoric acid group (—OPO₃H) is preferable, and a carboxylic acid group is particularly preferable. The copolymerization ratio of the monomer having an acid group is preferably 1% by mass to 20% by mass, and more preferably 1% by mass to 10% by mass. Specific examples of the monomer having an acid group include an acrylic acid, a methacrylic acid, an itaconic acid, sodium p-toluenesulfonate, isoprene sulfonate, phosphoryl ethyl methacrylate, and the like. Among these, an acrylic acid and a methacrylic acid are preferable, and an acrylic acid is particularly preferable.

In view of film forming properties and image preservability, the glass transition temperature (Tg) of the binder is preferably within a range of −30° C. to 70° C., more preferably within a range of −10° C. to 50° C., and even more preferably within a range of 0° C. to 40° C. As the binder, two or more kinds of polymers may be used in combination. In this case, Tg obtained by calculating a weighted average in consideration of the compositional fraction is preferably within the above range. Furthermore, in a case where phase separation occurs in the binder, or the binder has a core-shell structure, Tg obtained by calculating a weighted average is preferably within the above range.

One kind of polymer latex described above may be used singly. Alternatively, if necessary, two or more kinds of polymer latex described above may be used in combination.

The equilibrium moisture content of the polymer latex at 25° C. and 60% RH is preferably equal to or smaller than 2% by mass, more preferably equal to or greater than 0.01% by mass and equal to or smaller than 1.5% by mass, and even more preferably equal to or greater than 0.02% by mass and equal to or smaller than 1.0% by mass.

If necessary, the interlayer A and the interlayer B may contain a hydrophilic polymer such as gelatin, polyvinyl alcohol, methyl cellulose, hydroxypropyl cellulose, or carboxymethyl cellulose. The content of the hydrophilic polymer with respect to the total amount of the binder in the interlayer A is preferably equal to or smaller than 50% by mass, and more preferably equal to or smaller than 20% by mass.

The total amount of the binder coating the interlayer A is preferably 0.5 g/m² to 3.0 g/m², and more preferably 1.0 g/m² to 2.0 g/m².

The total amount of the binder coating the interlayer B is preferably 0.3 g/m² to 3.0 g/m², and more preferably 0.5 g/m² to 1.5 g/m².

<<Outermost Layer>>

The outer most layer contains the hydrophilic polymer as a binder preferably in an amount equal to or greater than 50% by mass and more preferably in an amount equal to or greater than 60% by mass.

The hydrophilic polymer in the present disclosure is preferably a hydrophilic polymer derived from animal proteins. The hydrophilic polymer derived from animal proteins refers to a natural water-soluble polymer such as glue, casein, gelatin, or eggwhite or a chemically modified water-soluble polymer. Among these, gelatin is preferable. Gelatin is classified into acid-treated gelatin and alkali-treated gelatin (lime treatment or the like) according to the synthesis method, and any of these can be preferably used. It is preferable to use gelatin having a molecular weight of 10,000 to 1,000,000. Furthermore, it is possible to use modified gelatin (for example, phthalated gelatin) obtained by performing a modification treatment by using an amino group or a carboxyl group of gelatin. As gelatin, inert gelatin (for example, NITTA GELATIN 750), phthalated gelatin (for example NITTA GELATIN 801), and the like can be used.

In a case where gelatin in an aqueous solution heated to a temperature equal to or higher than 30° C., the gelatin changes to sol. In a case where the gelatin is cooled to a temperature equal to or lower than 30° C., the gelatin changes to gel and loses fluidity. The sol-gel change reversibly occurs depending on the temperature. Therefore, the aqueous gelatin solution as a coating solution has setting properties in which the gelatin loses fluidity in a case where it is cooled to a temperature lower than 30° C.

<<Antihalation Layer>>

In the thermally-developable photosensitive material according to the present disclosure, an antihalation layer can be provided between the image forming layer and the support, for example.

Examples of the antihalation layer include those described in paragraphs “0123” and “0124” in JP1999-065021A (JP-H11-065021A), JP1999-223898A (JP-H11-223898A), JP1997-230531A (JP-H09-230531A), JP1998-036695A (JP-H10-036695A), JP1998-104779A (JP-H10-104779A), JP1999-231457A (JP-H11-231457A), JP1999-352625A (JP-H11-352625A), and JP1999-352626A (JP-H11-352626A).

It is preferable that the antihalation layer contains an antihalation dye absorbing an exposure wavelength. In the present disclosure, the exposure wavelength is in an infrared region, and accordingly, an infrared absorbing dye may be used. In this case, it is preferable to use a dye which does not absorb visible rays. Furthermore, it is preferable that the antihalation dye contains a water-soluble dye or a solid dispersed dye whose absorption wavelength is variable with pH.

In a case where a visible ray-absorbing dye is used to prevent halation, it is preferable that the color of the dye substantially does not remain after the formation of an image. It is more preferable to use means for decolorizing by using the heat of thermal development. Particularly, it is preferable to add a decolorizing dye and a base precursor to the non-photosensitive layer such that the non-photosensitive layer functions as an antihalation layer. These techniques are described in JP1999-231457A (JP-H11-231457A) and the like.

The amount of the decolorizing dye added is determined according to the use of the dye. It is preferable that the dye is used in such an amount that causes an optical density (absorbance) measured at an intended wavelength to exceed 0.1. The optical density is preferably 0.15 to 2, and more preferably 0.2 to 1. The amount of the decolorizing dye used for obtaining this optical density is preferably about 0.001 g/m² to 1 g/m².

In a case where the dye is decolorized as described above, the optical density after thermal development can be reduced and become equal to or lower than 0.1. In a thermal decolorization-type recording material or a thermally-developable photosensitive material, two or more kinds of decolorizing dyes may be used in combination. Likewise, two or more kinds of base precursors may be used in combination.

For performing thermal decolorization by using the decolorizing dye and the base precursor, in view of thermal decolorization properties and the like, it is preferable to use a substance (for example, diphenylsulfone or 4-chlorophenyl(phenyl)sulfone), which reduces a melting point by 3° C. (deg) or more in a case where the substance is mixed with a base precursor described in JP1999-352626A (JP-H11-352626A), 2-naphthylbenzoate, and the like in combination.

<Film Surface pH>

In the thermally-developable photosensitive material according to the present disclosure, a film surface pH of the image forming layer not yet being subjected to a thermal development treatment is preferably equal to or lower than 7.0, and more preferably equal to or lower than 6.6. The lower limit thereof is not particularly limited, and is about 3. The pH is particularly preferably within a range of 4 to 6.2. From the viewpoint of reducing the film surface pH, it is preferable to control the film surface pH by using a nonvolatile acid such as an organic acid like a phthalic acid derivative or sulfuric acid and a volatile base such as ammonia. Particularly, ammonia is preferable for achieving low film surface pH, because this base easily volatilizes and can be removed before a coating step or thermal development. Furthermore, it is also preferable to use a nonvolatile base such as sodium hydroxide, potassium hydroxide, or lithium hydroxide in combination with ammonia. The method for measuring the film surface pH is described in paragraph “0123” in JP2000-284399A.

<Hardener>

In the thermally-developable photosensitive material according to the present disclosure, each of the layers such as the image forming layer, the protective layer, and the non-photosensitive back layer may contain a hardener. Examples of the hardener are listed in each of the methods described in “THE THEORY OF THE PHOTOGRAPHIC PROCESS FOURTH EDITION” (T. H. James, Macmillan Publishing Co., Inc., 1977, pp. 77-87). As the hardener, chromium alum, a 2,4-dichloro-6-hydroxy-s-triazine sodium salt, N,N-ethylenebis(vinylsulfonacetamide), N,N-propylenebis(vinylsulfonacetamide), the polyvalent metal ions described on p. 78 and the like in the same document as above, the polyisocyanates in the specification of U.S. Pat. No. 4,281,060A, JP1994-208193A (JP-H06-208193A), and the like, the epoxy compounds in the specification of U.S. Pat. No. 4,791,042A and the like, and the vinylsulfone-based compounds in JP1987-089048A (JP-S62-089048A) and the like are preferably used.

The hardener is added as a solution. The period of time for adding the solution to a protective layer coating solution is from 180 minutes before coating to immediately before coating, and preferably is from 60 minutes before coating to 10 seconds before coating. However, the mixing method and the mixing condition are not particularly limited as long as the effects of the present disclosure are sufficiently demonstrated. Specifically, the mixing method include a method of performing mixing in a tank which is controlled such that an average retention time calculated from the flow rate of the solution added and the amount of the solution supplied to a coater becomes a desired time, and a method of using the static mixer or the like described in “Liquid Mixing Technique” (N. Hamby, M. F. Edwards, A. W. Nienow, translated by Koji Takahashi, The Nikkan Kogyo Shimbun, Ltd., 1989, Chapter 8).

<Surfactant>

The surfactant which can be used in the present disclosure is described in paragraph “0132” in JP1999-065021A (JP-H11-065021A). The solvent which can be used in the present disclosure is described in paragraph “0133” in the same publication. The support which can be used in the present disclosure is described in paragraph “0134” in the same publication. The antistatic agent and the conductive layer which can be used in the present disclosure are described in paragraph “0135” in the same publication. The method for obtaining a color image that can be used in the present disclosure is described in paragraph “0136” in the same publication. The lubricant which can be used in the present disclosure is described in paragraphs “0061” to “0064” in JP1999-084573A (JP-H11-084573A).

It is preferable that the thermally-developable photosensitive material according to the present disclosure contains, as a surfactant, a fluorine compound having an alkyl fluoride group containing 2 or more carbon atoms and 12 or less fluorine atoms. Examples of the fluorine compound include the compounds described in line 1 on p. 10 to line 30 on p. 36 in JP2004-212903A.

The fluorine compound is preferably used as a surfactant in a coating composition for forming a layer on any of the surfaces provided with the image forming layer. Particularly, it is preferable to use the fluorine compound for forming the outermost layer of the thermally-developable photosensitive material, because then an effective antistatic ability and coating uniformity can be obtained. In view of demonstrating the antistatic ability and coating uniformity, the fluorine compound of the present disclosure is useful. Furthermore, the fluorine compound is effective for improving storage stability, dependence on usage environment, and the like.

The amount of the fluorine compound used is not particularly limited, and can be optionally determined according to the structure of the fluorine compound to be used, the layer in which the fluorine compound to be used, the type or amount of other materials to be incorporated into the composition, and the like. For example, in a case where the fluorine compound is used as the coating solution for the outermost layer of the thermally-developable photosensitive material, the amount of the fluorine compound used for coating is preferably 0.1 mg/m² to 100 mg/m², and more preferably 0.5 mg/m² to 20 mg/m².

In the present disclosure, one kind of fluorine compound may be used singly, or two or more kinds of fluorine compounds may be used in combination. Furthermore, a fluorine compound other than the fluorine compound, which has an alkyl fluoride group containing 2 or more carbon atoms and 12 or less dispersion liquids, may be used in combination. Furthermore, a fluorine compound and a surfactant other than the fluorine compound may be used in combination.

<Antistatic Agent>

It is preferable that the thermally-developable photosensitive material according to the present disclosure has a conductive layer containing a metal oxide or a conductive polymer. The antistatic layer may be used as an undercoat layer, a surface protective layer for the non-photosensitive back layer, or the like, or may be used as a layer different from these layers. As the conductive material to be incorporated into the antistatic layer lacks the oxygen of a metal oxide, and hence a metal oxide is preferably used into which dissimilar metal atoms are introduced to increase conductivity. As the metal oxide, for example, ZnO, TiO₂, and SnO₂ are preferable. It is preferable to add Al or In to ZnO. It is preferable to add Sb, Nb, P, a halogen element, or the like to SnO₂. It is preferable to add Nb, Ta, or the like to TiO₂. As the conductive material, SnO₂ to which Sb is added is particularly preferable.

The amount of the dissimilar atoms added is preferably within a range of 0.01 mol % to 30 mol %, and more preferably within a range of 0.1 mol % to 10 mol %. The metal oxide may have any of a spherical shape, a needle shape, or a plate shape. From the viewpoint of a conductivity imparting effect, a ratio of major axis/minor axis in the metal oxide is preferably equal to or higher than 2.0. The metal oxide is more preferably needle-like particles in which the ratio is 3.0 to 50. The amount of the metal oxide used is preferably within a range of 1 mg/m² to 1,000 mg/m², more preferably within a range of 10 mg/m² to 500 mg/m², and even more preferably within a range of 20 mg/m² to 200 mg/m².

The antistatic layer may be disposed on any of the side of the support having the image forming layer or the side of the support having the non-photosensitive back layer. It is preferable that the antistatic layer is disposed between the support and the non-photosensitive back layer. Specific examples of the antistatic layer are listed in paragraph “0135” in JP1999-065021A (JP-H11-065021A), JP1981-143430A (JP-S56-143430A), JP1981-143431A (JP-S56-143431A), JP1983-062646A (JP-S58-062646A), JP1981-120519A (JP-S56-120519A), paragraphs “0040” to “0051” in JP1999-084573A (JP-H11-084573A), the specification of U.S. Pat. No. 5,575,957A, and paragraphs “0078” to “0084” in JP1999-223898A (JP-H11-223898A).

<Packing Material>

It is preferable that the thermally-developable photosensitive material according to the present disclosure is packed with at least a packing material having a low oxygen permeability or a packing material having a low moisture permeability, such that the change in photographic performance is inhibited in a case where the material is stored as it is or that curling or winding of the material is inhibited. The oxygen permeability at 25° C. is preferably equal to or lower than 50 mL/atm·m²·day, more preferably equal to or lower than 10 mL/atm·m²·day, and even more preferably equal to or lower than 1.0 mL/atm·m²·day. The moisture permeability is preferably equal to or lower than 10 g/atm·m²·day, more preferably equal to or lower than 5 g/atm·m²·day, and even more preferably equal to or lower than 1 g/atm·m²·day.

Specific examples of the packing material having a low oxygen permeability and/or a low moisture permeability include the packing materials described in JP1996-254793A (JP-H08-254793A) or JP2000-206653A.

<Other Usable Techniques>

Examples of the techniques which can be used for the thermally-developable photosensitive material according to the present disclosure also include the techniques described in the specification of EP803764A1, the specification of EP883022A1, WO98/036322A, JP1981-062648A (JP-S56-062648A), JP1983-062644A (JP-S58-062644A), JP1997-043766A (JP-H09-043766A), JP1997-281637A (JP-H09-281637A), JP1997-297367A (JP-H09-297367A), JP1997-304869A (JP-H09-304869A), JP1997-311405A (JP-H09-311405A), JP1997-329865A (JP-H09-329865A), JP1998-010669A (JP-H10-010669A), JP1998-062899A (JP-H10-062899A), JP1998-069023A (JP-H10-069023A), JP1998-186568A (JP-H10-186568A), JP1998-090823A (JP-H10-090823A), JP1998-171063A (JP-H10-171063A), JP1998-186565A (JP-H10-186565A), JP1998-186567A (JP-H10-186567A), JP1998-186569A (JP-H10-186569A), JP1998-186570A (JP-H10-186570A), JP1998-186571A (JP-H10-186571A), JP1998-186572A (JP-H10-186572A), JP1998-197974A (JP-H10-197974A), JP1998-197982A (JP-H10-197982A), JP1998-197983A (JP-H10-197983A), JP1998-197985A (JP-H10-197985A), JP1998-197986A (JP-H10-197986A), JP1998-197987A (JP-H10-197987A), JP1998-207001A (JP-H10-207001A), JP1998-207004A (JP-H10-207004A), JP1998-221807A (JP-H10-221807A), JP1998-282601A (JP-H10-282601A), JP1998-288823A (JP-H10-288823A), JP1998-288824A (JP-H10-288824A), JP1998-307365A (JP-H10-307365A), JP1998-312038A (JP-H10-312038A), JP1998-339934A (JP-H10-339934A), JP1999-007100A (JP-H11-007100A), JP1999-015105A (JP-H11-015105A), JP1999-024200A (JP-H11-024200A), JP1999-024201A (JP-H11-024201A), JP1999-030832A (JP-H11-030832A), JP1999-084574A (JP-H11-084574A), JP1999-065021A (JP-H11-065021A), JP1999-109547A (JP-H11-109547A), JP1999-125880A (JP-H11-125880A), JP1999-129629A (JP-H11-129629A), JP1999-133536A (JP-H11-133536A), JP1999-133537A (JP-H11-133537A), JP1999-133538A (JP-H11-133538A), JP1999-133539A (JP-H11-133539A), JP1999-133542A (JP-H11-133542A), JP1999-133543A (JP-H11-133543A), JP1999-223898A (JP-H11-223898A), JP1999-352627A (JP-H11-352627A), JP1999-305377A (JP-H11-305377A), JP1999-305378A (JP-H11-305378A), JP1999-305384A (JP-H11-305384A), JP1999-305380A (JP-H11-305380A), JP1999-316435A (JP-H11-316435A), JP1999-327076A (JP-H11-327076A), JP1999-338096A (JP-H11-338096A), JP1999-338098A (JP-H11-338098A), JP1999-338099A (JP-H11-338099A), JP1999-343420A (JP-H11-343420A), JP2000-187298A, JP2000-010229A, JP2000-047345A, JP2000-206642A, JP2000-098530A, JP2000-098531A, JP2000-112059A, JP2000-112060A, JP2000-112104A, JP2000-112064A, and JP2000-171936A.

(Preparation Method of Thermally-Developable Photosensitive Material)

The preparation method of the thermally-developable photosensitive material according to the present disclosure is not particularly limited. From the viewpoint of making it easy to control pH and to introducing mechanism such as chemical sensitization and color sensitization of silver halide, it is preferable that the preparation method includes a step of forming the image forming layer by aqueous coating.

Furthermore, from the viewpoint of the sharpness as image quality of the image to be obtained, it is preferable that the preparation method of the thermally-developable photosensitive material according to the present disclosure includes a step of preparing a coating solution for forming an image forming layer by adding at least one kind of compound selected from the group consisting of the infrared sensitizing dye represented by Formula (III), the intensely color-sensitizing compound represented by Formula (IV), and the intensely color-sensitizing compound represented by Formula (V) to a composition containing a photosensitive silver halide under a temperature condition equal to or higher than 50° C. The step of forming the image forming layer by aqueous coating is more preferably a step of forming the image forming layer by performing aqueous coating by using the coating solution for forming an image forming layer. In a case where the aforementioned sensitizing compound is added at a temperature equal to or higher than 50° C., the adsorption of the sensitizing compound onto the surface of the silver halide is promoted, the storability of the sensitive material, the stability in the production process, and the like can be improved. Furthermore, it is preferable that the preparation method of the thermally-developable photosensitive material according to the present disclosure includes a step of forming a non-photosensitive layer by aqueous coating.

Each of the layers in the thermally-developable photosensitive material according to the present disclosure, such as the image forming layer, may be coated by any method. Specifically, various coating methods including extrusion coating, slide coating, curtain coating, dip coating, knife coating, flow coating, or extrusion coating using the hopper described in the specification of U.S. Pat. No. 2,681,294A may be used. Among these, extrusion coating or slide coating described in “LIQUID FILM COATING” (Stephen F. Kistler, Petert M. Schweizer, CHAPMAN & HALL, 1997, pp. 399-536) is preferably used, and the slide coating is more preferably used. The shape of a slide coater used in the slide coating is described in FIG. 11b. 1 on p. 427 in the same document. Furthermore, as desired, two or more layers may be simultaneously coated by the method described on pp. 399-536 in the same document or the method described in the specification of U.S. Pat. No. 2,761,791A or the specification of UK837095B. In the present disclosure, as the coating method, for example, the methods described in JP2001-194748A, JP2002-153808A, JP2002-153803A, JP2002-182333A, and the like are particularly preferable.

It is preferable that the image forming layer coating solution is a thixotropic fluid. Regarding the thixotropic fluid, JP1999-052509A (JP-H11-052509A) and the like can be referred to. The viscosity of the organic silver salt-containing layer coating solution of the present disclosure at a shear rate of 0.1 S⁻¹ is preferably equal to or higher than 400 mPa·s and equal to or lower than 100,000 mPa·s, and more preferably equal to or higher than 500 mPa·s and equal to or lower than 20,000 mPa·s. Furthermore, the viscosity of the image forming layer coating solution at a shear rate of 1,000 S⁻¹ is preferably equal to or higher than 1 mPa·s and equal to or lower than 200 mPa·s, and more preferably equal to or higher than 5 mPa·s and equal to or lower than 80 mPa·s.

In the present disclosure, as a solvent of the image forming layer coating solution of the thermally-developable photosensitive material of the present disclosure (herein, for simplification, a solvent and a dispersion medium are collectively referred to as solvent), an aqueous solvent in which water content is equal to or greater than 30% by mass is preferable. As components other than water, any organic solvent miscible with water such as methyl alcohol, ethyl alcohol, isopropyl alcohol, methyl cellosolve, ethyl cellosolve, dimethylformamide, or ethyl acetate may be used. The water content rate of the solvent of the coating solution is preferably equal to or higher than 50% by mass, and more preferably equal to or higher than 70% by mass. Examples of preferable solvent composition include water, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol=85/10/5, and the like (the unit of the numerical value is % by mass).

In a case where two kinds of liquids are mixed together for preparing the coating solution, it is preferable to use a known in-line mixer or in-plant mixer. In the present disclosure, as the in-line mixer, for example, the mixer described in JP2002-085948A is preferable. As the in-plant mixer, for example, the mixer described in JP2002-090940A is preferable.

It is preferable that the coating solution is subjected to a defoaming treatment such that the coating surface shape is excellently maintained. In the present disclosure, as the defoaming treatment, for example, the method described in JP2002-066431A is preferable. At the time of performing coating by using the coating solution, in order to prevent dirt, dust, and the like from adhering to the support by the charging of the support, it is preferable to perform neutralization. In the present disclosure, as a neutralization method, for example, the method described in JP2002-143747A is preferable.

In the present disclosure, in order to dry the image forming layer coating solution that does not have setting properties, it is important to accurately control drying air and drying temperature. Preferable drying methods are specifically described in JP2001-194749A, JP2002-139814A, and the like.

In order to improve film forming properties, it is preferable that the thermally-developable photosensitive material according to the present disclosure is subjected to a heating treatment immediately after the material is coated and dried. The heating treatment temperature expressed as a film surface temperature is preferably within a range of 60° C. to 100° C., and more preferably within a range of 70° C. to 90° C. The heating time is preferably within a range of 1 second to 60 seconds, and more preferably within a range of 2 seconds to 10 seconds. As the heating treatment method, for example, the method described in JP2002-107872A is preferable.

Furthermore, in order to stably continuously manufacture the thermally-developable photosensitive material according to the present disclosure, it is preferable to use the manufacturing method described in JP2002-156728A or JP2002-182333A.

It is preferable that the thermally-developable photosensitive material according to the present disclosure is a mono-sheet type (a type of thermally-developable photosensitive material on which an image can be formed without using another sheet such as an image receiving material).

(Image Forming Method)

1) Exposure

The thermally-developable photosensitive material according to the present disclosure may be exposed by any method, but it is preferable to carry out scanning exposure performed using laser light as an exposure light source. As a laser, it is possible to use a He—Ne laser emitting light in a wavelength range of red to infrared, a red semiconductor layer, an Ar⁺, He—Ne, or He—Cd laser emitting light in a wavelength range of blue to green, or a blue semiconductor laser. In the present disclosure, it is preferable to use a semiconductor layer emitting light in a wavelength range of red to infrared. The laser light preferably has a peak in a wavelength range of 700 nm to 900 nm, and more preferably has a peak in a wavelength range of 720 nm to 850 nm. It is also preferable to use a blue semiconductor laser. In this case, the laser light preferably has a peak in a wavelength range of 300 nm to 500 nm, and more preferably has a peak in a wavelength range of 400 nm to 500 nm.

The laser light caused to demonstrate vertical multiple oscillation by a method such as superimposition of high frequencies is preferably used as well.

2) Thermal Development

The thermally-developable photosensitive material according to the present disclosure may be developed by any method. Generally, the thermally-developable photosensitive material is image-wise exposed and then developed by heating. The development temperature is preferably 80° C. to 250° C., more preferably 100° C. to 140° C., and even more preferably 110° C. to 130° C. The development time is preferably 1 second to 60 seconds, more preferably 3 seconds to 30 seconds, even more preferably 5 seconds to 25 seconds, and particularly preferably 7 seconds to 15 seconds.

As the thermal development method, any of a drum-type heater or a plate-type heater may be used, but the plate-type heater is more preferable. As the thermal development method performed using the plate-type heater, the method described in JP1999-133572A (JP-H11-133572A) is preferable. In this method, a thermal development apparatus is used which brings heating means into contact with the thermally-developable photosensitive material, in which a latent image is formed, in a thermal development portion so as to obtain a visible image. The heating means includes a plate heater, a plurality of pressing rollers are arranged along one surface of the plate heater such that the rollers face each other, and the thermally-developable photosensitive material passes between the pressing roller and the plate heater so as to perform thermal development. It is preferable to divide the plate heater into 2 to 6 stages, and the temperature of the tip portion thereof is reduced preferably by about 1° C. to 10° C. For example, a group of four plate heaters each of which can be independently subjected to temperature control may be used, and the temperature of each of the heaters may be controlled to be 112° C., 119° C., 121° C., and 120° C. This method is described in JP1979-030032A (JP-S54-030032A) as well, and makes it possible to remove the moisture or the organic solvent contained in the thermally-developable photosensitive material to the outside the system, and to inhibit the shape of the support of the thermally-developable photosensitive material from changing in a case where the thermally-developable photosensitive material is rapidly heated.

In order to reduce the size of the thermal development apparatus and to reduce the thermal development time, it is preferable to more stably control the heater and to start the exposure from the head portion of one sheet of sensitive material such that thermal development starts before the exposure of the tail portion is finished. The imaging device (imager) which can rapidly perform the treatment in the present disclosure is described, for example, in JP2002-289804A and JP2002-287668A. In a case where this imager is used, by using a three-stage plate-type heaters whose temperatures are controlled to be 107° C., 121° C., and 121° C. respectively, the thermal development treatment can be finished within 14 seconds, the time taken for outputting one sheet can be reduced to be about 60 seconds. For such a rapid development treatment, it is preferable to use the thermally-developable photosensitive material of the present disclosure, which has high sensitivity and is hardly affected by the environmental temperature, in combination.

3) System

As a laser imager for medical uses including an exposure portion and a thermal development portion, for example, there is a FUJI medical dry laser imager FM-DPL (manufactured by FUJIFILM Corporation). FM-DPL is described in “Fuji Medical Review” (No. 8, pp. 39-55), and the techniques described in the document may be applied as the laser imager of the thermally-developable photosensitive material according to the present disclosure. Furthermore, the thermally-developable photosensitive material of the present disclosure can be applied as a thermally-developable photosensitive material for a laser imager in “AD network” that FUJIFILM Medical Systems have suggested as a network system meeting the Digital Imaging and Communication in Medicine (DICOM) standards.

(Use)

The thermally-developable photosensitive material according to the present disclosure forms a black-and-white image containing silver and can be used as a thermally-developable photosensitive material for medical diagnoses, a thermally-developable photosensitive material for industrial photographs, a thermally-developable photosensitive material for printing, and a thermally-developable photosensitive material for computer output microfilm (COM).

### EXAMPLES

Hereinafter, embodiments of the present invention will be more specifically described based on examples. However, as long as the gist of the present disclosure is maintained, the present invention is not limited to the following examples. Unless otherwise specified, “part” is based on mass.

### Example 1

((Preparation of PET Support))

(Preparation of Film)

By using terephthalic acid and ethylene glycol, polyethylene terephthalate (PET) having an intrinsic viscosity IV=0.66 dL/g was obtained according to a common method (the compounds were dissolved in phenol/tetrachloroethane=6/4 (mass ratio), and IV was measured at 25° C.). PET was pelletized, then dried for 4 hours at 130° C., melted at 300° C., extruded from a T-die, and rapidly cooled, thereby preparing a non-stretched film. The intrinsic viscosity IV is a value obtained by subtracting 1 from a ratio ηᵣ (=η/η₀; relative viscosity) of a solution viscosity (η) to a solvent viscosity (η₀) so as to obtain a specific viscosity (ηₛₚ=ηᵣ−1), dividing ηₛₚ by concentration, and performing extrapolation on the basis of the obtained value on condition that the concentration is 0.

The intrinsic viscosity IV was measured by the following method.

1) A target sample (1.5000 g to 1.5005 g) was weighed and put into a 50 ml volumetric flask.

2) An IV solution (phenol/tetrachloroethane=6/4, 30 ml) was added to the volumetric flask.

3) The mixed solution obtained as above was dissolved by being heated and stirred for 15 minutes in an oil bath at 145° C., and then left to cool for 10 minutes at room temperature (25° C.).

4) Then, the solution was cooled for 15 minutes in a water tank at 25° C., and the IV solution was added thereto such that the volume of the solution was increased up to the gauge line.

5) By using a measurement apparatus including Ostwald viscometer (Yamato Labotech K.K., model: AVM-102), the number of seconds (t1) for which the IV solvent fell and the number of seconds (t2) for which the prepared solution fell were measured.

6) From the ratio between the measured values (t2/t1), the intrinsic viscosity was calculated using the Huggins viscosity equation.

The non-stretched film obtained as above was longitudinally stretched by 330% by using rolls having different circumferential speeds, and then transversely stretched by 450% by using a tenter. At this time, the temperature was 110° C. and 130° C. respectively. Thereafter, the film was thermally fixed for 20 seconds at 240° C., and then relaxed by 4% in the transverse direction at 240° C. Subsequently, chuck portions of the tenter were slit, both ends of the film were subjected to a knurling process, and the film was wound at 4 kg/cm², thereby obtaining a roll of a biaxially stretched polyethylene terephthalate (PET) support having a thickness of 175 μm.

(Surface Corona Treatment)

By using a solid-state corona treatment machine 6KVA model manufactured by NIPPON PILLAR PACKING CO., LTD., a corona treatment was performed on both surfaces of the PET support at room temperature (25° C., the same is true for the following description) and 20 m/min. From the read values of the current and voltage at this time, it was understood that the support was treated at 0.375 kV·A·min/m². During the corona treatment, the treatment frequency was 9.6 kHz, and the gap clearance between an electrode and a dielectric roll was 1.6 mm.

(Undercoat)

1) Preparation of undercoat layer coating solution

Formulation (1) (Undercoat layer coating solution for image forming layer)
PESRESIN A-520 (manufactured by TAKAMATSU OIL & FAT CO., LTD., 30% by mass solution): 46.8 g
BAIRONAL MD-1200 (manufactured by Toyobo Co., Ltd): 10.4 g
Polyethylene glycol monononyl phenyl ether: 11.0 g

(average number of ethylene oxide=8.5; 1% by mass solution)
MP-1000 (manufactured by Soken Chemical & Engineering Co., Ltd., polymethyl methacrylate (PMMA) polymer particles having an average particle size 0.4 μm): 0.91 g
Distilled water: 931 mL

Formulation (2) (Undercoat layer coating solution for back surface-side first layer)
Styrene-butadiene copolymer latex (manufactured by ZEON CORPORATION, solid contents 40% by mass, mass ratio of styrene/butadiene=68/32): 130.8 g
2,4-Dichloro-6-hydroxy-S-triazine sodium salt (manufactured by FUJIFILM Fine Chemicals, 8% by mass aqueous solution): 5.2 g
Polystyrene particle dispersion (manufactured by ZEON CORPORATION, average particle size 2 μm, 20% by mass): 0.5 g
Distilled water: 854 mL

Formulation (3) (Undercoat layer coating solution for back surface-side second layer)
SnO₂/SbO (manufactured by Mitsubishi Materials Corporation, 9/1 mass ratio, average particle size 0.5 μm, 17% by mass solid dispersion) 84 g
Gelatin (manufactured by Nitta Gelatin, Inc.): 7.9 g
METOLOSE TC-5 (manufactured by Shin-Etsu Chemical Co., Ltd., 2% by mass aqueous solution): 10 g
1% by mass aqueous solution of sodium dodecylbenzene sulfonate: 10 mL
NaOH (1% by mass): 7 g
PROXEL (manufactured by Avecia): 0.5 g
Distilled water: 881 mL

The aforementioned corona discharge treatment was performed on both the front surface and back surface of the biaxially stretched polyethylene terephthalate support having a thickness of 175 μm. Then, by using a wire bar, one surface thereof (surface of the image forming layer) was coated with the undercoat layer coating solution of Formulation (1) such that the wet coating amount became 6.6 mL/m² (per one surface), and then dried for 5 minutes at 180° C. Subsequently, by using a wire bar, the other surface (surface of the non-photosensitive back layer) was coated with the undercoat layer coating solution of Formulation (2) such that the wet coating amount became 5.7 mL/m², and then dried for 5 minutes at 180° C. Thereafter, by using a wire bar, the surface of the non-photosensitive back layer was coated with the undercoat layer coating solution of Formulation (3) such that the wet coating amount became 8.4 mL/m², and then dried for 6 minutes at 180° C. In this way, a support having undercoat layers was prepared.

2) Preparation of Infrared Absorbing Dye Dispersion B

A dye (0.5 kg) containing the following infrared absorbing dye B, 3.0 kg of a 10% by mass aqueous solution of carboxymethyl cellulose, 42 g of a surfactant (48% by mass aqueous solution of PIONIN A-43-S (manufactured by TAKEMOTO OIL & FAT Co., Ltd.)), and 3.0 g of an antifoaming agent (SAFINOL 104E (manufactured by Shin-Etsu Chemical Co., Ltd.)) were added and thoroughly mixed together, thereby obtaining slurry.

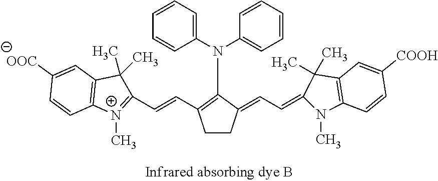

By using a diaphragm pump, the slurry obtained as above was supplied to a horizontal sand mill (UVM-2: manufactured by AIMEX Co., Ltd.) filled with zirconia beads having an average diameter of 0.5 mm, and dispersed for 5 hours. Then, 1.0 g of a benzisothiazolinone sodium salt and water were added thereto such that the concentration of the water-insoluble dye was adjusted and became 5% by mass. The dispersion liquid obtained as above was heated for 2 hours at 40° C., thereby obtaining a solid dispersion of the infrared absorbing dye B. The dye particles contained in the obtained solid dispersion had a median size of 0.49 μm and a maximum particle size equal to or smaller than 2.6 μm. The obtained solid dispersion was filtered through a filter made of polypropylene having a pore size of 3.0 μm so as to remove impurities such as dust, thereby obtaining an infrared absorbing dye dispersion B. The pH of the infrared absorbing dye dispersion B can be adjusted to be within a range of 5 to 9 by using sodium hydroxide.

3) Preparation of Infrared Absorbing Dye Aqueous Solution C

A dye (0.4 g) containing the following infrared absorbing dye C was added to 100 mL of pure water, thereby preparing a 0.4% by mass aqueous solution. The pH of the obtained aqueous solution can be adjusted to be within a range of 5 to 9 by using sodium hydroxide. In the following formula, Et represents an ethyl group.

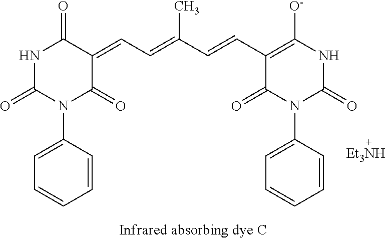 [SMILES: CC(/C=C/c1c([O-])[nH]c(=O)n(-c2ccccc2)c1=O)=C\C=C1\C(=O)NC(=O)N(c2ccccc2)C1=O]

((Non-Photosensitive Back Layer and Non-Photosensitive Back Surface Protective Layer))

(Non-Photosensitive Back Layer)

1) Preparation of Coating Solution 1 for Non-Photosensitive Back Layer

A container was kept at 40° C., 100 g of gelatin, 400 mg of benzisothiazolinone, 45 mL of a 5% by mass aqueous solution of the following blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). The viscosity of the obtained coating solution was measured using a B type viscometer (single cylinder-type viscometer VISMETRON, VS-A1 model, manufactured by Shibaura Systems Co., Ltd., No. 1 rotor, 60 rpm) at 40° C. As a result, the viscosity was 32 mPa·s. The pH of the coating solution was 5.15 at 40° C.

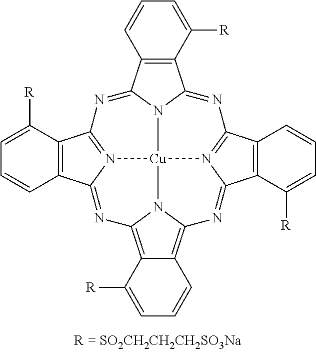

2) Preparation of Non-Photosensitive Back Layer Coating Solution 2

A container was kept at 40° C., 100 g of gelatin, 400 mg of benzisothiazolinone, 45 mL of a 5% by mass aqueous solution of the blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). A 0.4% by weight infrared absorbing dye aqueous solution (179 mL) of the infrared absorbing dye C was added to the obtained solution. The viscosity of the obtained coating solution was measured using a B type viscometer (No. 1 rotor, 60 rpm) at 40° C. As a result, the viscosity was 32 mPa·s. The pH of the coating solution was 5.15 at 40° C.

3) Preparation of Non-Photosensitive Back Layer Coating Solution 3

A container was kept at 40° C., 100 g of gelatin, 400 mg of benzisothiazolinone, 45 mL of a 5% by mass aqueous solution of the blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). A 0.4% by weight infrared absorbing dye aqueous solution (179 mL) of the infrared absorbing dye C was added to the obtained solution, and then 15 mL of a 5% by weight solid dispersed infrared absorbing dye of the infrared absorbing dye B was added thereto. The viscosity of the obtained coating solution was measured using a B type viscometer (No. 1 rotor, 60 rpm) at 40° C. As a result, the viscosity was 32 mPa·s. The pH of the coating solution was 5.15 at 40° C.

4) Preparation of Non-Photosensitive Back Layer Coating Solution 4

A container was kept at 40° C., 100 g of gelatin, 400 mg of benzisothiazolinone, 45 mL of a 5% by mass aqueous solution of the blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). A 0.4% by weight aqueous dye solution (179 mL) of the infrared absorbing dye C was added to the obtained solution, and then 15 mL of a 5% by weight solid dispersed dye of the infrared absorbing dye B was added thereto. The viscosity of the obtained coating solution was measured using a B type viscometer (No. 1 rotor, 60 rpm) at 40° C. As a result, the viscosity was 32 mPa·s. The pH of the coating solution was 7.5 at 40° C.

5) Preparation of Non-Photosensitive Back Layer Coating Solution 5

A container was kept at 40° C., 100 g of gelatin, 400 mg of benzisothiazolinone, 45 mL of a 5% by mass aqueous solution of the blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). A 5% by weight solid dispersed dye (30 mL) of the infrared absorbing dye B was added to the obtained solution. The viscosity of the obtained coating solution was measured using a B type viscometer (No. 1 rotor, 60 rpm) at 40° C. As a result, the viscosity was 32 mPa·s. The pH of the coating solution was 5.15 at 40° C.

6) Preparation of Non-Photosensitive Back Layer Coating Solution 6

A container was kept at 40° C., 100 g of gelatin, 400 mg of benzisothiazolinone, 45 mL of a 5% by mass aqueous solution of the blue dye 2, 6.1 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 72 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 52 mL of a 4% by mass aqueous solution of N,N-ethylenebis(vinylsulfonacetamide). A 5% by weight solid dispersed dye (30 mL) of the infrared absorbing dye B was added to the obtained solution. The viscosity of the obtained coating solution was measured using a B type viscometer (No. 1 rotor, 60 rpm) at 40° C. As a result, the viscosity was 32 mPa·s. The pH of the coating solution was 7.5 at 40° C.

(Non-Photosensitive Back Surface Protective Layer)

1) Preparation of Non-Photosensitive Back Surface Protective Layer Coating Solution Formulation (1) Back Surface Protective Layer Coating Solution 1

A container was kept at 40° C., 100 g of gelatin, 5.7 g of only one kind of monodispersed polymethyl methacrylate particles (average particle size 6 μm, standard deviation of particle size 0.4) as a matting agent, 637 mg of benzisothiazolinone, and 1,645 mL of water were added to the container, and the gelatin was dissolved. Furthermore, the obtained solution was mixed with 15.8 mL of a 30% by mass solution of carnauba wax (manufactured by CHUKYO YUSHI CO., LTD., SELOSOL 524), 5.7 mL of a 15% by mass methanol solution of phthalic acid, 24 mL of a 5% by mass aqueous solution of sodium di(2-ethylhexyl) sulfosuccinate, 50 mL of a 3% by mass aqueous solution of sodium polystyrene sulfonate, 12 mL of a 1% by mass solution of the following fluorine-based surfactant (F-1), 2.4 mL of a 2% by mass solution of a fluorine-based surfactant (F-2), and 72 g of a 20% by mass solution of ethyl acrylate/acrylic acid copolymer (copolymerization ratio based on mass: 64/4). Immediately before coating, the obtained solution was mixed with 90 mL of a 4% by mass aqueous solution of N,N-ethylenebis(vinylsulfonacetamide), thereby obtaining a back surface protective layer coating solution 1. The viscosity of the coating solution was measured using a B type viscometer (No. 1 rotor, 60 rpm) at 40° C. As a result, the viscosity was 28 mPa·s. The pH of the coating solution was 5.5 at 40° C.

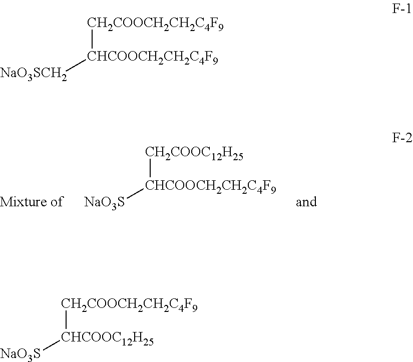

((Coating of Non-Photosensitive Back Layer))

By means of simultaneous multi-layer coating, the back surface side of the support having the undercoat layers was coated with the non-photosensitive back layer coating solution described in Table 1 such that the amount of gelatin used for coating became 1.5 g/m² and with the back surface protective layer coating solution 1 such that the amount of gelatin used for coating became 0.73 g/m², followed by drying. In this way, a non-photosensitive back layer was formed.

((Image Forming Layer, Interlayer, and Surface Protective Layer))

Coating Materials were Prepared as Below.

(Silver Halide Emulsion)

1) Preparation of Silver Halide Emulsion 1

A 1% by mass potassium bromide solution (3.1 mL) was added to 1,421 mL of distilled water, and 3.5 mL of sulfuric acid having a concentration of 0.5 mol/L and 31.7 g of phthalated gelatin were added thereto. While the obtained solution was being stirred in a reactor made of stainless steel, the liquid temperature thereof was kept at 27° C. Then, the whole quantity of a solution A, which was prepared by adding distilled water to 22.22 g of silver nitrate so as to obtain 95.4 mL of a diluted solution, and a solution B, which was prepared by diluting 15.3 g of potassium bromide and 0.8 g of potassium iodide so as to obtain a diluted solution having a volume of 97.4 mL, were added thereto for 45 seconds at a constant flow rate. Subsequently, 10 mL of a 3.5% by mass aqueous hydrogen peroxide solution was added to the obtained solution, and then 10.8 mL of a 10% by mass aqueous solution of benzimidazole was added thereto. The whole quantity of a solution C (317.5 mL), which was obtained by adding distilled water to 51.86 g of silver nitrate so as to dilute the compound, was added to the obtained solution for 20 minutes at a constant flow rate. Furthermore, 400 mL of a solution D, which was obtained by adding distilled water to 44.2 g of potassium bromide and 2.2 g of potassium iodide so as to dilute the compounds, was added to the obtained solution by a controlled double-jet method in a state where pAg of the solution D was kept at 8.1. Ten minutes after the addition of the solution C and the solution D was started, the whole quantity of potassium hexachloroiridate (III) was added thereto such that the amount of this compound became 1×10⁻⁴ mol per 1 mol of silver. In addition, 5 seconds after the end of the addition of the solution C, the whole quantity of an aqueous solution of potassium hexacyanoferrate (II) was added thereto such that the amount of this compound became 3×10⁻⁴ mol per 1 mol of silver. By using sulfuric acid having a concentration of 0.5 mol/L, the pH was adjusted to be 3.8, stirring was stopped, and precipitation/desalting/rinsing were performed. By using sodium hydroxide having a concentration of 1 mol/L, the pH was adjusted to be 5.9, thereby preparing a silver halide dispersion at a pAg of 8.0.

The silver halide dispersion obtained as above was kept at 38° C. while being stirred, a 5 mL of a 0.34% by mass methanol solution containing 1,2-benzisothiazolin-3-one was added thereto, and after 40 minutes, the solution was heated to 62° C. After the solution was heated for 20 minutes, a methanol solution of sodium benzene thiosulfonate was added thereto such that the amount of the solution became 7.6×10⁻⁵ mol with respect to 1 mol of silver. Then, after 5 minutes, a methanol solution of a tellurium sensitizer C was added thereto such that the amount of the solution became 5.2×10⁻⁴ mol per 1 mol of silver, and the resulting solution was kept at 62° C. while being stirred for 91 minutes. Thereafter, a spectral sensitizing dye A (dissolved in a solution containing phenoxyethanol (8%) and methanol (92%)) was added thereto in an amount of 3.0×10⁻³ mol, an intensely color-sensitizing compound B1 (methanol solution) and an intensely color-sensitizing compound B2 (methanol solution) were added thereto in amounts of 2.3×10⁻³ mol and 6.40×10⁻³ mol respectively. In addition, after 4 minutes, 1-phenyl-2-heptyl-5-mercapto-1,3,4-triazole (methanol solution) was added thereto in an amount of 5.4×10⁻³ mol with respect to 1 mol of silver, and an aqueous solution of 1-(3-methylureidophenyl)-5-mercaptotetrazole added thereto in an amount of 8.5×10⁻³ mol with respect to 1 mol of silver, thereby preparing a silver halide emulsion 1.

The particles in the prepared silver halide emulsion were silver iodobromide particles which had an average equivalent spherical diameter of 0.034 μm and homogeneously contained iodo at 3.5 mol %, in which a coefficient of variation of the equivalent spherical diameter was 20%. The particle size or the like was obtained by calculating the average particle size of 1,000 particles by using an electron microscope. The proportion of the (100) plane of these particles determined using the Kubelka-Munk method was 80%.

2) Preparation of Silver Halide Emulsion 2

In the preparation of the silver halide emulsion 1, precipitation/desalting/rinsing/dispersing were performed, the obtained solution was then heated to a temperature of 62° C., the infrared sensitizing dye A was not added, and the solution was aged in the same manner as the silver halide emulsion 1, thereby obtaining an emulsion named silver halide emulsion 2.

3) Preparation of Silver Halide Emulsion 3

In the preparation of the silver halide emulsion 1, precipitation/desalting/rinsing/dispersing were performed, the obtained solution was then heated to a temperature of 62° C., the intensely color-sensitizing compound B1 was not added, and the solution was aged in the same manner as the silver halide emulsion 1, thereby obtaining an emulsion named silver halide emulsion 3.

4) Preparation of Silver Halide Emulsion 4

In the preparation of the silver halide emulsion 1, precipitation/desalting/rinsing/dispersing were performed, the obtained solution was then heated to a temperature of 62° C., the intensely color-sensitizing compound B2 was not added, and the solution was aged in the same manner as the silver halide emulsion 1, thereby obtaining an emulsion named silver halide emulsion 4.

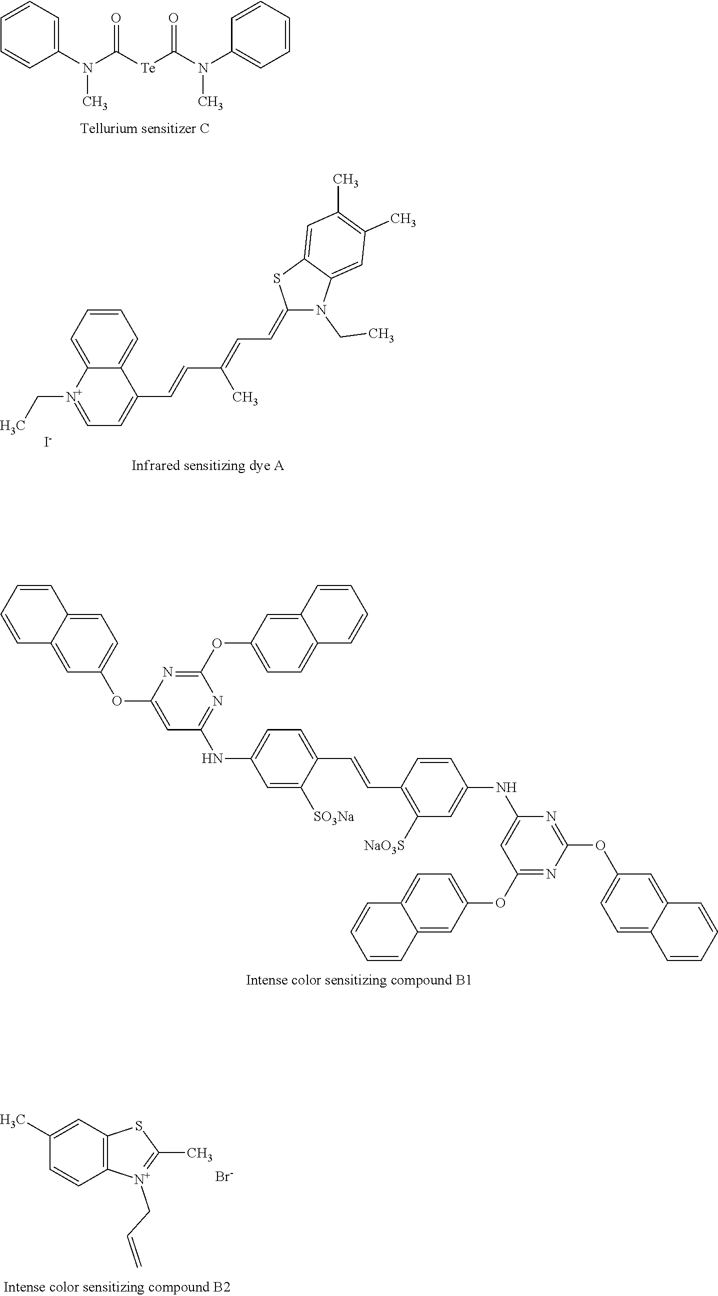

((Preparation of Silver Halide Emulsion A for Coating Solution))

The silver halide emulsion 1 was dissolved, and water was added thereto such that the amount of water per 1 kg of the emulsion became 513 mL, thereby preparing an emulsion A for a coating solution.

In the emulsion A for a coating solution, a content rate of silver was 35.4 g/Kg.

Furthermore, as compounds which generates a one-electron oxidant through one-electron oxidation that can release one or more electrons, the following compound 1, compound 20, and compound 26 were added in an amount of 2×10⁻³ mol per 1 mol of silver in the silver halide, thereby preparing a mixed emulsion A for a coating solution.

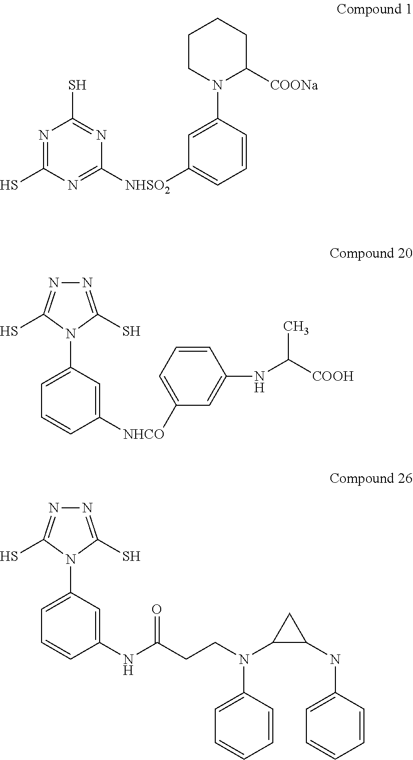

(Preparation of Fatty Acid Silver Dispersion)

1) Preparation of Recrystallized Behenic Acid

Behenic acid (manufactured by Henkel AG & Co., trade name: Edenor C22-85R) (100 kg) was mixed with 1,200 kg of isopropyl alcohol, dissolved at 50° C., filtered through a 10 μm filter, and then cooled to 30° C. so as to be recrystallized. The cooling speed at the time of recrystallization was 3° C./hour. The obtained crystals were centrifuged, rinsed with 100 kg of isopropyl alcohol, and then dried. The obtained crystals were esterified, and measured using a gas chromatograph-hydrogen flame ionization type detector (GC-FID). As a result, the content rate of behenic acid was 96 mol %, the content rate of lignoglyceric acid was 2 mol %, the content rate of arachidic acid was 2 mol %, and the content rate of erucic acid was 0.001 mol %.

2) Preparation of Fatty Acid Silver Dispersion

The recrystallized behenic acid (88 kg), 422 L of distilled water, 49.2 L of an aqueous solution of sodium hydroxide (NaOH) having a concentration of 5 mol/L, and 120 L of t-butyl alcohol were mixed together and reacted by being stirred for 1 hour at 75° C., thereby obtaining a sodium behenate solution B. Furthermore, 206.2 L (pH 4.0) of an aqueous solution of 40.4 kg of silver nitrate was separately prepared and kept at 10° C. A reaction container to which 635 L of distilled water and 30 L of t-butyl alcohol were added was kept at 30° C. While the solution in the reaction container was being thoroughly stirred, the whole quantity of the sodium behenate solution B and the whole quantity of the aqueous silver nitrate solution were added thereto for 93 minutes and 15 seconds and 90 minutes respectively at a constant flow rate.

Here, after the addition of the aqueous silver nitrate solution was started, only the aqueous silver nitrate solution was added for 11 minutes. The addition of the sodium behenate solution B was started thereafter, and after the addition of the aqueous silver nitrate solution ended, only the sodium behenate solution B was added for 14 minutes and 15 seconds. The internal temperature of the reaction container was kept at 30° C., and the external temperature was controlled such that the liquid temperature became constant. In addition, the piping of the system for adding the sodium behenate solution B was prepared such that the temperature of the piping was maintained by circulating hot water in the outer tube of a double pipe and that the liquid temperature at the outlet of the tip of an addition nozzle became 75° C. Moreover, the temperature of the piping of a system for adding the aqueous silver nitrate solution was maintained by circulating hot water in the outer tube of a double pipe. Furthermore, the piping was prepared such that the position where the addition of the sodium behenate solution B was performed and the position where the addition of the aqueous silver nitrate solution was performed became symmetrical about the stirring axis, and that the piping did not contact the reaction solution.

After the addition of the sodium behenate solution B ended, the reaction solution was left stirred for 20 minutes at the same temperature. The reaction solution was heated to 35° C. for 30 minutes, and then aged for 210 minutes. Immediately after the aging ended, solid contents were separated by filtration by means of centrifugation and rinsed with water until the conductivity of the filtrate became 30 ρS/cm. In this way, a fatty acid silver salt was obtained. The obtained solid contents were stored as a wet cake without being dried.

The shape of the obtained silver behenate particles was evaluated by electron microscopy. As a result, the particles were crystals in which the value of a equaled 0.21 μm on average, the value of b equaled 0.4 μm on average, the value of c equaled 0.4 μm on average, the average aspect ratio was 2.1, and a coefficient of variation of an equivalent spherical diameter was 11% (the definitions of a, b, and c are as described above).

Polyvinyl alcohol (trade name: PVA-217, 19.3 kg) and water were added to the wet cake containing 260 kg of dry solid contents such that the whole quantity thereof became 1,000 kg. Thereafter, the mixture was made into slurry by using a dissolver blade and then preliminarily dispersed using a pipeline mixer (manufactured by MIZUHO INDUSTRIAL CO., LTD.: PM-10 model).

Then, by using a disperser (trade name: MICROFLUIDIZER M-610, manufactured by MICROFLUIDICS INTERNATIONAL CORPORATION, using Z-type interaction chamber), the stock solution having been preliminarily dispersed was treated three times by controlling the pressure to be 1,150 kg/cm², thereby obtaining a silver behenate dispersion. For performing a cooling operation, a coil-type heat exchanger was mounted on the front and back of the interaction chamber, and the temperature of the refrigerant was controlled such that the dispersion temperature was set to be 18° C.

(Preparation of Reducing Agent Dispersion)

1) Preparation of Dispersion of Reducing Agent 1

Water (10 kg) was added to 10 kg of a reducing agent 1 (6,6′-di-t-butyl-4,4′-dimethyl-2,2′-butylidene diphenol) and 16 kg of a 10% by mass aqueous solution of modified polyvinyl alcohol (manufactured by KURARAY CO., LTD., POVAL MP203), and these were thoroughly mixed together, thereby obtaining slurry. By using a diaphragm pump, the slurry was supplied to a horizontal sand mill (UVM-2: manufactured by AIMEX Co., Ltd.) filled with zirconia beads having an average diameter of 0.5 mm, and dispersed for 3 hours and 30 minutes. Then, 0.2 g of a benzisothiazolinone sodium salt and water were added thereto such that the concentration of the reducing agent was adjusted and became 25% by mass. The obtained dispersion liquid was heated for 1 hour at 40° C. and then subjected to a heating treatment for 1 hour at 80° C., thereby obtaining a dispersion of a reducing agent 1. The reducing agent particles contained in the obtained dispersion of the reducing agent 1 had a median size of 0.50 μm and a maximum particle size equal to or smaller than 1.6 μm.

The obtained dispersion of the reducing agent 1 was filtered through a filter made of polypropylene having a pore size of 3.0 μm so as to remove impurities such as dust.

2) Preparation of Dispersion of Reducing Agent 2

Water (10 kg) was added to 10 kg of the following reducing agent (PP-1) and 16 kg of a 10% by mass aqueous solution of modified polyvinyl alcohol (manufactured by KURARAY CO., LTD., POVAL MP203), and these were thoroughly mixed together, thereby obtaining slurry. By using a diaphragm pump, the obtained slurry was supplied to a horizontal sand mill (UVM-2: manufactured by AIMEX Co., Ltd.) filled with zirconia beads having an average diameter of 0.5 mm, and dispersed for 3 hours and 30 minutes. Then, 0.2 g of a benzisothiazolinone sodium salt and water were added thereto such that the concentration of the reducing agent was adjusted and became 25% by mass. The obtained dispersion liquid was heated for 1 hour at 40° C. and then subjected to a heating treatment for 1 hour at 80° C., thereby obtaining a dispersion of a reducing agent 2. The reducing agent particles contained in the obtained dispersion of the reducing agent 2 had a median size of 0.35 μm and a maximum particle size equal to or smaller than 1.6 μm.

The obtained dispersion of the reducing agent 2 was filtered through a filter made of polypropylene having a pore size of 3.0 μm so as to remove impurities such as dust.

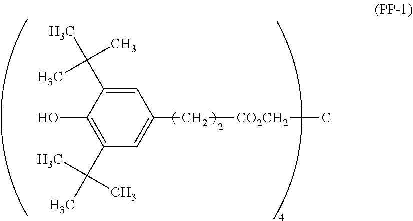

(Preparation of Dispersion of Hydrogen Bonding Compound 1)

Water (10 kg) was added to 10 kg of a hydrogen bonding compound 1 (tri(4-t-butylphenyl)phosphine oxide) and 16 kg of a 10% by mass aqueous solution of modified polyvinyl alcohol (manufactured by KURARAY CO., LTD., POVAL MP203), and these were thoroughly mixed together, thereby obtaining slurry. By using a diaphragm pump, the obtained slurry was supplied to a horizontal sand mill (UVM-2: manufactured by AIMEX Co., Ltd.) filled with zirconia beads having an average diameter of 0.5 mm, and dispersed for 4 hours. Then, 0.2 g of a benzisothiazolinone sodium salt and water were added thereto such that the concentration of the hydrogen bonding compound was adjusted and became 25% by mass. The obtained dispersion liquid was heated for 1 hour at 40° C. and then heated for 1 hour at 80° C., thereby obtaining a dispersion of the hydrogen bonding compound 1. The hydrogen bonding compound particles contained in the obtained dispersion of the hydrogen bonding compound 1 had a median size of 0.45 μm and a maximum particle size equal to or smaller than 1.3 μm. The obtained dispersion of the hydrogen bonding compound 1 was filtered through a filter made of polypropylene having a pore size of 3.0 μm so as to remove impurities such as dust.

(Preparation of Dispersion of Development Accelerator 1)

Water (10 kg) was added to 10 kg of the following development accelerator 1 and 20 kg of a 10% by mass aqueous solution of modified polyvinyl alcohol (manufactured by KURARAY CO., LTD., POVAL MP203), and these were thoroughly mixed together, thereby obtaining slurry. By using a diaphragm pump, the obtained slurry was supplied to a horizontal sand mill (UVM-2: manufactured by AIMEX Co., Ltd.) filled with zirconia beads having an average diameter of 0.5 mm, and dispersed for 3 hours and 30 minutes. Then, 0.2 g of a benzisothiazolinone sodium salt and water were added thereto such that the concentration of the development accelerator was adjusted and became 20% by mass, thereby obtaining a dispersion of the development accelerator 1. The development accelerator particles contained in the obtained dispersion of the development accelerator 1 had a median size of 0.48 μm and a maximum particle size equal to or smaller than 1.4 μm. The obtained dispersion of the development accelerator 1 was filtered through a filter made of polypropylene having a pore size of 3.0 μm so as to remove impurities such as dust.

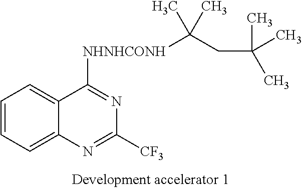

(Preparation of Dispersions of Development Accelerator 2 and Tone Adjuster 1)

Solid dispersions of the following development accelerator 2 and the following tone adjuster 1 were dispersed by the same method as that used for the development accelerator 1, thereby obtaining 20% by mass dispersion liquids.

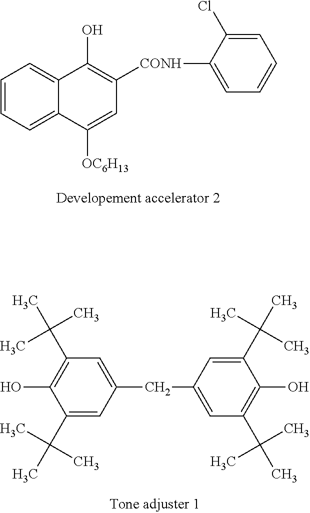

(Preparation of Polyhalogen Compound)

1) Preparation of Dispersion of Organic Polyhalogen Compound 1

The following organic polyhalogen compound 1 (tribromomethanesulfonylbenzene, 10 kg), 10 kg of a 20% by mass aqueous solution of modified polyvinyl alcohol (manufactured by KURARAY CO., LTD., POVAL MP203), 0.4 kg of a 20% by mass aqueous solution of sodium triisopropyl naphthalene sulfonate, and 14 kg of water were added and thoroughly mixed together, thereby obtaining slurry. By using a diaphragm pump, the obtained slurry was supplied to a horizontal sand mill (UVM-2: manufactured by AIMEX Co., Ltd.) filled with zirconia beads having an average diameter of 0.5 mm, and dispersed for 5 hours. Then, 0.2 g of a benzisothiazolinone sodium salt and water were added thereto such that the concentration of the organic polyhalogen compound was adjusted and became 26% by mass, thereby obtaining a dispersion of the organic polyhalogen compound 1. The organic polyhalogen compound particles contained in the obtained dispersion of the organic polyhalogen compound 1 had a median size of 0.41 μm and a maximum particle size equal to or smaller than 2.0 μm. The obtained dispersion of the organic polyhalogen compound 1 was filtered through a filter made of polypropylene having a pore size of 10.0 μm so as to remove impurities such as dust.

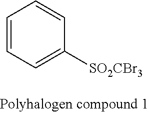

2) Preparation of Dispersion of Organic Polyhalogen Compound 2

The following organic polyhalogen compound 2 (N-butyl-3-tribromomethanesulfonylbenzamide, 10 kg), 20 kg of a 10% by mass aqueous solution of modified polyvinyl alcohol (manufactured by KURARAY CO., LTD., POVAL MP203), and 0.4 kg of a 20% by mass aqueous solution of sodium triisopropyl naphthalene sulfonate were added and thoroughly mixed together, thereby obtaining slurry. By using a diaphragm pump, the slurry was supplied to a horizontal sand mill (UVM-2: manufactured by AIMEX Co., Ltd.) filled with zirconia beads having an average diameter of 0.5 mm, and dispersed for 5 hours. Then, 0.2 g of a benzisothiazolinone sodium salt and water were added thereto such that the concentration of the organic polyhalogen compound was adjusted and became 30% by mass. The obtained dispersion liquid was heated at 40° C. for 5 hours, thereby obtaining a dispersion of the organic polyhalogen compound 2. The organic polyhalogen compound particles contained in the obtained dispersion of the organic polyhalogen compound 2 had a median size of 0.40 μm and a maximum particle size equal to or smaller than 1.3 μm. The obtained dispersion of the organic polyhalogen compound 2 was filtered through a filter made of polypropylene having a pore size of 3.0 μm so as to remove impurities such as dust.

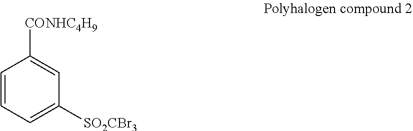

(Preparation of Solution of Phthalazine Compound 1)

Modified polyvinyl alcohol MP203 (manufactured by KURARAY CO., LTD., 8 kg) was dissolved in 174.57 kg of water. Then, 3.15 kg of a 20% by mass aqueous solution of sodium triisopropyl naphthalene sulfonate and 14.28 kg of a 70% by mass aqueous solution of the following phthalazine compound 1 (6-isopropylphthalazine) were added thereto, thereby preparing a 5% by mass solution of the phthalazine compound 1.

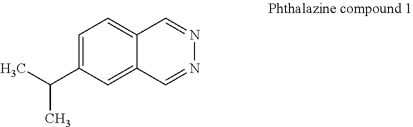

(Preparation of Mercapto Compound)

1) Preparation of Aqueous Solution of Mercapto Compound 2

The following mercapto compound 2 ((1-(3-methylureidophenyl)-5-mercaptotetrazole), 20 g) was dissolved in 980 g of water, thereby obtaining a 2.0% by mass aqueous solution.

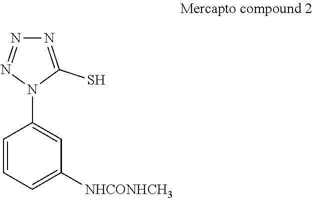

(Preparation of Azomethine Dye Solid Dispersion)

The following azomethine dye A (1.0 kg), 3.0 kg of a 10% by mass aqueous solution of modified polyvinyl alcohol (POVAL MP203 manufactured by KURARAY CO., LTD.), 42 g of a surfactant (48% by mass aqueous solution of PIONIN A-43-S(manufactured by TAKEMOTO OIL & FAT Co., Ltd.)), and 3.0 g of an antifoaming agent (SAFINOL 104E (manufactured by Shin-Etsu Chemical Co., Ltd.)) were thoroughly mixed together, thereby obtaining slurry.

By using a diaphragm pump, the obtained slurry was supplied to a horizontal sand mill (UVM-2: manufactured by AIMEX Co., Ltd.) filled with zirconia beads having an average diameter of 0.5 mm, and dispersed for 5 hours. Then, 1.0 g of a benzisothiazolinone sodium salt and water were added thereto such that the concentration of the water-insoluble azomethine dye was adjusted and became 10% by mass. The obtained dispersion liquid was heated at 40° C. for 2 hours, thereby obtaining an azomethine dye solid dispersion. The azomethine dye particles contained in the obtained azomethine dye solid dispersion had a median size of 0.49 μm and a maximum particle size equal to or smaller than 2.6 μm. The obtained azomethine dye solid dispersion was filtered through a filter made of polypropylene having a pore size of 3.0 μm so as to remove impurities such as dust, and then stored.

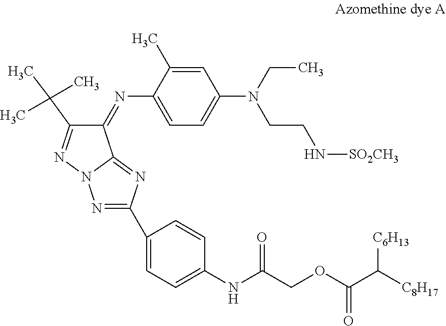

(Preparation of Benzotriazole Silver Dispersion)

Benzotriazole (1 kg) was added to a solution obtained by dissolving 360 g of sodium hydroxide in 9,100 mL of water, and the mixture was stirred for 60 minutes, thereby obtaining a sodium benzotriazole solution BT.

A liquid, which was obtained by adding 55.9 g of alkali-treated deionized gelatin to 1,400 mL of distilled water, was stirred in a reactor made of stainless steel while the temperature thereof was being kept at 70° C. A solution A was prepared by adding distilled water to 54.0 g of silver nitrate so as to obtain a diluted solution having a volume of 400 mL, and a solution B was prepared by diluting 397 mL of the sodium benzotriazole solution BT with distilled water so as to obtain a volume of 420 mL. By a double-jet method, 220 mL of the solution B was added to the reactor made of stainless steel at a constant flow rate of 20 mL/min for 11 minutes. Furthermore, 1 minute after the addition of the solution B was started, by a double-jet method, 200 mL of the solution A was added to the reactor made of stainless steel at a constant flow rate of 20 mL/min for 10 minutes. Then, after 6 minutes, 200 mL of the solution A and 200 mL of the solution B were simultaneously added to the reactor for 6 minutes at a constant flow rate of 33.34 mL/min. The mixture was cooled to 45° C. and kept stirred, and in this state, 92 mL of DEMOL N (10% aqueous solution, manufactured by Kao Corporation) was then added thereto, the pH thereof was adjusted to be 4.1 by using sulfuric acid having a concentration of 1 mol/L. Thereafter, stirring was stopped, and precipitation/desalting/rinsing steps were performed.

Subsequently, the temperature of the mixture was adjusted to be 50° C., and the mixture was kept stirred. In this state, 51 mL of sodium hydroxide having a concentration of 1 mol/L was added thereto, and then 11 mL of a methanol solution (3.5%) of benzisothiazolinone and 7.7 mL of a methanol solution (1%) of sodium benzene thiosulfonate were added thereto and stirred for 80 minutes. Then, by using sulfuric acid having a concentration of 1 mol/L, the pH thereof was adjusted to be 7.8, thereby preparing a benzotriazole silver dispersion.

In the particles of the prepared benzotriazole silver dispersion, the average equivalent circular diameter was 0.172 μm (coefficient of variation: 18.5%), the average length of a long side was 0.32 μm, the average length of a short side was 0.09 μm, and the average ratio between the long side and the short side was 0.298. The particle size or the like was obtained by calculating the average particle size of 300 particles by using an electron microscope.

(Preparation of Isoprene Latex TP-1)

Isoprene latex TP-1 was prepared as below.

Distilled water (1,500 g) was added to a polymerization tank of a gas monomer reaction apparatus (TAS-2J model manufactured by Taiatsu Techno) and heated at 90° C. for 3 hours such that a passivation film was formed on the members of the polymerization tank including a stainless steel surface, a stirring device made of stainless steel, and the like. The polymerization tank having undergone this treatment was filled with 582.28 g of distilled water having undergone nitrogen gas bubbling for 1 hour, 9.49 g of a surfactant (PIONIN A-43-S(manufactured by TAKEMOTO OIL & FAT Co., Ltd.)), 19.56 g of sodium hydroxide (NaOH) at 1 mol/L, 0.20 g of tetrasodium ethylenediaminetetraacetate, 314.99 g of styrene, 190.87 g of isoprene, 10.43 g of acrylic acid, and 2.09 g of tert-dodecylmercaptane. The reaction container was sealed, the reaction solution was stirred at a stirring speed of 225 rpm, and the internal temperature was increased up to 65° C. A solution, which was obtained by dissolving 2.61 g of ammonium persulfate in 40 mL of water, was added to the reaction solution, and the reaction solution was stirred for 6 hours. At this point, a polymerization conversion rate obtained by measuring solid contents was 90%. A solution, which was obtained by dissolving 5.22 g of acrylic acid in 46.98 g of water, was added to the reaction solution, and then 10 g of water was added thereto. Furthermore, a liquid, which was obtained by dissolving 1.30 g of ammonium persulfate in 50.7 mL of water, was added thereto, and then the reaction solution was heated to 90° C. and stirred for 3 hours. After the reaction ended, the reaction solution was cooled until the internal temperature reached room temperature. Thereafter, sodium hydroxide (NaOH) at 1 mol/L and ammonium hydroxide (NH₄OH) were added thereto at a molar ratio of Na⁺ ions:NH₄⁺ ions of 1:5.3 such that the pH thereof was adjusted to be 8.4. The obtained product was filtered through a filter made of polypropylene having a pore size of 1.0 μm so as to remove impurities such as dust, thereby obtaining 1,248 g of isoprene latex TP-1. As a result of measuring halogen ions by ion chromatography, the concentration of chloride ions was 3 ppm. Furthermore, the concentration of the chelating agent was measured by high-performance liquid chromatography. As a result, the concentration of the chelating agent was 142 ppm.

In the isoprene latex TP-1, the average particle size was 113 nm, the glass transition temperature (Tg) was 15° C., the concentration of solid contents was 41.3% by mass, the equilibrium moisture content at 25° C. and 60% RH was 0.4% by mass, and the ion conductivity was 5.23 mS/cm. The ion conductivity was measured at 25° C. by using a conductivity meter CM-30S manufactured by DKK-TOA CORPORATION.

(Preparation of Image Forming Layer Coating Solution)

1) Preparation of Image Forming Layer Coating Solution A

The fatty acid silver dispersion (1,000 g), a 5% by mass aqueous solution of the blue dye 2, the azomethine dye solid dispersion, the dispersion of the organic polyhalogen compound 1, the dispersion of the organic polyhalogen compound 2, the solution of the phthalazine compound 1, a 2% by mass aqueous solution of METOLOSE 60SH50 (manufactured by Shin-Etsu Chemical Co., Ltd.) as a thickener, the liquid of the isoprene latex TP-1, the dispersion of the reducing agent 1, the dispersion of the reducing agent 2, the dispersion of the hydrogen bonding compound 1, the dispersion of the development accelerator 1, the dispersion of the development accelerator 2, the dispersion of the tone adjuster 1, and the aqueous solution of the mercapto compound 2 were sequentially added to a reaction container. Immediately before coating, 140 g of the silver halide mixed emulsion A was added thereto and thoroughly mixed such that the pH was adjusted to be 7.5, thereby preparing an image forming layer coating solution A.

2) Preparation of Image Forming Layer Coating Solution B-1

The pH of the image forming layer coating solution A was adjusted to be 7.5, and 10.3 g of the infrared absorbing dye dispersion B was added thereto, thereby preparing an image forming layer coating solution B-1.

3) Preparation of Image Forming Layer Coating Solution B-2

The pH of the image forming layer coating solution A was adjusted to be 5.8, and 10.3 g of the infrared absorbing dye dispersion B was added thereto, thereby preparing an image forming layer coating solution B-2.

4) Preparation of Image Forming Layer Coating Solution B-3

The pH of the image forming layer coating solution A was adjusted to be 5.8, and 5.2 g of the infrared absorbing dye dispersion B and 64.5 g of the infrared absorbing dye C were added thereto, thereby preparing an image forming layer coating solution B-3.

5) Preparation of Image Forming Layer Coating Solution C-1

The pH of the image forming layer coating solution A was adjusted to be 5.8, and 129 g of the infrared absorbing dye C was added thereto, thereby preparing an image forming layer coating solution C-1.

6) Preparation of Image Forming Layer Coating Solution C-2

The pH of the image forming layer coating solution A was adjusted to be 7.5, and 129 g of the infrared absorbing dye C was added thereto, thereby preparing an image forming layer coating solution C-2.

7) Preparation of Image Forming Layer Coating Solution D

Instead of the silver halide emulsion 1, the silver halide emulsion 2 was added to the image forming layer coating solution A in the same amount as that of the silver halide emulsion 1, and coating was performed.

8) Preparation of Image Forming Layer Coating Solution E

Instead of the silver halide emulsion 1, the silver halide emulsion 3 was added to the image forming layer coating solution A in the same amount as that of the silver halide emulsion 1, and coating was performed.

9) Preparation of Image Forming Layer Coating Solution F

Instead of the silver halide emulsion 1, the silver halide emulsion 4 was added to the image forming layer coating solution A in the same amount as that of the silver halide emulsion 1, and coating was performed.

(Preparation of Interlayer Coating Solution)

1) Preparation of Interlayer Coating Solution 1

Polyvinyl alcohol PVA-205 (manufactured by KURARAY CO., LTD., 1,000 g), 37 mL of a 5% aqueous solution of sodium di(2-ethylhexyl)sulfosuccinate, 153 mL of a 10% by mass aqueous solution of a blue dye FRL-SF manufactured by Clariant, and 4,632 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex were added to a reaction container. Furthermore, 565 mL of a 20% by mass aqueous solution of diammonium phthalate, 2,319 g of the dispersion of the reducing agent 1, and water were added thereto such that the total amount of the mixture became 13,200 mL. In addition, NaOH was added thereto such that the pH was adjusted to be 7.5, thereby preparing an interlayer coating solution 1. The interlayer coating solution 1 was supplied to a coating die in an amount of 8.3 mL/m².

The viscosity of the obtained interlayer coating solution 1 was measured using a B type viscometer (No. 1 rotor, 60 rpm) at 40° C. As a result, the viscosity was 58 mPa·s.

(Coating Solution for First Layer of Surface Protective Layer)

1) Preparation of Coating Solution for First Layer of Surface Protective Layer

Inert gelatin (1,000 g), 1 g of benzisothiazolinone, 385 g of a benzotriazole silver dispersion A, 543 mL of a 15% by mass methanol solution of phthalic acid, 160 mL of a 15% by mass aqueous solution of 4-methyl phthalate, 58 mL of a mixed aqueous solution containing 17% by mass of homophthalic acid and 23% by mass of trishydroxyaminomethane, and 55.2 mL of a 5% by mass aqueous solution of sodium di(2-ethylhexyl) sulfosuccinate were added to a reaction container and mixed together. Then, water was added thereto such that the total amount of the mixture became 9,913 mL. Immediately before coating, a mixed solution, which was obtained by mixing together 1,788 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex and 406 mL of 4% by mass chromium alum by using a static mixer, was supplied to a coating die such that the amount of the coating solution became 25 mL/m².

The viscosity of the obtained coating solution for a first layer of a surface protective layer was measured using a B type viscometer (No. 1 rotor, 60 rpm) at 40° C. As a result, the viscosity was 20 mPa·s.

(Coating Solution for Second Layer of Surface Protective Layer)

2) Preparation of Coating Solution for Second Layer of Surface Protective Layer

Inert gelatin (1,000 g), 1 g of benzisothiazolinone, 185 mL of a 30% by mass solution of carnauba wax (manufactured by CHUKYO YUSHI CO., LTD., SELOSOL 524), 1,762 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex, 389 mL of a 15% by mass methanol solution of phthalic acid, 129 mL of a 1% by mass solution of the following fluorine-based surfactant (F-1), 50 mL of a 1% by mass aqueous solution of the following fluorine-based surfactant (F-2), 240 mL of a 10% by mass aqueous solution of the following surfactant (F-3), 244 mL of a 5% by mass aqueous solution of sodium di(2-ethylhexyl) sulfosuccinate, and 164 g of polymethyl methacrylate particles (average particle size: 6.3 μm) as a matting agent were added to a reaction container, and water was added thereto such that the total amount thereof became 13,242 mL. These were mixed together, thereby preparing a coating solution for a second layer of a surface protective layer. Subsequently, the coating solution for a second layer of a surface protective layer was supplied to a coating die such that the amount of the solution became 8.3 mL/m².

The viscosity of the obtained coating solution for a second layer of a surface protective layer was measured using a B type viscometer (No. 1 rotor, 60 rpm) at 40° C. As a result, the viscosity was 24 mPa·s.

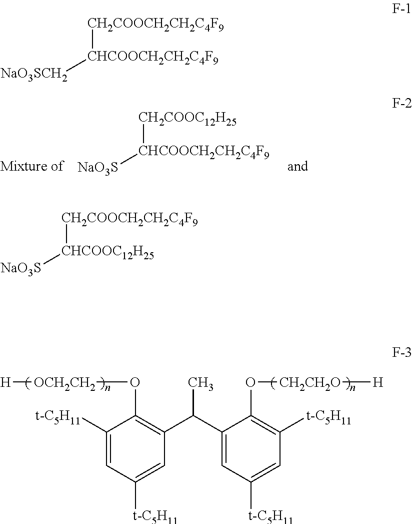

((Preparation of Thermally-Developable Photosensitive Material))

On a surface, which was opposite to a surface provided with the non-photosensitive back layer, of the support, simultaneous multi-layer coating was performed by a slide bead coating method such that an image forming layer, an interlayer, a first layer of a surface protective layer, and a second layer of the surface protective layer were formed in this order from the undercoat surface, thereby preparing a thermally-developable photosensitive material. The amount of the interlayer coating solution used for coating was 8.3 mL/m², the amount of the coating solution for a first layer of a surface protective layer used for coating was 25 mL/m², and the amount of the coating solution for a second layer of the surface protective layer used for coating was 8.3 mL/m².

The amount of each compound in the image forming layer used for coating (unit: g/m²) is as below.

| | |
|---|---|
| Fatty acid silver (as Ag) | 0.958 |
| Blue dye 2 | 0.006 |
| Azomethine dye A | 0.009 |
| Polyhalogen compound 1 | 0.10 |
| Polyhalogen compound 2 | 0.19 |
| Phthalazine compound 1 | 0.12 |
| Thickener (60SH50) | 0.10 |
| Isoprene latex TP-1 | 5.95 |
| Reducing agent 1 | 0.31 |
| Reducing agent 2 | 0.32 |
| Hydrogen bonding compound 1 | 0.05 |
| Development accelerator 1 | 0.011 |
| Development accelerator 2 | 0.016 |
| Tone adjuster 1 | 0.003 |
| Mercapto compound 2 | 0.009 |
| Silver halide (as Ag) | 0.09 |

Coating and Drying Conditions are as Below.

Coating was performed at a speed of 180 m/min. The interval between the tip of the coating die and the support was set to be 0.10 mm to 0.30 mm, and the internal pressure of a decompression chamber was set to be lower than the atmospheric pressure by 196 Pa to 882 Pa. Before being coated, the support was neutralized using ionic wind.

Subsequently, in a chilling (cooling) zone, air with a dry-bulb temperature of 10° C. to 20° C. was supplied to cool the coating solutions, and then the film was transported in a non-contact manner. By using a spiral winding-type non-contact drying machine, the coating solutions were dried by being supplied with dry air with a dry-bulb temperature of 23° C. to 45° C. and a wet-bulb temperature of 15° C. to 21° C.

After being dried, the film was humidified at 25° C. and a humidity of 40% RH to 60% RH, and then the film surface was heated to 70° C. to 90° C. After heating, the film surface was cooled down to 25° C.

### Example 2 to Example 16 and Comparative Example 1 and Comparative Example 2

Thermally-developable photosensitive materials of Example 2 to Example 16, Comparative Example 1, and Comparative Example 2 were prepared in the same manner as in Example 1, except that the compositions of the image forming layer and the non-photosensitive back layer were changed as shown in the following Table 1.

TABLE 1

| | Image forming layer | | | | | | | | | |
|---|---|---|---|---|---|---|---|---|---|---|
| | | Amount of silver | | | | | | | | |
| | | used for | | | Infrared | Intensely | Intensely | | | |
| | | coating in | | | sensitizing | color-sensitizing | color-sensitizing | Non-photosensitive back layer | | |
| | Coating | photosensitive | Infrared | pH of | dye | compound | compound | Coating | Infrared | pH of |
| | solution | silver halide | absorbing | coating | represented by | represented by | represented | solution | absorbing | coating |
| | used | (g/m²) | dye | solution | Formula (III) | Formula (IV) | by Formula (V) | used | dye | solution |
| Example 1 | B-1 | 1 | Cyanine | >6.5 | Present | Present | Present | 1 | — | <6.5 |
| Example 2 | B-2 | 1 | Cyanine | <6.5 | Present | Present | Present | 2 | Oxonol | <6.5 |
| Example 3 | B-3 | 1 | Cyanine | <6.5 | Present | Present | Present | 2 | Oxonol | <6.5 |
| | | | Oxonol | | | | | | | |
| Example 4 | C-1 | 1 | Oxonol | <6.5 | Present | Present | Present | 2 | Oxonol | <6.5 |
| Example 5 | C-2 | 1 | Oxonol | >6.5 | Present | Present | Present | 2 | Oxonol | <6.5 |
| Example 6 | B-1 | 1 | Cyanine | >6.5 | Present | Present | Present | 3 | Cyanine | <6.5 |
| | | | | | | | | | Oxonol | |
| Example 7 | B-1 | 1 | Cyanine | >6.5 | Present | Present | Present | 4 | Cyanine | >6.5 |
| | | | | | | | | | Oxonol | |
| Example 8 | B-1 | 1 | Cyanine | >6.5 | Present | Present | Present | 5 | Cyanine | <6.5 |
| Example 9 | B-1 | 1 | Cyanine | >6.5 | Present | Present | Present | 6 | Cyanine | >6.5 |
| Example 10 | D | 1 | Cyanine | >6.5 | — | Present | Present | 2 | Oxonol | <6.5 |
| Example 11 | E | 1 | Cyanine | >6.5 | Present | — | Present | 2 | Oxonol | <6.5 |
| Example 12 | F | 1 | Cyanine | >6.5 | Present | Present | — | 2 | Oxonol | <6.5 |
| Example 13 | B-1 | 1 | Cyanine | >6.5 | Present | Present | Present | 4 | Cyanine | >6.5 |
| | | | | | | | | | Oxonol | |
| Example 14 | B-1 | 1 | Cyanine | >6.5 | Present | Present | Present | 4 | Cyanine | >6.5 |
| | | | | | | | | | Oxonol | |
| Example 15 | B-1 | 0.3 | Cyanine | >6.5 | Present | Present | Present | 4 | Cyanine | >6.5 |
| | | | | | | | | | Oxonol | |
| Example 16 | B-1 | 1.8 | Cyanine | >6.5 | Present | Present | Present | 4 | Cyanine | >6.5 |
| | | | | | | | | | Oxonol | |
| Comparative | A | 1.8 | — | — | Present | Present | Present | 1 | — | <6.5 |
| Example 1 | | | | | | | | | | |

| | | | | | | | | |
|---|---|---|---|---|---|---|---|---|
| Comparative | A | 1 | — | — | Present | Present | Present | No non-photosensitive |
| Example 2 | | | | | | | | back layer |

In Table 1, “Cyanine” is the infrared absorbing dye dispersion B, “Oxonol” is the infrared absorbing dye C, the infrared sensitizing dye represented by Formula (III) is the infrared sensitizing dye A, the intensely color-sensitizing compound represented by Formula (IV) is B1, and the intensely color-sensitizing compound represented by Formula (V) is B2.

Evaluation of Photographic Performance

1) Preparation

The obtained thermally-developable photosensitive material was cut in half. One of the cut materials was packed with the following packing material in an environment of 25° C. and 50% RH, stored for 2 weeks at room temperature, and then evaluated as below.

<Packing Material>
Laminated film obtained by laminating PET (10 μm)/polyethylene (PE) (12 μm)/aluminum foil (9 μm)/nylon (Ny) (15 μm)/polyethylene containing 3% by mass of carbon (50 μm);
Oxygen permeability: 0.02 mL/atm·m²·25° C.·day,
Moisture permeability: 0.10 g/atm·m^{2·25}° C.·day.

2) Exposure and Development of Thermally-Developable Photosensitive Material

By using a dry laser imager DRYPIX 7000 manufactured by FUJIFILM Medical Systems and a semiconductor laser, each of the thermally-developable photosensitive materials was thermally developed (for 14 seconds in total by using three sheets of panel heaters set to be 107° C.-121° C.-125° C.), and the obtained image was evaluated using a densitometer (manufactured by Macbeth).

Here, during the thermal development, the semiconductor laser to be mounted was changed to a 780 nm semiconductor laser or an 810 nm semiconductor laser having a maximum power of 30 mW.

1) Evaluation Method

(Photographic Performance)

A maximum density (Dmax) represents density that is not increased any more even though the exposure amount is increased under the aforementioned exposure and development conditions by using the thermally-developable photosensitive material as a sample.

—Sensitivity Evaluation—

A: Based on the sensitivity of Example 1, sensitivity is equivalent to that of Example 1 (difference is less than ±5%).

B: Based on the sensitivity of Example 1, sensitivity is lower than that of Example 1 by equal to or higher than 5% and less than 10%.

C: Based on the sensitivity of Example 1, sensitivity is lower than that of Example 1 by equal to or higher than 10%.

(Image Quality Test)

<<Evaluation of Sharpness>>

A 660 nm semiconductor laser of DRYPIX 7000 was changed to a 780 nm semiconductor laser or an 810 nm semiconductor laser, a test pattern having a density of 2.0 was output, and the sharpness at both the wavelengths was evaluated. The reproducibility of 5 patterns for image resolution per 1 mm was measured using a spatial resolution frequency function (MTF), thereby evaluating the sharpness.

—Sharpness Evaluation—

A: The images of the test patterns are distorted least, and the sharpness is excellent. The value of reproducibility (MTF value) is equal to or greater than 0.85 and equal to or smaller than 1.00.

B: The value of reproducibility (MTF value) is equal to or greater than 0.80 and less than 0.85.

C: The value of reproducibility (MTF value) is equal to or greater than 0.75 and less than 0.80.

D: The value of reproducibility (MTF value) is less than 0.75.

The evaluation results are described in the following Table 2.

TABLE 2

| | Evaluation | | | | |
|---|---|---|---|---|---|
| | | | | Image quality | Image quality |
| | | Sensitivity | Sensitivity | Sharpness | Sharpness |
| | Dmax | 780 nm | 810 nm | 780 nm | 810 nm |
| Example 1 | 3.5 | A | A | C | C |
| Example 2 | 3.5 | B | A | B | A |
| Example 3 | 3.5 | B | A | B | A |
| Example 4 | 3.5 | C | C | B | A |
| Example 5 | 3.5 | A | B | B | A |
| Example 6 | 3.5 | A | B | A | B |
| Example 7 | 3.5 | A | B | A | B |
| Example 8 | 3.5 | A | B | B | A |
| Example 9 | 3.5 | A | B | A | B |
| Example 10 | 3.5 | C | C | A | B |
| Example 11 | 3.5 | C | C | A | B |
| Example 12 | 3.5 | C | C | A | B |
| Example 13 | 3.5 | A | C | A | B |
| Example 14 | 3.5 | A | C | A | B |
| Example 15 | 1 | A | B | A | B |
| Example 16 | 6 | A | B | A | B |
| Comparative | 3.5 | A | A | D | D |
| Example 1 | | | | | |
| Comparative | 3.5 | A | A | D | D |
| Example 2 | | | | | |

It was confirmed that from the viewpoint of the image sharpness, the thermally-developable photosensitive materials of Example 1 to Example 16 are better than Comparative Example 1 because scattering (irradiation) and reflection (halation) were sufficiently prevented in the thermally-developable photosensitive materials of Example 1 to Example 16. Furthermore, the thermally-developable photosensitive materials of Example 1 to Example 16 had sufficient sensitivity.

It was confirmed that among Example 1 to Example 16, the thermally-developable photosensitive materials of Examples 6, 7, and 9 to 16, in which the pH of the image forming layer was equal to or higher than 6.5, exhibited excellent image sharpness with respect to the 780 nm laser, and the thermally-developable photosensitive materials of Examples 2 to 5 and 8, in which the pH of the image forming layer or the pH of the non-photosensitive back layer was equal to or lower than 6.5 exhibited excellent image sharpness with respect to the 810 nm laser. That is, in a case where the pH of the solution for preparing the thermally-developable photosensitive material according to the present disclosure is changed, the absorption wavelength of the infrared absorbing dye is controlled, and the thermally-developable photosensitive material demonstrates optimal performance for infrared lasers having different wavelengths.

### Examples 17 to 22

((Preparation of PET Support))

A support was used which was used in Example 1 and coated with the undercoat layer coating solution for the image forming layer and the undercoat layer coating solution for the first and second layers on the back surface side.

((Non-Photosensitive Back Layer and Back Surface Protective Layer))

(Non-Photosensitive Back Layer)

1) Preparation of Equal Non-Photosensitive Back Layer Coating Solution 7

A container was stored and kept at 40° C., 100 g of gelatin, 400 mg of benzisothiazolinone, 20.4 mL of a 10% by mass aqueous solution of a blue dye FRL-SF manufactured by Clariant, and 1,544 mL of water were added to the container, and the gelatin was dissolved. The obtained solution was mixed with 27 mL of a 20% by mass aqueous solution of diammonium phthalate, 25 mL of a 15% by mass methanol solution of phthalic acid, 50 mL of a 3% by mass aqueous solution of sodium polystyrene sulfonate, and 200 g of a 10% by mass aqueous dispersion liquid of isoprene latex TP-1 which will be described later. Immediately before coating, the obtained solution was mixed with 65 mL of a 4% by mass aqueous solution of N,N-ethylenebis(vinylsulfonacetamide). An aqueous infrared absorbing dye solution (101 mL) containing 0.4% by mass of the infrared absorbing dye C was added to the obtained solution. The viscosity of the obtained coating solution was measured using a B type viscometer (No. 1 rotor, 60 rpm) at 40° C. As a result, the viscosity was 32 mPa·s. The pH of the coating solution was 5.15 at 40° C.

(Non-Photosensitive Back Surface Protective Layer)

1) Preparation of Non-Photosensitive Back Surface Protective Layer Coating Solution 2 Formulation (1) Back Surface Protective Layer Coating Solution 2

A container was kept at 40° C., 100 g of gelatin, 72.1 g of only one kind of monodispersed polymethyl methacrylate particles (average particle size: 8 μm, standard deviation of particle size: 0.4) as a matting agent, 637 mg of benzisothiazolinone, and 1,645 mL of water were added to the container, and the gelatin was dissolved. Furthermore, the obtained solution was mixed with 15.8 mL of a 30% by mass solution of carnauba wax (manufactured by CHUKYO YUSHI CO., LTD., SELOSOL 524), 5.7 mL of a 15% by mass methanol solution of phthalic acid, 24 mL of a 5% by mass aqueous solution of sodium di(2-ethylhexyl) sulfosuccinate, 50 mL of a 3% by mass aqueous solution of sodium polystyrene sulfonate, 12 mL of a 1% by mass solution of the fluorine-based surfactant (F-1) used in Example 1, and 72 ml of a 20% by mass solution of ethyl acrylate/acrylic acid copolymer (copolymerization ratio based on mass: 64/4). Immediately before coating, the obtained solution was mixed with 90 mL of a 4% by mass aqueous solution of N,N-ethylenebis(vinylsulfonacetamide), thereby obtaining a back surface protective layer coating solution 2. The viscosity of the coating solution was measured using a B type viscometer (No. 1 rotor, 60 rpm) at 40° C. As a result, the viscosity was 18 mPa·s. The pH of the coating solution was 5.5 at 40° C.

((Coating of Non-Photosensitive Back Layer))

By means of simultaneous multi-layer coating, the back surface side of the support having the undercoat layers was coated with the non-photosensitive back layer coating solution 7 described in Table 3 such that the amount of gelatin used for coating became 1.5 g/m² and with the back surface protective layer coating solution 2 such that the amount of gelatin used for coating became 0.73 g/m², followed by drying. In this way, a non-photosensitive back layer was formed.

((Image Forming Layer, Interlayer, and Surface Protective Layer))

A tone adjuster 2 and a surfactant 1 were newly prepared as below.

(Preparation of Tone Adjuster)

1) Preparation of Tone Adjuster 2

The following compound 2A (trihydroxymethyl aminomethane) was measured (229.38 g), and 727.05 ml of water was measured. Then, 170.57 g of a compound 2B (2-carboxyphenyl acetate) was measured and stirred for 60 minutes, thereby obtaining a tone adjuster 2.

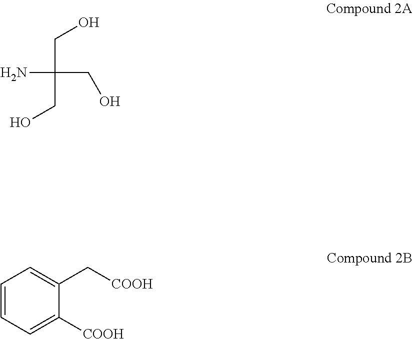 [SMILES: NC(CO)(CO)CO ; O=C(O)Cc1ccccc1C(=O)O]

(Preparation of Surfactant)

1) Preparation of Surfactant 1

Water was added to the following surfactant A (PIONIN A-43-S: manufactured by TAKEMOTO OIL & FAT Co., Ltd.), thereby preparing an 8% aqueous solution.

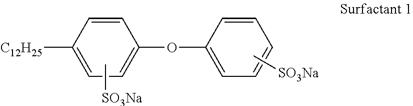

(Image Forming Layer Coating Solution)

1) Preparation of Image Forming Layer Coating Solution A-2

Fatty acid silver dispersion (1,000 g) prepared in Example 1, 3.7 g of the azomethine dye A (solid dispersion having a concentration of 10%) prepared in Example 1, 22.7 g of the dispersion of the organic polyhalogen compound 1 (solid dispersion having a concentration of 26%) prepared in Example 1, 49.3 g of the dispersion of the organic polyhalogen compound 2 (solid dispersion having a concentration of 30%) prepared in Example 1, 169.8 g of the solution of the phthalazine compound 1 (concentration: 5%) prepared in Example 1, 71.3 ml of a 2% by mass aqueous solution of METOLOSE 60SH50 (manufactured by Shin-Etsu Chemical Co., Ltd.) as a thickener, 53 ml of the surfactant 1 (concentration: 8%) prepared as above as a surface tension adjuster of the coating solution, 901.1 g of the isoprene latex TP-1 liquid (concentration: 42%) prepared in Example 1, 58.6 g of the solid dispersion of the reducing agent 1 (concentration: 25%) prepared in Example 1, 89.4 g of the solid dispersion of the reducing agent 2 (concentration: 25%) prepared in Example 1, 3.52 g of the solid dispersion of the development accelerator 1 (concentration: 20%) prepared in Example 1, 6.86 g of the solid dispersion of the development accelerator 2 (concentration: 23%) prepared in Example 1, 2.6 ml of the tone adjuster 2 prepared as above, and 34.2 ml of the aqueous solution of the mercapto compound 2 (concentration: 2%) were sequentially added to a reaction container. Immediately before coating, 106.5 g of the silver halide mixed emulsion A prepared in Example 1 was added thereto and thoroughly mixed such that the pH thereof was adjusted to be 7.5, thereby preparing an image forming layer coating solution A-2.

2) Preparation Image Forming Layer Coating Solution G

Fatty acid silver dispersion (1,000 g) prepared in Example 1, 3.7 g of the azomethine dye A (solid dispersion having a concentration of 10%) prepared in Example 1, 22.7 g of the dispersion of the organic polyhalogen compound 1 (solid dispersion having a concentration of 26%) prepared in Example 1, 49.3 g of the dispersion of the organic polyhalogen compound 2 (solid dispersion having a concentration of 30%) prepared in Example 1, 169.8 g of the solution of the phthalazine compound 1 (concentration: 5%) prepared in Example 1, 71.3 ml of a 2% by mass aqueous solution of METOLOSE 60SH50 (manufactured by Shin-Etsu Chemical Co., Ltd.) as a thickener, 53 ml of the surfactant 1 (concentration: 8%) prepared as above as a surface tension adjuster of the coating solution, 901.1 g of the isoprene latex TP-1 liquid (concentration: 42%) prepared in Example 1, 58.6 g of the solid dispersion of the reducing agent 1 (concentration: 25%) prepared in Example 1, 89.4 g of the dispersion of the reducing agent 2 (concentration: 25%) prepared in Example 1, 3.52 g of the solid dispersion of the development accelerator 1 (concentration: 20%) prepared in Example 1, 6.86 g of the solid dispersion of the development accelerator 2 (concentration: 23%) prepared in Example 1, 2.6 ml of the tone adjuster 2 prepared as above, and 34.2 ml of the aqueous solution of the mercapto compound 2 (concentration: 2%) were sequentially added to a reaction container. Immediately before coating, 106.5 g of the silver halide mixed emulsion A prepared in Example 1 was added thereto and thoroughly mixed such that the pH thereof was adjusted to be 7.5, thereby preparing an image forming layer coating solution G.

3) Preparation of Image Forming Layer Coating Solution H

Fatty acid silver dispersion (1,000 g) prepared in Example 1, 3.7 g of the azomethine dye A (solid dispersion having a concentration of 10%) prepared in Example 1, 22.7 g of the dispersion of the organic polyhalogen compound 1 (solid dispersion having a concentration of 26%) prepared in Example 1, 49.3 g of the dispersion of the organic polyhalogen compound 2 (solid dispersion having a concentration of 30%) prepared in Example 1, 169.8 g of the solution of the phthalazine compound 1 (concentration: 5%) prepared in Example 1, 71.3 ml of a 2% by mass aqueous solution of METOLOSE 60SH50 (manufactured by Shin-Etsu Chemical Co., Ltd.) as a thickener, 53 ml of the surfactant 1 (concentration: 8%) prepared as above as a surface tension adjuster of the coating solution, 901.1 g of the isoprene latex TP-1 liquid (concentration: 42%) prepared in Example 1, 29.3 g of the dispersion of the reducing agent 1 (concentration: 25%) prepared in Example 1, 190.4 g of the dispersion of the reducing agent 2 (concentration: 25%) prepared in Example 1, 3.52 g of the solid dispersion of the development accelerator 1 (concentration: 20%) prepared in Example 1, 6.86 g of the solid dispersion of the development accelerator 2 (concentration: 23%) prepared in Example 1, 2.6 ml of the tone adjuster 2 prepared as above, and 34.2 ml of the aqueous solution of the mercapto compound 2 (concentration: 2%) were sequentially added to a reaction container. Immediately before coating, 106.5 g of the silver halide mixed emulsion A prepared in Example 1 was added thereto and thoroughly mixed such that the pH thereof was adjusted to be 7.5, thereby preparing an image forming layer coating solution H.

(Interlayer Coating Solution)

1) Preparation of Interlayer Coating Solution 2

Polyvinyl alcohol PVA-205 (manufactured by KURARAY CO., LTD., 1,000 g), 37 mL of a 5% aqueous solution of sodium di(2-ethylhexyl)sulfosuccinate, 153 mL of a 10% by mass aqueous solution of a blue dye FRL-SF manufactured by Clariant, and 4,632 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex were added to a reaction container. Furthermore, 565 mL of a 20% by mass aqueous solution of diammonium phthalate, 1,160 g of 25% by mass of the dispersion of the reducing agent 2, and water were added thereto such that the total amount of the mixture became 13,200 mL. In addition, NaOH was added thereto such that the pH was adjusted to be 7.5, thereby preparing an interlayer coating solution 2. The interlayer coating solution was supplied to a coating die in an amount of 8.3 mL/m².

The viscosity of the obtained interlayer coating solution 2 was measured using a B type viscometer (No. 1 rotor, 60 rpm) at 40° C. As a result, the viscosity was 58 mPa·s.

2) Preparation of Interlayer Coating Solution 3

Polyvinyl alcohol PVA-205 (manufactured by KURARAY CO., LTD., 1,000 g), 37 mL of a 5% aqueous solution of sodium di(2-ethylhexyl)sulfosuccinate, 153 mL of a 10% by mass aqueous solution of a blue dye FRL-SF manufactured by Clariant, and 4,762 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex were added to a reaction container. Furthermore, 283 mL of a 20% by mass aqueous solution of diammonium phthalate, 290 g of 25% by mass of the dispersion of the reducing agent 2, and water were added thereto such that the total amount of the mixture became 10,890 mL. In addition, NaOH was added thereto such that the pH was adjusted to be 7.5, thereby preparing an interlayer coating solution 3. The interlayer coating solution 3 was supplied to a coating die in an amount of 8.3 mL/m².

The viscosity of the obtained interlayer coating solution 3 was measured using a B type viscometer (No. 1 rotor, 60 rpm) at 40° C. As a result, the viscosity was 45 mPa·s.

(Coating Solution for First Layer of Surface Protective Layer)

Inert gelatin (1,000 g), 1 g of benzisothiazolinone, 385 g of the benzotriazole silver dispersion A, 197 mL of a 15% by mass methanol solution of phthalic acid, 160 mL of a 15% by mass aqueous solution of 4-methyl phthalate, 103.5 mL of a mixed aqueous solution containing 17% by mass of homophthalic acid and 23% by mass of trishydroxyaminomethane, and 66.9 mL of a 5% by mass aqueous solution of sodium di(2-ethylhexyl) sulfosuccinate were added to a reaction container and mixed together. Then, water was added thereto such that the total amount of the mixture became 9,913 mL. Immediately before coating, the obtained solution was mixed with 1,561 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex and 242 mL of 4% by mass chromium alum by using a static mixer, and supplied to a coating die such that the amount of the coating solution became 24 mL/m².

The viscosity of the obtained coating solution for a first layer of a surface protective layer was measured using a B type viscometer (No. 1 rotor, 60 rpm) at 40° C. As a result, the viscosity was 20 mPa·s.

(Coating Solution for Second Layer of Surface Protective Layer)

Inert gelatin (1,000 g), 1 g of benzisothiazolinone, 185 mL of a 30% by mass solution of carnauba wax (manufactured by CHUKYO YUSHI CO., LTD., SELOSOL 524), 1,811 mL of a 19% by mass aqueous dispersion liquid of methyl methacrylate/styrene/butyl acrylate/hydroxyethyl methacrylate/acrylic acid copolymer (copolymerization ratio based on mass: 57/8/28/5/2) latex, 389 mL of a 15% by mass methanol solution of phthalic acid, 129 mL of a 1% by mass solution of the fluorine-based surfactant (F-1), 240 mL of a 10% by mass aqueous solution of the following surfactant (F-3), 146 mL of a 5% by mass aqueous solution of sodium di(2-ethylhexyl) sulfosuccinate, and 1,898 g of 20% by mass of polymethyl methacrylate particles (average particle size: 8.0 μm) as a matting agent were added to a reaction container. Subsequently, 17.3 ml of a 1 mol/L sodium hydroxide solution and a 12 mol/L sulfuric acid solution were added thereto, and water was added thereto such that the total amount of the mixture became 13,242 mL, thereby preparing a coating solution for a second layer of a surface protective layer. The coating solution for a second layer of a surface protective layer was supplied to a coating die such that the amount of the solution became 8.3 mL/m².

The viscosity of the obtained coating solution for a second layer of a surface protective layer was measured using a B type viscometer (No. 1 rotor, 60 rpm) at 40° C. As a result, the viscosity was 24 mPa·s.

((Preparation of Thermally-Developable Photosensitive Material))

On a surface, which was opposite to a surface provided with the non-photosensitive back layer, of the support, simultaneous multi-layer coating was performed by a slide bead coating method such that an image forming layer, an interlayer, a first layer of a surface protective layer, and a second layer of the surface protective layer were formed in this order from the undercoat surface, thereby preparing a thermally-developable photosensitive material. The amount of the interlayer coating solution used for coating was 8.3 mL/m², the amount of the coating solution for a first layer of a surface protective layer used for coating was 25 mL/m², and the amount of the coating solution for a second layer of a surface protective layer used for coating was 8.3 mL/m².

The amount of each compound in the image forming layer used for coating (unit: g/m²) is as below.

| | |
|---|---|
| Fatty acid silver (as Ag) | 1.02 |
| Azomethine dye A | 0.009 |
| Infrared absorbing dye B | 0.0076 |
| Polyhalogen compound 1 | 0.089 |
| Polyhalogen compound 2 | 0.22 |
| Phthalazine compound 1 | 0.098 |
| Thickener (60SH50) | 0.021 |
| Isoprene latex TP-1 | 5.68 |
| Reducing agent 1 | 0.110 |
| Reducing agent 2 | 0.714 |
| Development accelerator 1 | 0.011 |
| Development accelerator 2 | 0.024 |
| Tone adjuster 2 | 0.014 |
| Mercapto compound 2 | 0.010 |
| Silver halide (as Ag) | 0.06 |

Coating and drying conditions are as below.

Coating was performed at a speed of 180 m/min. The interval between the tip of the coating die and the support was set to be 0.10 mm to 0.30 mm, and the internal pressure of a decompression chamber was set to be lower than the atmospheric pressure by 196 Pa to 882 Pa. Before being coated, the support was neutralized using ionic wind.

Subsequently, in a chilling (cooling) zone, air with a dry-bulb temperature of 10° C. to 20° C. was supplied to cool the coating solutions, and then the film was transported in a non-contact manner. By using a spiral winding-type non-contact drying machine, the coating solutions were dried by being supplied with dry air with a dry-bulb temperature of 23° C. to 45° C. and a wet-bulb temperature of 15° C. to 21° C.

After being dried, the film was humidified at 25° C. and a humidity of 40% RH to 60% RH, and then the film surface was heated to 70° C. to 90° C. After heating, the film surface was cooled down to 25° C.

### Example 17 to Example 22, Comparative Example 3, and Comparative Example 4

Thermally-developable photosensitive materials of Example 17 to Example 22, Comparative Example 3, and Comparative Example 4 were prepared in the same manner as in Example 1, except that the compositions of the image forming layer, the interlayer, and the non-photosensitive back layer were changed as shown in the following Table 3, and the back surface protective layer coating solution 2 was used.

TABLE 3

| | Image forming layer | | | | | | | | | | |
|---|---|---|---|---|---|---|---|---|---|---|---|
| | | Amount of | | | | Intensely | | | | | |
| | | silver | | | Infrared | color- | Intensely | | | | |
| | | used for | | | sensitizing | sensitizing | color- | | | | |
| | | coating in | | | dye | compound | sensitizing | | Non-photosensitive back layer | | |
| | Coating | photosensitive | Infrared | pH of | represented | represented | compound | Interlayer | Coating | Infrared | pH of |
| | solution | silver halide | absorbing | coating | by | by | represented by | coating | solution | absorbing | coating |
| | used | (g/m²) | dye | solution | Formula (III) | Formula (IV) | Formula (V) | solution | used | dye | solution |
| Example 17 | G | 1.06 | Cyanine | >6.5 | Present | Present | Present | 1 | 7 | Oxonol | <6.5 |
| Example 18 | H | 1.06 | Cyanine | >6.5 | Present | Present | Present | 1 | 7 | Oxonol | <6.5 |
| Example 19 | G | 1.06 | Cyanine | >6.5 | Present | Present | Present | 2 | 7 | Oxonol | <6.5 |
| Example 20 | H | 1.06 | Cyanine | >6.5 | Present | Present | Present | 2 | 7 | Oxonol | <6.5 |
| Example 21 | G | 1.06 | Cyanine | >6.5 | Present | Present | Present | 3 | 7 | Oxonol | <6.5 |
| Example 22 | H | 1.06 | Cyanine | >6.5 | Present | Present | Present | 3 | 7 | Oxonol | <6.5 |
| Comparative | A-2 | 1.06 | — | — | Present | Present | Present | 1 | 1 | — | <6.5 |
| Example 3 | | | | | | | | | | | |

| | | | | | | | | | |
|---|---|---|---|---|---|---|---|---|---|
| Comparative | A-2 | 1.06 | — | — | Present | Present | Present | 1 | No non-photosensitive |
| Example 4 | | | | | | | | | back layer |

Evaluation was performed in the same manner as in Example 1. The results are shown in Table 4.

TABLE 4

| | Evaluation | | | | |
|---|---|---|---|---|---|
| | | | | Image quality | Image quality |
| | | Sensitivity | Sensitivity | Sharpness | Sharpness |
| | Dmax | 780 nm | 810 nm | 780 nm | 810 nm |
| Example 17 | 3.5 | A | B | A | B |
| Example 18 | 3.5 | A | B | A | B |
| Example 19 | 3.5 | A | B | A | B |
| Example 20 | 3.5 | A | B | A | B |
| Example 21 | 3.5 | A | B | A | B |
| Example 22 | 3.5 | A | B | A | B |
| Comparative | 3.5 | A | A | D | D |
| Example 3 | | | | | |
| Comparative | 3.5 | A | A | D | D |
| Example 4 | | | | | |

It was confirmed that from the viewpoint of image sharpness, the thermally-developable photosensitive materials of Example 17 to Example 22 are better than Comparative Example 3 or 4 because scattering (irradiation) and reflection (halation) were sufficiently prevented in the thermally-developable photosensitive materials of Example 17 to Example 22. Furthermore, the thermally-developable photosensitive materials of Example 17 to Example 22 had sufficient sensitivity.

The entire disclosure in JP2016-206373 filed on Oct. 20, 2016 is incorporated into the present disclosure by reference.

All the documents, patent applications, and technical standards described in the present specification are incorporated into the present specification by reference as if each of the documents, the patent applications, and the technical standards is specifically and independently described and incorporated into the present specification by reference.

What is claimed is:

1. A thermally-developable photosensitive material comprising:
a support;
an image forming layer, which contains at least a photosensitive silver halide, a non-photosensitive organic silver salt, a reducing agent, and a binder, on one surface of the support; and
a non-photosensitive back layer on the other surface of the support,
wherein either the image forming layer or the image forming layer and the non-photosensitive back layer contain an infrared absorbing dye which absorbs at least infrared having a wavelength equal to or longer than 700 nm.

2. The thermally-developable photosensitive material according to claim 1,
wherein the infrared absorbing dye is a cyanine-based dye represented by Formula (I), 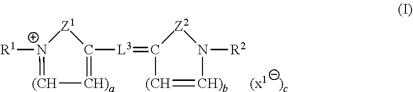
in the formula, Z¹ and Z² each independently represent a non-metal atomic group necessary for forming a 5- or 6-membered nitrogen-containing heterocyclic ring which may be fused; R¹ and R² each independently represent an aliphatic group or an aromatic group; L³ represents a methine chain including 3, 5, or 7 methine groups; a, b, and c each independently represent 0 or 1; and X¹ represents an atomic group which may become an anion.

3. The thermally-developable photosensitive material according to claim 2,
wherein the nitrogen-containing heterocyclic ring is a ring selected from the group consisting of a benzoxazole ring, a benzothiazole ring, a benzimidazole ring, an indolenine ring, and a benzindolenine ring.

4. The thermally-developable photosensitive material according to claim 1,
wherein the non-photosensitive back layer contains, as the infrared absorbing dye, an oxonol dye represented by Formula (II), 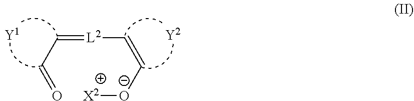
in the formula, Y¹ and Y² each independently represent a non-metal atomic group necessary for forming an aliphatic ring or a heterocyclic ring; L² represents a methine chain including an odd number of methine groups; and X² represents a hydrogen atom or an atomic group which may become a cation.

5. The thermally-developable photosensitive material according to claim 1,
wherein the image forming layer further contains an infrared sensitizing dye represented by Formula (III), 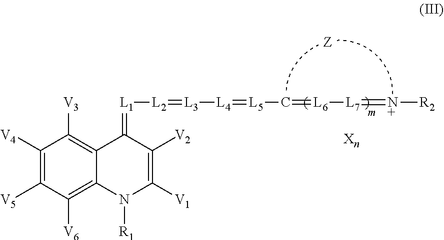
in the formula, V₁, V₂, V₃, V₄, V₅, and V₆ each independently represent a substituent satisfying Y=σp1+σp2+σp3+σp4+σp5+σp6<−0.27 provided that a Hammett constant op of each of V₁, V₂, V₃, V₄, V₅, and V₆ is σpi (i=1 to 6); R₁ and R₂ each independently represent an alkyl group; L₁, L₂, L₃, L₄, L₅, L₆, and L₇ each independently represent a methine group; m represents 0 or 1; Z represents an atomic group necessary for forming a 5- or 6-membered nitrogen-containing heterocyclic ring; Xₙ represents a charge balancing counterion; and n represents a number equal to or greater than 0 that is necessary for charge neutralization.

6. The thermally-developable photosensitive material according to claim 1,
wherein the image forming layer further contains an intensely color-sensitizing compound represented by Formula (IV), 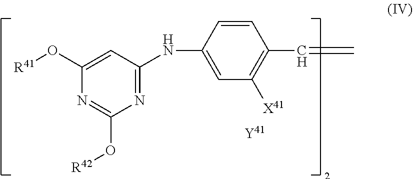
in the formula, R⁴¹ and R⁴² each independently represent a hydrogen atom or a monovalent substituent; X⁴¹ represents an acid anion group; and Y⁴¹ represents a monovalent metal ion.

7. The thermally-developable photosensitive material according to claim 1,
wherein the image forming layer further contains an intensely color-sensitizing compound represented by Formula (V), 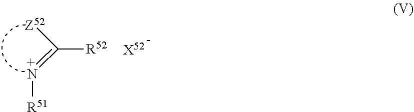
in the formula, Z⁵² represents a non-metal atomic group necessary for forming a 5- or 6-membered nitrogen-containing heterocyclic ring; R⁵¹ represents a hydrogen atom, an alkyl group, or an alkenyl group; R⁵² represents a hydrogen atom or an alkyl group having 1 to 4 carbon atoms; and X⁵²⁻ represents an acid anion.

8. The thermally-developable photosensitive material according to claim 1,
wherein a content of a silver element in the image forming layer is equal to or greater than 0.3 g/m² and equal to or smaller than 1.5 g/m².

9. The thermally-developable photosensitive material according to claim 1,
wherein the image forming layer and the non-photosensitive back layer contain an infrared absorbing dye which absorbs at least infrared having a wavelength equal to or longer than 700 nm.

10. A preparation method of the thermally-developable photosensitive material according to claim 1, comprising:
a step of forming the image forming layer by aqueous coating.

11. The preparation method of the thermally-developable photosensitive material according to claim 10, further comprising:
a step of preparing a coating solution for forming an image forming layer by adding at least one kind of compound, which is selected from the group consisting of an infrared sensitizing dye represented by Formula (III), an intensely color-sensitizing compound represented by Formula (IV), and an intensely color-sensitizing compound represented by Formula (V), to a composition containing a photosensitive silver halide under a temperature condition of equal to or higher than 50° C.,
wherein the step of forming the image forming layer by aqueous coating is a step of forming the image forming layer by performing aqueous coating by using the coating solution for forming an image forming layer, 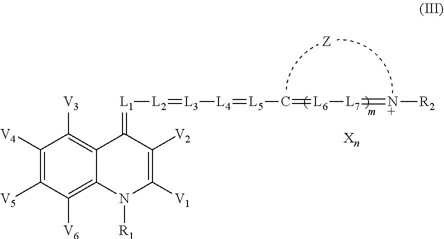
in the formula, V₁, V₂, V₃, V₄, V₅, and V₆ each independently represent a substituent satisfying Y=σp1+σp2+σp3+σp4+σp5+σp6<−0.27 provided that a Hammett constant σp of each of V₁, V₂, V₃, V₄, V₅, and V₆ is σpi (i=1 to 6); R₁ and R₂ each independently represent an alkyl group; L₁, L₂, L₃, L₄, L₅, L₆, and L₇ each independently represent a methine group; m represents 0 or 1; Z represents an atomic group necessary for forming a 5- or 6-membered nitrogen-containing heterocyclic ring; Xₙ represents a charge balancing counterion; and n represents a number equal to or greater than 0 that is necessary for charge neutralization, 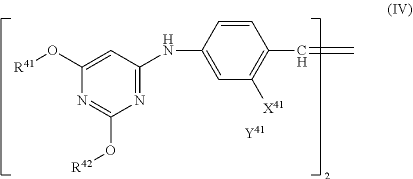
in the formula, R⁴¹ and R⁴² each independently represent a hydrogen atom or a monovalent substituent; X⁴¹ represents an acid anion group; and Y⁴¹ represents a monovalent metal ion, 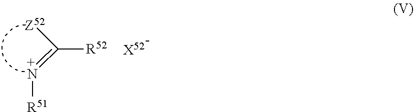
in the formula, Z⁵² represents a non-metal atomic group necessary for forming a 5- or 6-membered nitrogen-containing heterocyclic ring; R⁵¹ represents a hydrogen atom, an alkyl group, or an alkenyl group; R⁵² represents a hydrogen atom or an alkyl group having 1 to 4 carbon atoms; and X⁵²⁻represents an acid anion.
